(19) United States
(12) Patent Application Publication
(10) Pub. No.: US 2026/0328214 A1
(43) Pub. Date: Oct. 22, 2026

(54) AIR-BLOWING DEVICE

(71) Applicant: SHENZHEN CARKU TECHNOLOGY CO., LTD. [CN], Shenzhen (CN)

(72) Inventors: Yun LEI, Shenzhen (CN); Jianping LIN, Shenzhen (CN); Yubin ZHANG, Shenzhen (CN)

(73) Assignee: SHENZHEN CARKU TECHNOLOGY CO., LTD. [CN], Shenzhen (CN)

(21) Appl. No.: 19/713,770

(22) Filed: Jun. 19, 2026

Related U.S. Application Data
(63) Continuation of application No. PCT/CN2026/072041, filed on Jan. 12, 2026.

(30) Foreign Application Priority Data
Jan. 22, 2025 (CN) 202520156092.6
Jan. 22, 2025 (CN) 202520157844.0
Jan. 22, 2025 (CN) 202520164681.9
Jan. 22, 2025 (CN) 202520165816.3
Jan. 22, 2025 (CN) 202520165819.7
Dec. 29, 2025 (CN) 202522789383.1

(51) Int. Cl. F04D 25/08; F02N 11/12; F04D 19/00; F04D 29/52; F04D 29/70

(52) U.S. Cl. CPC F04D 25/084; F02N 11/12; F04D 19/002; F04D 29/522; F04D 29/703

(57) ABSTRACT

The present disclosure provides an air-blowing device, which is aimed at achieving a multi-functional air-blowing device, so as to satisfy various user needs. The air-blowing device of the present disclosure may comprise: a housing; an energy storage unit, comprising an emergency battery cell and disposed in the housing, wherein the emergency battery cell is connected to an emergency interface, wherein the emergency interface is suitable for being electrically connected to a vehicle, so as to enable emergency starting of the vehicle; a blowing unit, which is provided in the housing and is electrically connected to the energy storage unit; wherein the housing comprises an airflow section and a grip section; the blowing unit is located in the airflow section; the emergency interface is located in the grip section and is located at a part of the grip section close to the airflow section.

### CROSS-REFERENCE TO RELATED APPLICATIONS

The present disclosure is a continuation of International Patent Application No. PCT/CN2026/072041, filed on Jan. 12, 2026 and entitled “Air-Blowing Device”, which claims priority to: Chinese Patent Application No. 202522789383.1, filed on Dec. 29, 2025 and entitled “Multifunctional device”, Chinese Patent Application No. 202520156092.6, filed on Jan. 22, 2025 and entitled “Control circuit and air-blowing device”, Chinese Patent Application No. 202520165819.7, filed on Jan. 22, 2025 and entitled “Air-blowing device”, Chinese Patent Application No. 202520157844.0, filed on Jan. 22, 2025 and entitled “Air-blowing device”, Chinese Patent Application No. 202520164681.9, filed on Jan. 22, 2025 and entitled “Air-blowing device”, and Chinese Patent Application No. 202520165816.3, filed on Jan. 22, 2025 and entitled “Handheld air-blowing device”, all of which are hereby incorporated by reference herein.

### TECHNICAL FIELD

The present disclosure relates to the technical field of tools, and in particular to an air-blowing device.

### BACKGROUND

With social evolution and development, products with high applicability are increasingly favored by users.

However, the practical functions of many products in daily life are relatively simple.

For example, an air-blowing device for cleaning a vehicle is usually only capable of outputting air, so as to remove dust and snow from the vehicle by airflow.

To avoid a situation where a vehicle cannot start due to a drained battery in unexpected emergency, the vehicle owner also needs to carry an emergency power supply equipment in his vehicle in addition to an air-blowing device, and such an emergency power device is normally only used for emergency starting.

Accordingly, these products have poor applicability and are restricted to narrow usage scenarios, which can hardly meet people's different usage needs.

### SUMMARY

The present disclosure provides in embodiments an air-blowing device, which is aimed at achieving a multi-functional air-blowing device, so as to satisfy various user needs.

In a first aspect, the present disclosure provides an air-blowing device, wherein the air-blowing device comprises: a housing, comprising an airflow section and a grip section; an energy storage unit, comprising an emergency battery cell, which is provided in the housing, wherein the emergency battery cell is connected to an emergency interface, wherein the emergency interface is suitable for being electrically connected to a vehicle, so as to enable emergency starting of the vehicle; a blowing unit, which is provided in the housing and is electrically connected to the energy storage unit, wherein: the blowing unit is located in the airflow section; and the emergency interface is located in the grip section and is located at a part of the grip section close to the airflow section.

In some embodiments, the emergency battery cell is disposed in the grip section, and the emergency interface is disposed closer to the airflow section than the emergency battery cell is.

By arranging the emergency interface close to the airflow section, the emergency interface and the blowing motor can be placed at the same side of the battery cell, thereby the output wiring from the battery cell can be always toward a same direction. This facilitates/simplifies the wiring, and helps prevent potential faults caused by long winding wires within a confined internal space.

In some embodiments, the housing is provided with a mounting seat for mounting the emergency interface, wherein the mounting seat provides a receiving space that is constrained in at least two dimensions so as to position the emergency interface, wherein the at least two dimensions comprises length direction and width direction, wherein the housing is provided with a protruding structure at a position corresponding to the emergency interface and the protruding structure is able to limit movement of the emergency interface in thickness direction.

Thereby, the movements of the emergency interface are constrained in three directions (length, width, and height), which secures the emergency interface in position. Since the thickness (the smallest dimension) of the emergency interface is often smaller than the thickness (the smallest dimension) of the energy storage unit, and the overall thickness (dimension in the Z-direction) of the grip section is designed to be at least according to the thickness of the energy storage unit, and is thus greater than the thickness of the emergency interface. By providing the protruding structure in the first housing, it can compensate for this thickness difference and facilitate positioning installation of the emergency interface.

Meanwhile, the thickness direction (the smallest dimension) of the emergency interface can be arranged perpendicular to the second direction (the extension direction of the grip portion), and thus parallel to the thickness direction (the smallest dimension) of the energy storage assembly. Such an arrangement reduces the thickness of the grip portion while allowing its handle to be longer, making the device more comfortable to hold and easier to apply force.

In a second aspect, the present disclosure provides an air-blowing device, comprising: a housing; an energy storage unit, wherein the energy storage unit is provided in the housing and comprises an emergency interface, which is configured to be electrically connected to a vehicle, so as to enable emergency starting of the vehicle; a blowing unit, wherein the blowing unit is provided in the housing and is electrically connected to the energy storage unit.

In some embodiments, the air-blowing device further comprises a control assembly, wherein the control assembly is electrically connected to the blowing unit and to the energy storage unit, and the control assembly is used to control the starting/stopping of the blowing unit.

In some embodiments, the control assembly comprises: a circuit board, wherein the circuit board is provided in the housing and is electrically connected to the blowing unit and to the energy storage unit; a first switch, wherein the first switch is electrically connected to the circuit board and is used to control a power supply from the energy storage unit to be connected or disconnected; a second switch, wherein the second switch is electrically connected to the circuit board and is used to control the starting/stopping of the blowing unit when the energy storage unit is supplying power.

In some embodiments, the circuit board is connected to the housing by insertion; and/or, the circuit board is fixedly connected to the housing via a fastener; and/or, the circuit board is connected to the housing by adhesive bonding.

In some embodiments, the energy storage unit comprises: an emergency battery cell, wherein the emergency battery cell is provided in the housing and is electrically connected to the control assembly; and a power connecting wire, wherein the power connecting wire is electrically connected to the emergency battery cell or to the control assembly; the power connecting wire is provided with an emergency interface; and the control assembly is used to control the power supply from the emergency cell to the power connecting wire to be connected or disconnected.

In some embodiments, the emergency battery cell is connected to the housing by insertion; and/or, the emergency interface is connected to the housing by insertion.

In some embodiments, the housing comprises an airflow section and a grip section, and the blowing unit is located in the airflow section.

In some embodiments, the energy storage unit is located in the grip section.

In some embodiments, the emergency interface is located at an end (a part) of the grip section close to the airflow section and/or at an end (a part) of the grip section away from the airflow section.

In some embodiments, the blowing unit is connected to the housing by insertion/bayonet connection.

In some embodiments, the energy storage unit is provided in the housing. The housing is provided with a power port. The emergency interface is electrically connected to a vehicle through the power port.

The air-blowing device further comprises an insulating protector, wherein the insulating protector is movably connected to the housing, and the insulating protector is used to cover the power port.

For the air-blowing device of the present disclosure, the energy storage unit is able to supply power to the blowing unit, and the blowing unit is able to blow air when it is powered on. Thereby, the air-blowing device is equipped with a function of air blowing. In addition, the energy storage unit further comprises an emergency interface, which is able to be electrically connected to a vehicle to realize emergency starting of the vehicle. Thereby, multiple functions are incorporated in the air-blowing device and the applicability of the device is broadened.

In a third aspect, the present disclosure provides an air-blowing device, comprising: a housing; an energy storage unit, wherein the energy storage unit is provided in the housing and is provided with an emergency interface, the emergency interface is configured to be electrically connected to a vehicle, so as to enable emergency starting of the vehicle; a blowing unit, wherein the blowing unit is located in the housing; the blowing unit is electrically connected to the energy storage unit; and the blowing unit is provided with an air outlet; a flow guide, wherein the flow guide is connected to the housing or to the blowing unit; the flow guide is arranged corresponding to the air outlet; and the flow guide is used to adjust the airflow effect at the air outlet.

In some embodiments, the flow guide comprises a flow-guiding channel, which is in communication with (communicates with) the air outlet, and the airflow output from the air outlet is able to be blown out through the flow-guiding channel.

In some embodiments, the flow-guiding channel comprises a flow converging section and a guiding section, wherein the flow converging section is in communication with (communicates with) the air outlet and the guiding section, and the radial dimension/size of the flow converging section gradually decreases along the direction from the flow converging section to the guiding section.

In some embodiments, the flow guide is detachably connected to the housing.

In some embodiments, the housing is connected to the flow guide by insertion/bayonet connection; and/or, the housing is connected to the flow guide by magnetic connection; and/or, the housing is connected to the flow guide by threaded connection; and/or, the housing is in interference fit with the flow guide.

In some embodiments, one selected from the housing and the flow guide is provided with a guiding groove, and the other is provided with a protrusion. The protrusion is movably inserted in the guiding groove, so that the protrusion is able to move relative to the guiding groove until the housing is connected to the flow guide by insertion/bayonet connection.

By using a flow guide, the air-blowing device of the present disclosure is able to adjust the airflow effect at the air outlet, for example, making the airflow more concentrated or expanding the airflow coverage, so as to improve the working efficiency of the air-blowing device when performing dust removal and snow removal by airflow. In addition, the flow guide is detachably connected, so that a user can replace various flow guides with different structures. This enables the air-blowing device to provide diversified airflow effects, so as to improve the adaptability of the air-blowing device, and make the air-blowing device applicable to more scenarios.

In a fourth aspect, the present disclosure provides an air-blowing device, comprising: a housing, wherein the housing comprises an accommodating cavity, wherein the accommodating cavity comprises a first accommodating cavity and a second accommodating cavity. The housing comprises an airflow section extending along a first direction and a grip section extending along a second direction. The airflow section corresponds to the first accommodating cavity, the grip section corresponds to the second accommodating cavity, and the first direction and the second direction form a preset angle; a blowing unit, wherein the blowing unit is located in the first accommodating cavity; an emergency battery cell, wherein the emergency battery cell is located in the second accommodating cavity; the grip section is provided with an emergency interface; the emergency interface is electrically connected to the emergency battery cell; and the emergency interface is used for emergency starting; a circuit board, wherein the circuit board is located in the accommodating cavity; the circuit board, the blowing unit and the battery cell are electrically connected.

In some embodiments, the preset angle ranges from 60° to 150°; and/or, the grip section is foldable.

In some embodiments, the housing (in the second accommodating cavity) is provided with at least one fixing plate and multiple fixing members. The fixing plate (fixing plates) and multiple fixing members enclose a placement slot, and the emergency battery cell is mounted in the placement slot; therein, one surface of the fixing plate is used to place the circuit board, and the other surface of the fixing plate is connected to the emergency battery cell.

In some embodiments, the blowing unit comprises an air-blowing motor and a motor sleeve, and the motor sleeve is disposed around the periphery of the air-blowing motor, i.e. disposed on a circumferential side of the air-blowing motor.

In some embodiments, the housing (in the first accommodating cavity) is provided with one selected from a first bayonet catch and a first bayonet slot, and the other from the first bayonet catch and the first bayonet slot is correspondingly provided on a peripheral (circumferential) side of the motor sleeve. The first bayonet slot cooperates (matches) with the first bayonet catch, so as to connect the motor sleeve to the housing.

In some embodiments, the blowing unit further comprises a filter screen. The airflow section is provided with a first opening and a second opening, which are opposite to each other, along the first direction. The first accommodating cavity communicates with the first opening and with the second opening. The filter screen may be located at the first opening and/or the second opening. An inlet of airflow channel of the blowing unit is located corresponding to the first opening, and an outlet of airflow channel of the blowing unit is located corresponding to the second opening.

In some embodiments, the housing (in the first accommodating cavity) is provided with one selected from a second bayonet catch and a second bayonet slot, and the other from the second bayonet catch and the second bayonet slot is correspondingly provided on the filter screen. The second bayonet slot cooperates (matches) with the second bayonet catch, so as to connect the filter screen to the housing.

In some embodiments, the housing comprises a first housing and a second housing, and the first housing and the second housing are detachably connected, so as to form the accommodating cavity.

In some embodiments, the blowing unit comprises an air pump. The handheld air-blowing device further comprises a tire-pressure sensor and an inflation connector. The tire-pressure sensor is located on/at/in the inflation connector, and the inflation connector communicates with the air pump.

In some embodiments, the housing is further provided with a signal light and/or a display screen, wherein the signal light and/or the display screen is electrically connected to the circuit board, so as to display the operating information (working information) of the handheld air-blowing device.

In the handheld air-blowing device of the present disclosure, the housing comprises an airflow section extending along a first direction and a grip section extending along a second direction. The airflow section corresponds to a first accommodating cavity, and the grip section corresponds to a second accommodating cavity. The first direction and the second direction form a preset angle. The blowing unit is located in the first accommodating cavity, and the emergency battery cell is located in the second accommodating cavity. The handheld air-blowing device is provided with a grip section for easy holding by a user. Furthermore, the emergency battery cell of the handheld air-blowing device is located in the grip section, forming a compact structure. Therefore, the handheld air-blowing device has the advantages of practical functionality, compact structure, and ease of use, and is able to be used as an emergency starting power supply.

In a fifth aspect, the present disclosure provides an air-blowing device, comprising: a housing, wherein the housing comprises an airflow section and a grip section; a blowing unit, wherein the blowing unit is located in the airflow section; an emergency battery cell, wherein the emergency battery cell is located in the grip section; the grip section is provided with an emergency interface; the emergency interface is electrically connected to the emergency battery cell; and the emergency interface is used for emergency starting; a circuit board, wherein the circuit board is located in the airflow section and/or in the grip section, and the circuit board is electrically connected to the blowing unit and to the emergency battery cell; a button assembly, wherein the button assembly comprises a first button and a second button; the first button and the second button are located in the grip section and are located at a part of the grip section close to the airflow section; the first button is used to control the power supply from the emergency battery cell via the circuit board, and the second button is used to control a working mode (operating mode) or an air-blowing level (airflow level) of the air-blowing device via the circuit board.

In some embodiments, the emergency interface is located in the grip section and is located at a part of the grip section away from the airflow section.

In some embodiments, the air-blowing device further comprises an insulating protector. A protector seat is provided in/on the grip section. A connecting section is provided on one side of the insulating protector. The connecting section is connected to the protector seat by insertion. The insulating protector is able to cover the emergency interface.

In some embodiments, the second button is located on a second side of the grip section, wherein the second side of the grip section faces (towards) the second air outlet of the air-blowing device; the first button is located on a first side of the grip section, and the second side is adjacent to the first side.

In some embodiments, the first button and/or the second button comprises a pressing section, an elastic arm, and a fixing section. The pressing section is connected to the fixing section through the elastic arm, and the fixing section is connected to the inner wall of the housing. The housing is provided with a pressing opening (an opening for pressing), wherein the pressing section of the first button and/or the second button passes through the pressing opening and protrudes out of the housing.

In some embodiments, the emergency interface is provided with a first electrical connecting socket and a second electrical connecting socket. The first electrical connecting socket and the second electrical connecting socket are respectively connected to the cathode and anode of the device (which needs emergency starting) through their respective electrical wires, so as to enable the function of emergency starting. The first electrical connecting socket and the second electrical connecting socket may have different shapes, so that the first electrical connecting socket is not able to be connected to the electrical wire corresponding to the second electrical connecting socket, and the second electrical connecting socket is not able to be connected to the electrical wire corresponding to the first electrical connecting socket.

In some embodiments, the housing is further provided with a first charging/discharging port and/or a second charging/discharging port. The first charging/discharging port may be a USB port, and the second charging/discharging port may be a Type-C port. The first charging/discharging port and the second charging/discharging port are electrically connected to the circuit board or to the emergency battery cell.

In the air-blowing device of the present disclosure, the first button and the second button are located in the grip section and are located at a part of the grip section close to the airflow section.

Therein, the first button is used to control the power supply from the emergency battery cell via the circuit board, and the second button is used to control the working mode (operating mode) or air-blowing level of the air-blowing device via the circuit board. This design not only allows a user to hold and operate the device with one hand, but also has a simple structure, a low material cost, and a good user experience. Therefore, the air-blowing device has the advantages of easy operation, practical functions and so on.

In a sixth aspect, the present disclosure provides a control circuit, which is used for an air-blowing device. The control circuit comprises: an emergency battery cell, wherein the emergency battery cell is connected to an emergency interface of the air-blowing device, and the emergency interface is used for emergency starting; a driving module, wherein a first terminal of the driving module is connected to the emergency battery cell, and a second terminal of the driving module is connected to an air-blowing motor of the air-blowing device; a first control module, wherein the first control module is connected to a control terminal of the driving module and is configured to drive the air-blowing motor to blow air via the drive module.

In some embodiments, the control circuit further comprises: a protection module, which is used for connecting the emergency battery cell to the emergency interface; and a second control module, wherein the second control module is connected to the protection module and is configured to control an on/off state of the protection module (control the connection and disconnection of the protection module), so as to control the supply power from the emergency battery cell to an external device (via the emergency interface).

For example, the control circuit further comprises: a first triggering module, which is configured to receive a triggering operation by a user and then generate a first triggering signal; the first triggering module is connected to the second control module, and the second control module is configured to control the on and off of the protection module according to the first triggering signal.

In some embodiments, the control circuit further comprises: a battery detection module, wherein the battery detection module is connected to the emergency battery cell and to the first control module respectively, and the battery detection module generates a first detection signal for the emergency battery cell; if the first detection signal indicates that the emergency battery cell is abnormal, the first control module controls the driving module to stop the air-blowing motor from blowing air.

For example, the first detection signal comprises at least one or more selected from a battery-voltage detection signal, a battery-current detection signal, and a battery-temperature detection signal; the battery detection module further comprises: a battery-voltage detection unit, wherein the battery-voltage detection unit is connected to the emergency battery cell and to the control module respectively, and is configured to generate a battery-voltage detection signal; if the battery-voltage detection signal indicates that the emergency battery cell is under-voltage, the first control module controls the switch module to turn off, and stops (via the driving module) the air-blowing motor from blowing air; and/or, a battery-current detection unit, wherein the battery-current detection unit is connected to the emergency battery cell and to the control module respectively, and is configured to generate a battery-current detection signal; if the battery-current detection signal indicates that the emergency battery cell is over-current, the first control module controls the switch module to turn off, and stops (via the driving module) the air-blowing motor from blowing air; and/or, a battery-temperature detection unit, wherein the battery-temperature detection unit is connected to the emergency battery cell and to the control module respectively, and is configured to generate a battery-temperature detection signal; if the battery-temperature detection signal indicates that the emergency battery cell is overheating, the first control module controls the switch module to turn off, and stops (via the driving module) the air-blowing motor from blowing air.

In some embodiments, if the battery-voltage detection signal indicates that the battery is over-voltage, and/or if the battery-current detection signal indicates that the battery is over-current, the control module controls the emergency battery cell to stop charging.

In some embodiments, the control circuit further comprises: a second triggering module, wherein the second triggering module is connected to the first control module. The second triggering module is configured to generate a second triggering signal, when the second triggering module is triggered. The first control module is configured to drive (start) or stop the air blowing of the air-blowing motor according to the second triggering signal.

In some embodiments, a power-supply voltage of the emergency battery cell is input to the driving module. The control unit uses the driving module to convert the power-supply voltage into a driving voltage, so that the driving voltage drives the air-blowing motor to blow air.

For example, the air-blowing motor comprises N air-blowing levels, wherein N is a positive integer greater than or equal to 2.

In some embodiments, the control circuit further comprises: a motor detection module, wherein the motor detection module is connected to the air-blowing motor and to the first control module respectively, and is configured to generate a second detection signal for the air-blowing motor. If the second detection signal indicates that air-blowing motor is abnormal, the first control module stops (via the driving module) the air-blowing motor from blowing air.

For example, the second detection signal comprises at least one or more selected from a motor-current detection signal and a motor-temperature detection signal; the motor detection module further comprises: a motor-current detection unit, wherein the motor-current detection unit is connected to the air-blowing motor and to the first control module respectively, and is configured to generate a motor-current detection signal. If the motor-current detection signal indicates that the air-blowing motor is over-current, the first control module stops (via the driving module) the air-blowing motor from blowing air; and/or, a motor-temperature detection unit, wherein the motor-temperature detection unit is connected to the air-blowing motor and to the first control module respectively, and is configured to generate a motor-temperature detection signal. If the motor-temperature detection signal indicates that the air-blowing motor is overheating, the first control module stops (via the driving module) the air-blowing motor from blowing air.

In some embodiments, the control circuit further comprises: a warning module, wherein the warning module is connected to the first control module. If the emergency battery cell is abnormal, and/or the air-blowing motor is abnormal, the first control module controls the warning module to perform a warning.

In some embodiments, the driving module comprises: a first switching unit, wherein a first terminal of the first switching unit is connected to the emergency battery cell, a second terminal of the first switching unit is connected to a preset ground terminal, and a control terminal of the first switching unit is connected to the control module; an interface unit, wherein an output terminal of the interface unit is configured to be connected to the air-blowing motor; an input terminal of the interface unit is connected to a point between the emergency battery cell and the first terminal of the first switching unit, or is connected to a point between the second terminal of the first switching unit and the ground terminal; therein, the first control module controls the first switching unit to be turned on via the control terminal of the first switching unit, so as to supply power to the interface unit and drive the air-blowing motor to blow air.

In addition, the present disclosure provides an air-blowing device, wherein the air-blowing device comprises an emergency interface, an air-blowing motor, and the above-mentioned control circuit. The control circuit is connected to the emergency interface, and is used to control the emergency interface to perform emergency starting. The control circuit is connected to the air-blowing motor and is used to drive the air-blowing motor to blow air.

In some embodiments, the air-blowing device further comprises: a housing, wherein the housing is configured to accommodate the air-blowing motor and at least a part of the first control circuit; the housing comprises an air outlet and an air inlet; when the air-blowing motor is working (in operation), air enters from the air inlet, and is blown by the air-blowing motor towards the air outlet; and a flow guide, which is configured to be connected to the air outlet and is configured to adjust the airflow effect at the air outlet.

For example, the flow guide has an air-inlet side which is connected to the air outlet (of the air-blowing device), and an air-outlet side which is used for air output. The area of the air-inlet side of the flow guide is smaller/larger than the area of the air-outlet side of the flow guide.

In some embodiments, the air-blowing motor comprises a motor and an impeller (blower blade, fan blade), wherein the motor and the impeller are enclosed in a same housing; the air-blowing device blows air for cleaning purposes, including blowing away dust, debris, or snow; the emergency interface of the air-blowing device is configured to be connected to an external vehicle, so as to supply power for vehicle starting.

The present disclosure provides a control circuit and an air-blowing device. The control circuit enables a same emergency battery cell to supply power for emergency starting and to supply power to the air-blowing device. Furthermore, the control circuit may comprise a plurality of protection modules, which firstly extends the service life of the battery, and secondly protects the motor. In addition, the control circuit may provide a plurality of selectable air-blowing levels for the air-blowing device, which facilitates selecting appropriate blowing speeds in different scenarios.

In a seventh aspect, the present disclosure provides a portable tool, comprising: an energy storage unit, a blowing unit, and a suction assembly; the suction assembly may be configured to be connected to an air inlet of the blowing unit. In some embodiments, the energy storage unit may be an emergency battery cell, and is connected to an emergency interface, so that the energy storage unit can be used for emergency starting of a vehicle.

In some embodiments, the suction assembly and the blowing unit are detachably connected. In some embodiments, the suction assembly and the blowing unit are connected by insertion/bayonet connection, and/or magnetic connection, and/or threaded connection, and/or in interference fit. In so me embodiments, the suction assembly comprises a first magnetic member, and the housing or the blowing unit is provided with a second magnetic member; therein, the first magnetic member and the second magnetic member are configured to attract each other when they come close to each other.

In some embodiments, the housing or the blowing unit is provided with an air-inlet grille at the air inlet, an embedding seat is provided on/in/at the air-inlet grille, and the embedding seat is used for embedding the first magnetic member; the suction assembly comprises a suction connector, and a second magnetic member corresponding to the first magnetic member is provided on/in/at the suction connector.

In some embodiments, the air-inlet grille is annular, and the magnetic member is embedded at the center of the circle. In some embodiments, the air-inlet grille is circular, and M magnetic members are distributed in the circle with central symmetry, wherein M is an integer greater than or equal to 2, preferably 3 or 4. In some embodiments, the first/second magnetic member is fixed to the corresponding embedding seat by adhesive bonding. In some embodiments, when connected, the suction connector is sleeved over the outer side of the outer circumference of the housing or sleeved over the outer side of the outer circumference of the air-inlet grille. In some embodiments, the suction assembly comprises a suction body, and the suction body comprises a suction port, a filter member, and a dust chamber. In some embodiments, the suction assembly may further comprise a suction tube. One end of the suction tube is configured to be connected (for example, detachably connected) to the suction port of the suction body, and the other end of the suction tube may have a converging structure. In some embodiments, the suction assembly may further comprise a suction brush. The suction brush may be detachably connected to the suction port of the suction body or to one end of the suction tube.

Through the connection between the suction assembly and the blowing unit, a complete airflow channel for a vacuum cleaner may be formed, so that the device has the function of a vacuum cleaner. The device may be used to suck in dust (debris), so as to clean the interior (e.g., seats) of a vehicle. Through the detachable connection (especially the magnetic connection) between the suction assembly and the blowing unit, the suction assembly may be easily removed (detached) and installed, thereby achieving the convenience in use and in storage/carrying.

The present disclosure integrates (incorporates) multiple functions (such as functions of an emergency starting, an air-blowing device, and a vacuum cleaner) into one unit, so that a user does not need to carry multiple devices, thereby greatly improving the practicality and convenience of the product.

In an eighth aspect, the present disclosure provides a portable tool, comprising a housing and a safety hammer section. In some embodiments, an energy storage unit is provided in the housing. In some embodiments, a blowing unit is further provided in the housing. In some embodiments, the safety hammer section is detachably connected to the housing, for example, connected to a first air port (air suction port (air inlet)) of the housing or a second air port (air outlet) of the housing. In some embodiments, the energy storage unit may be an emergency battery cell and is connected to an emergency interface, so that the energy storage unit can be used for emergency starting of a vehicle. In some embodiments, the safety hammer section comprises a hammer head and a safety-hammer body. In some embodiments, the safety-hammer body comprises a mounting seat, which is used for mounting the hammer head. In some embodiments, a through hole is provided at a bottom of the mounting seat of the safety-hammer body, an inserting pin is provided at a bottom of the hammer head. The inserting pin of the hammer head passes through the through hole at the bottom of the mounting seat of the safety-hammer body, and the protruding portion of the pin can be fixed by adhesive. In some embodiments, the safety-hammer body is hollowed out. In some embodiments, a plurality of air ports is provided on/in the safety-hammer body. For example, at least one through hole is provided in the lateral direction(s) of the safety-hammer body (in the direction(s) perpendicular to the first direction). The plurality of through holes form air ports.

In some embodiments, the safety-hammer body comprises a safety-hammer connecting section, which is used for connecting the safety hammer section to the housing. In some embodiments, the connection between the safety hammer section and the housing may be an insertion/bayonet connection. In some embodiments, the connection between the safety hammer section and the housing adopts substantially the same connection manner as that between a flow guide and the housing, or adopts substantially the same connection manner as that between the suction assembly and the housing. In some embodiments, the safety-hammer body preferably uses a plastic material with a certain degree of elasticity. The connection (joint) between the safety-hammer body and the hammer head, and/or the connection (joint) between the safety-hammer body and the housing are all designed to have an appropriate degree of interference fit (in sizes/dimensions). In some embodiments, the portable tool is further provided with an illumination unit, and the illumination unit is arranged on the same side as the safety hammer section. In some embodiments, the housing or the blowing unit is provided with an air-inlet grille at the air inlet and/or an air-outlet grille at the air outlet. An illumination fixing member is provided on/in/at the air-inlet grille or the air-outlet grille, for example, at the center of the grille. The illumination fixing member is used for installing/fixing the illumination unit.

When the safety hammer section is connected to the housing, the portable tool may be used as a safety hammer. A user may align the sharp end of the safety-hammer head to a weak portion of the glass, such as an edge or a corner of the glass, then hold the grip section of the housing (like the handle of a safety hammer), and swing the handle to apply impact force. By the concentrated stress at the sharp end of the safety hammer, the glass can be easily broken. The safety-hammer body is used to stably mount the hammer head, thereby preventing the hammer head from falling off during swinging. The safety-hammer body may be provided with an air port (through hole/grille), which may allow air to pass through (without affecting the air blowing/vacuuming function of the air-blowing device) and may also allow light to pass through (so that the built-in illumination unit can provide auxiliary illumination).

### BRIEF DESCRIPTION OF DRAWINGS

In order to describe the technical solutions of the embodiments of the present application more clearly, the drawings used in the embodiment description are briefly described below. It is evident that the drawings used in the following description are only some embodiments of the present application, and a person skilled in the art may obtain some other drawings based on these drawings without creative effort.

FIG. 1 is a schematic diagram from a viewing angle, showing the structure of an air-blowing device according to an embodiment of the present disclosure.

FIG. 2 is a schematic diagram from another viewing angle, showing the structure of an air-blowing device according to an embodiment of the present disclosure.

FIG. 3 is a schematic diagram showing the structure of an air-blowing device (wherein a part of the housing is omitted), according to an embodiment of the present disclosure.

FIG. 4 is an exploded view of the structure of an air-blowing device, according to an embodiment of the present disclosure.

FIG. 5 is a schematic diagram showing the structure of a flow guide, according to an embodiment of the present disclosure.

FIG. 6 is a half-sectional view of the flow guide in FIG. 5.

FIG. 7 is a schematic diagram showing the structure of a flow guide, according to an embodiment of the present disclosure.

FIG. 8 is a half-sectional view of the flow guide in FIG. 7.

FIG. 9 is a schematic diagram showing the structure of a flow guide, according to an embodiment of the present disclosure.

FIG. 10 is a half-sectional view of the flow guide in FIG. 9.

FIG. 11 is an exploded view of the structure of an air-blowing device, according to an embodiment of the present disclosure.

FIG. 12 is an enlarged view of part A in FIG. 11.

FIG. 13 is a schematic diagram showing the structure of a handheld air-blowing device according to an embodiment of the present disclosure, wherein some components therein are exploded.

FIG. 14 is a schematic diagram showing the structure of an air-blowing device according to an embodiment of the present disclosure, wherein some components therein are exploded.

FIG. 15 is a schematic diagram showing the structure of partial components of an air-blowing device, according to an embodiment of the present disclosure.

FIG. 16 is a schematic diagram showing the structure of a first button of an air-blowing device, according to an embodiment of the present disclosure.

FIG. 17 is a schematic diagram showing the structure of a second button of an air-blowing device, according to an embodiment of the present disclosure.

FIG. 18 is a schematic diagram showing the structure of one embodiment of the present disclosure having a suction assembly.

FIG. 19 is a schematic diagram showing the structure of the suction assembly of the present disclosure.

FIG. 20 is an exploded view showing the structure of one embodiment of the present disclosure having a suction assembly.

FIG. 21 is a schematic diagram showing a magnetic connection structure of the present disclosure.

FIG. 22 is a schematic diagram showing the structure of one embodiment of the present disclosure having a safety hammer section.

FIG. 23 is a schematic diagram showing the structure of the safety hammer section according to the present disclosure, together with a partial sectional view thereof taken along direction A-A.

FIG. 24 is a schematic diagram showing the structure of one embodiment of the present disclosure having a safety hammer section and a suction assembly.

FIG. 25 is a schematic diagram showing the structure of a battery clamp of an air-blowing device, according to an embodiment of the present disclosure.

FIG. 26 is a schematic diagram showing the structure of a circuit board, according to an embodiment of the present disclosure.

FIG. 27 is a diagram showing a part of the structure of a housing, according to an embodiment of the present disclosure.

FIG. 28 is a diagram showing a part of the structure according to an embodiment of the present disclosure.

FIG. 29 is a schematic diagram showing the structure of a housing, according to an embodiment of the present disclosure.

FIG. 30 is a schematic diagram showing the structure of a housing, according to an embodiment of the present disclosure.

FIG. 31 is a schematic block diagram of a first control circuit according to an embodiment of the present disclosure.

FIG. 32 is a schematic block diagram of a second control circuit according to an embodiment of the present disclosure.

FIG. 33 is a schematic block diagram of a third control circuit according to an embodiment of the present disclosure.

FIG. 34 is a schematic block diagram of a fourth control circuit according to an embodiment of the present disclosure.

FIG. 35 is a schematic block diagram of a fifth control circuit according to an embodiment of the present disclosure.

FIG. 36 is a schematic block diagram of a sixth control circuit according to an embodiment of the present disclosure.

FIG. 37 is a schematic block diagram of a first drive module according to an embodiment of the present disclosure.

FIG. 38 is a schematic block diagram of a second drive module according to an embodiment of the present disclosure.

FIG. 39 is a schematic circuit block diagram of a drive module according to an embodiment of the present disclosure.

FIG. 40 is a schematic block diagram of a seventh control circuit according to an embodiment of the present disclosure.

FIG. 41 is a schematic block diagram of an air-blowing device according to the present disclosure.

### DESCRIPTION OF REFERENCE SIGNS

40, housing; 10a, accommodating cavity; 10b, first air port (air inlet); 10c, second air port (air outlet); 10d, power port; 10e, mounting slot; 101, protrusion; 1011, insertion slot; 110, airflow section; 111, first airflow section; 112, second airflow section; 120, grip section; 121, first grip section; 122, second grip section; 101, first housing; 102, second housing; 1001, first accommodating cavity; 1002, second accommodating cavity; 401, first housing; 402, second housing; 403, third housing; 4021, first opening; 4031, second opening; 433, button; 4331, button leg; 4332, button head; 4333, button plate; 4019, protruding structure; 4022, first mounting seat; 4023, second mounting seat; 1011, first protruding portion; 1012, first insertion member; 1013, second insertion member; 1014, second protruding portion; 11a, first bayonet catch; 11b, second bayonet catch; 11c, first bayonet slot; 11d, second bayonet slot; 12, grip section; 131, fixing plate; 132, fixing member; 133, placement slot; 200, blowing unit; 20a, air outlet; 21, air-blowing motor; 22, filter mesh (grille component); 221, air-inlet grille; 222, air-outlet grille; 23, motor sleeve; 300, energy storage unit; 31, emergency battery cell; 32, emergency interface; 33, power connecting wire; 1201, pressing opening; 3201, first electrical connecting socket; 3202, second electrical connecting socket; 4201, first button; 4301, second button; 44, button assembly; 4401, pressing section; 4402, elastic arm; 4403, fixing section; 71, first charging/discharging port; 72, second charging/discharging port; 10, control assembly; 41, circuit board; 411, first sub-circuit board; 412, second sub-circuit board; 413, connecting column; 42, first switch; 421, switch body; 422, button; 43, second switch; 50, insulating protector; 51, connecting member; 52, protector seat; 60, flow guide; 61, flow-guiding channel; 611, flow converging section; 612, guiding section; 601, guide groove; 6011, locking block; 70, charging/discharging socket; 80, safety hammer section; 81, hammer head; 82, safety-hammer body; 83, safety-hammer connecting section; 90, suction assembly; 91, suction body; 92, suction brush head; 93, suction tube; 94, suction connector; 991, first magnetic member; 992, second magnetic member; 88, illumination unit; 89, illumination fixing member; 900, battery clamp; 901, circuit section; 902, power-input interface; 903, power-output interface; 100, air-blowing device; 10, control circuit; 11, emergency battery cell; 12, drive module; 121, first switching unit; 122, interface unit; 13, first control module; 14, protection module; 15, second control module; 16, battery detection module; 161, battery-voltage detection unit; 162, battery-current detection unit; 163, battery-temperature detection unit; 17, first triggering module; 18, second triggering module; 19, motor detection module; 13a, warning module; 20, emergency interface; 30, air-blowing motor; 40, ground terminal.

### DETAILED DESCRIPTION OF EMBODIMENTS

The technical solutions in the embodiments of the present disclosure are described clearly and completely below with reference to the accompanying drawings of the embodiments. Evidently, the described embodiments are only part of the embodiments of the present disclosure, rather than all of the embodiments.

Based on the embodiments of the present disclosure, any other embodiments obtained by a person skilled in the art without creative effort shall fall within the protection scope of the present disclosure.

It should be understood that, as used in this specification and the appended claims, singular forms such as “a,” “an,” and “the” are intended to include plural forms unless the context clearly indicates otherwise.

All directional indications in the embodiments of this application (such as up, down, left, right, front, and rear) are only used to explain relative positional relationships and movement conditions among components under a specific posture; when the specific posture changes, such directional indications change accordingly.

In the present disclosure, “vertical” includes a “substantially vertical” state. If a difference between an angle formed by two directions and 90 degrees is smaller than a threshold (for example, 2 degrees, 5 degrees, or 10 degrees), the two directions can be deemed to be substantially perpendicular to each other.

In the present disclosure, “parallel” includes a “substantially parallel” state. If an included angle formed by two directions is smaller than a threshold (for example, 2 degrees, 5 degrees, or 10 degrees), the two directions can be deemed to be substantially parallel to each other.

It should also be understood that when an element is described as being “fixed to/on” or “disposed on” another element, it may be placed directly on/to the other element, or there may be an intermediate element present therebetween. When one element is described as being “connected” to another element, it may be directly connected to the other element or indirectly connected to the other element through an intermediate element.

It should be noted that, unless otherwise expressly specified and limited, terms such as “mounted,” “connected,” and “coupled” are to be understood in a broad sense; for example, the connection may be fixed, detachable, or integral. The connection may be a mechanical connection or an electrical connection. The connection may be direct or indirect through an intermediate medium, and may be internal communication between two elements or an interaction relationship between two elements. A person skilled in the art may understand the specific meanings of the above terms in the present disclosure based on actual scenarios.

Terms used in this specification are only for describing specific embodiments and are not intended to limit the present application. Descriptions involving “first,” “second,” etc. in this application are for descriptive purposes only, and shall not be understood as indicating or implying relative importance, or as implicitly indicating the number of the technical features. Accordingly, a feature defined as “first” or “second” may explicitly or implicitly include at least one such feature. For example, the first triggering module and the second triggering module are only used to distinguish different triggering modules, and do not limit any sequence therebetween. A person skilled in the art can understand that terms such as “first” and “second” do not limit the quantity or the execution order, nor do they require that the features modified by such terms must be different.

It should be further understood that the term “and/or” used in this specification and the appended claims refers to any one or any combination of the associated listed items as well as all possible combinations thereof, and includes such combinations.

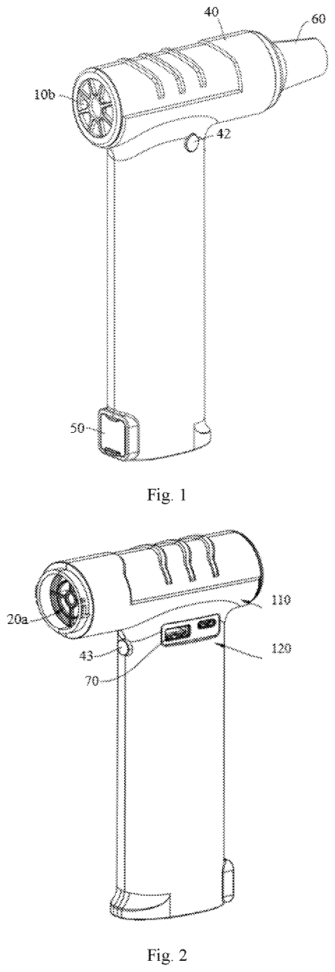

Referring to FIGS. 1 to 4, an embodiment of the present disclosure provides an air-blowing device, comprising a housing 40, an energy storage unit 300, and a blowing unit 200. The energy storage unit 300 is disposed in the housing 40. Optionally, the energy storage unit 300 may be connected to an emergency interface 32, wherein the emergency interface 32 is configured to be electrically connected to a vehicle, so as to enable emergency starting of the vehicle. The blowing unit 200 is disposed in the housing 40, and the blowing unit 200 is electrically connected to the energy storage unit 300. The blowing unit 200 has an air outlet 20a.

For the air-blowing device in this embodiment of the present disclosure, the energy storage unit 300 is able to supply power to the blowing unit 200, and the blowing unit 200 is able to blow air when it is powered on. Thereby, the air-blowing device is equipped with a function of air blowing.

For example, dust and debris are likely to accumulate in positions such as door gaps and window gaps of a vehicle. The air-blowing device can be used to blow away such dust and debris, thereby cleaning the vehicle body. For example, in severe rainy or snowy weather, when a large amount of standing water or snow accumulates on the vehicle body surface, the air-blowing device can be used to blow away the water or snow.

Besides, the energy storage unit 300 may be connected to an emergency interface 32, which is able to be electrically connected to a vehicle to perform emergency starting of the vehicle. Thereby, the air-blowing device has an emergency-start function. Thereby, multiple functions are incorporated in the air-blowing device, which can improve the applicability of the air-blowing device and satisfy different user needs.

A vehicle battery is a key component for vehicle starting; once the battery power is depleted, the vehicle cannot start normally. In the present disclosure, the air-blowing device of the present disclosure can be connected, via the emergency interface 32, to the positive and negative terminals of a vehicle battery, so as to use the energy storage unit 300 to perform emergency starting.

Components that may be present in the air-blowing device of the present disclosure are further described in detail below with examples.

### Housing

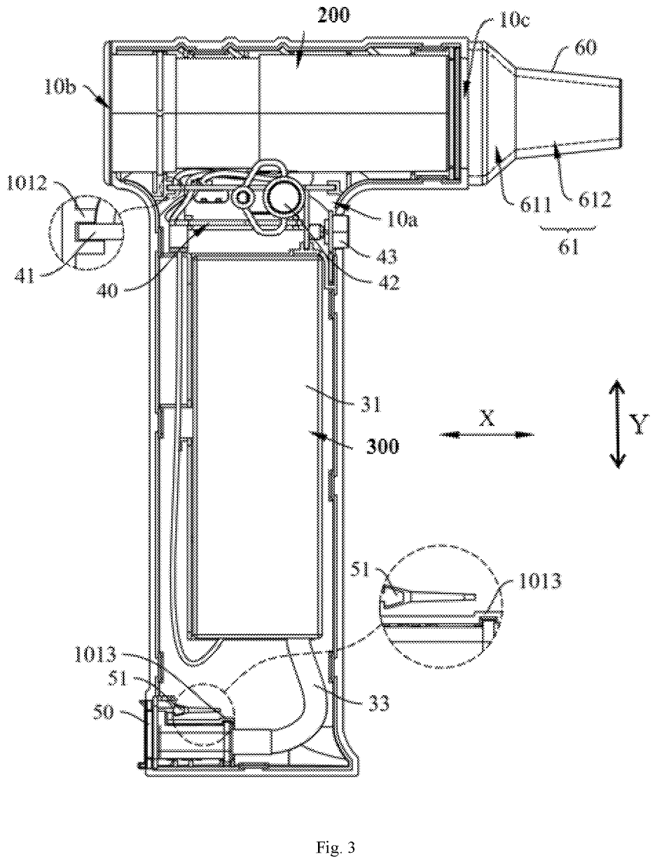

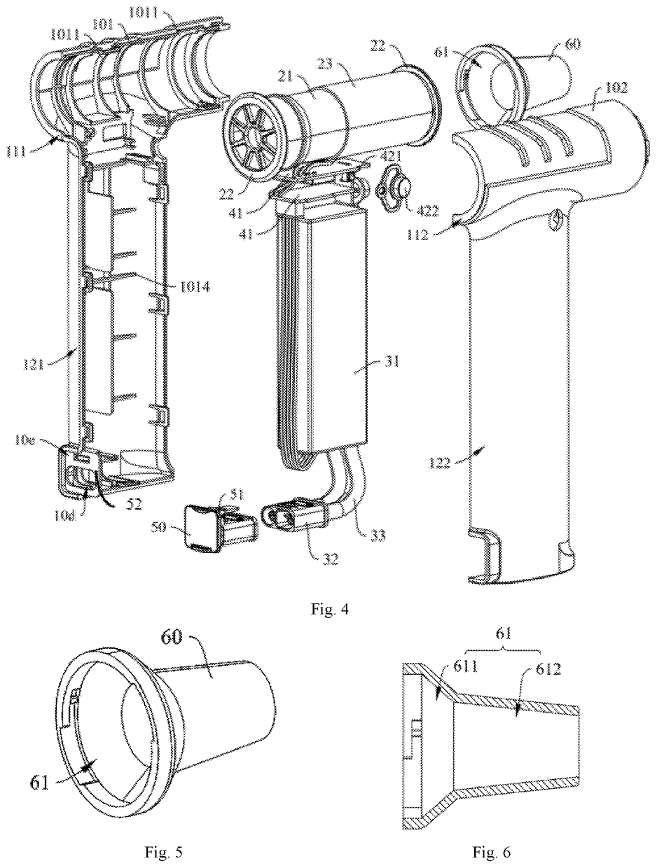

As shown in FIGS. 3 and 4, in some embodiments, the housing 40 has an accommodating cavity 10a; the blowing unit 200 and/or the energy storage unit 300 may be disposed in the accommodating cavity 10a; the housing 40 serves to protect the blowing unit 200 and/or the energy storage unit 300.

For example, as shown in FIG. 4, the housing 40 comprises a first housing 101 and a second housing 102, and the first housing 101 and the second housing 102 are connected and jointly define/enclose the accommodating cavity 10a.

For example, the first housing 101 and the second housing 102 may be connected by snap connection, or may be fastened together by a fastener.

In some embodiments, the first housing 101 and the second housing 102 may be detachably connected. Through the detachable design of the first housing 101 and the second housing 102, users and manufacturers can conveniently perform operations such as disassembly, installation, maintenance, debugging, cleaning, and modification on the handheld air-blowing device.

In some embodiments, the housing 40 has a first air port 10b and a second air port 10c that communicate with the accommodating cavity 10a. The blowing unit 200 is disposed in the accommodating cavity 10a, and can suck/draw external air in through the first air port 10b to form airflow, and output the airflow from the air outlet 20a of the blowing unit 200. A flow guide 60 may be arranged around the outer periphery of the second air port 10c; the output airflow passes through the second air port 10c and reaches the flow guide 60, so that the flow guide 60 can adjust the airflow output effect.

For example, the first air port 10b and the second air port 10c may be disposed opposite to each other, or may be located on two adjacent sides of the housing 40.

For example, as shown in FIG. 3, the second air port 10c (the first air port 10b) and the energy storage unit 300 are respectively located on different sides of the blowing unit 200, so as to prevent the energy storage unit 300 from blocking the airflow.

For example, the first housing 101 and the second housing 102 may jointly define/enclose the first air port 10b, and may jointly define/enclose the second air port 10c.

As shown in FIGS. 2 and 3, in some embodiments, the housing 40 comprises an airflow section 110 and a grip section 120, and the blowing unit 200 is located in the airflow section 110. In this way, during use, a user can conveniently hold the grip section 120, so as to control the air-blowing device to blow air in a target direction.

In some embodiments, the accommodating cavity 10a of the housing 40 may comprise a first accommodating cavity 1001 and a second accommodating cavity 1002.

For example, the airflow section 110 corresponds to the first accommodating cavity 1001, and the grip section 120 corresponds to the second accommodating cavity 1002.

The airflow section 110 extends along a first direction; the grip section 120 extends along a second direction.

The first direction is the longitudinal extension direction of the airflow section 110 (the first accommodating cavity 1001), such as the X direction shown in FIG. 3. The first direction is preferably also the longitudinal extension direction of the blowing unit 200, and preferably also the axial direction of the air-blowing motor 21.

The second direction is the longitudinal extension direction of the grip section 120 (the second accommodating cavity 1002), such as the Y direction shown in FIG. 3. The second direction is preferably also the longitudinal extension direction of the energy storage unit 300 (battery cell 31).

In some embodiments, the first direction and the second direction form an angle, such as a preset angle. In some embodiments, the preset angle ranges from 60° to 150°; preferably, it ranges from 70° to 110°; for example, 70°, 80°, 90°, 110°, or 120°. By setting the included angle within the range, the overall housing presents a shape like the numeral “7”. This facilitates user holding and operation.

In some embodiments, the grip section 120 is foldable.

By providing the housing 40 with the airflow section 110 and the grip section 120, or by setting the preset angle range, user holding can be facilitated.

By providing the handheld air-blowing device with a foldable grip section 120, the user can more easily store the handheld air-blowing device, while he can conveniently grip/hold the device. For example, as shown in FIG. 4, the airflow section 110 may comprise a first air outlet portion 111 of the first housing 101 and a second air outlet portion 112 of the second housing 102. The grip section 120 may comprise a first grip portion 121 of the first housing 101 and a second grip portion 122 of a second housing. The accommodating cavity 10a comprises a first cavity and a second cavity. The first air outlet portion 111 and the second air outlet portion 112 jointly define/enclose the first cavity. The first grip portion 121 and the second grip portion 122 jointly define/enclose the second cavity.

Preferably, the blowing unit 200 is disposed in the first accommodating cavity 1001.

Preferably, the energy storage unit 300 is disposed in the second accommodating cavity 1002.

By disposing the energy storage unit 300 in the grip section 120 (the second accommodating cavity 1002) and disposing the blowing unit 200 in the first accommodating cavity 1001, a compact structure can be achieved. The direction (the first direction) of the airflow passage of the blowing unit 200 and the direction (the second direction) in which the grip section 120 extends form an included angle, which facilitates user holding and use.

As shown in FIG. 22, in some embodiments, an anti-slip portion (anti-slip member) may be provided on the surface of the grip section 120 of the housing 40. The anti-slip portion (anti-slip member) may be provided with multiple anti-slip stripes (e.g. two or more, three or more), for example multiple anti-slip stripes (anti-slip grooves and ridges) which are repeatedly arranged. In some embodiments, the anti-slip portion may be integrally formed with the surface of the housing 40, for example be concave and/or convex stripes, for example be integrally formed by compression molding. In some embodiments, the anti-slip member may be an additional anti-slip layer attached (or embedded) on the outer surface of the housing 40, such as a soft rubber layer with texture. By providing the anti-slip portion (anti-slip member/anti-slip layer), the stability of holding/gripping can be improved, and the comfort and convenience during operation can be enhanced.

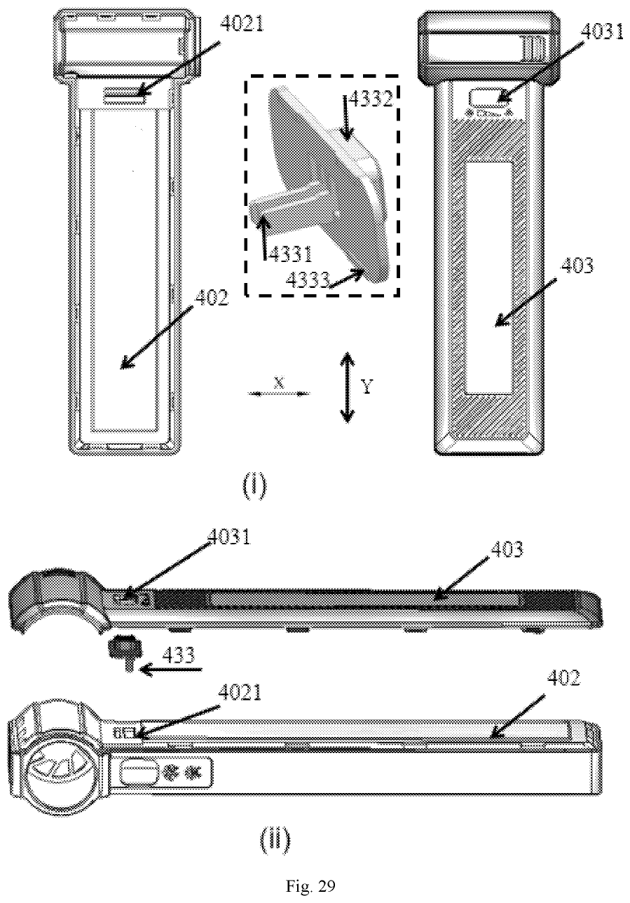

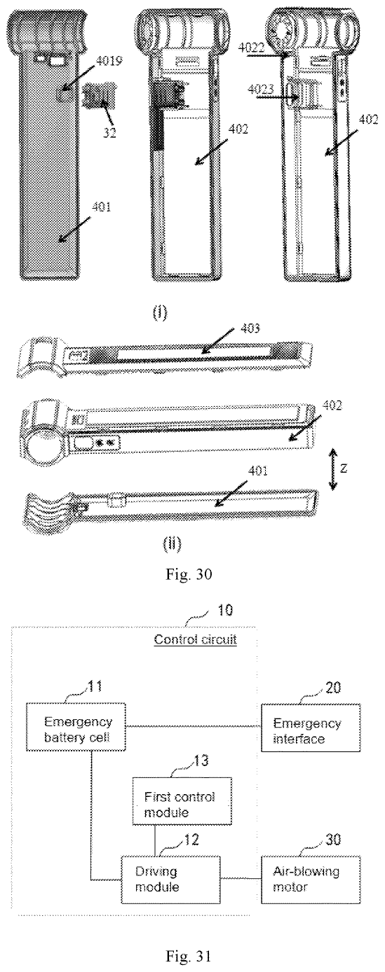

As shown in FIGS. 29 to 30, in some embodiments, the housing 40 may comprise at least three parts, comprising a first housing 401, a second housing 402, and a third housing 403. The first housing 401 and the third housing 403 are mounted on two sides of the second housing 402, respectively. For example, snap-fit connection may be achieved through snaps/slots on the peripheral side of the housing.

After the first housing 401 and the second housing 402 are connected, they jointly define/enclose the accommodating cavity 10a. The accommodating cavity 10a accommodates/houses the air-blowing motor 21, the circuit board 41, and the energy storage unit 300, etc.

The space between the second housing 402 and the third housing 403 may be used for installing a button, for example a button 433 of the second switch 43. As shown in FIG. 29, the second housing 402 has a first opening 4021, and the third housing 403 has a second opening 4031. The sizes of the openings may match the sizes of the button 433. The button 433 has a structure that is larger in the middle and smaller on two sides. The middle button plate 4333 is larger (greater in length and/or width), while the button leg 4331 and the button head 4332 are located on two sides of the button plate 4333 and are smaller (smaller in length and/or width). When the button leg 4331 of the button 433 is inserted into the first opening 4021 on the second housing 402 and the button head 4332 is inserted into the second opening 4031 on the third housing 403, the button plate 4333, due to its larger size (unable to pass through the first opening 4021 or the second opening 4031), is located between the second housing 402 and the third housing 403.

As shown in FIG. 29, in some embodiments, the button 433 is a button of a toggle switch. Accordingly, the dimensional relationship among the first opening 4021, the second opening 4031, and the button 433 may be designed such that the button 433 can be toggled/shifted as a whole along the X direction (or along a direction perpendicular to the Y direction). In other words, the button 433 can be toggled/shifted along the long-side direction (length direction) of the first opening 4021/second opening 4031. Thereby, toggling/switching among different levels (for example, three or more levels) can be achieved.

As an alternative, the button 433 may be installed by providing a blocking plate on the inner side of the second housing 402. In this case, the third housing 403 may be omitted; the button head 4332 of the button 433 passes through an opening on the second housing 402, and the button plate 4333 is mounted between the second housing 402 and the blocking plate.

In some embodiments, as shown in FIG. 30, the first housing 401, the second housing 402, and the third housing 403 are assembled along the Z direction (the Z direction is generally the thickness direction of the battery cell 31 and also the thickness direction of the grip section 120). The second housing 402 has a side wall extending along the Z direction, thereby providing the main part of the accommodating cavity 10a. The first housing 401 serves as a cover and covers one side of the second housing 402.

Multiple (two or more) mounting seats may be provided in the second housing 402 for mounting and positioning different components. These mounting seats may be integrally formed with the second housing 402, for example by compression molding. In some embodiments, the plurality of mounting seats may comprise a first mounting seat 4022 for mounting the circuit board 41, for example a slot into which the board body of the circuit board can be inserted. In some embodiments, the plurality of mounting seats may comprise a second mounting seat 4023 for mounting the emergency interface 32, for example a receiving slot. The receiving slot provides a receiving space that is constrained in at least two dimensions, for example constrained in length and width (e.g., constrained in X and Y directions), so as to position the emergency interface 32 (for example as a female socket of the emergency interface).

To cooperate with positioning/installation of the emergency interface 32, the first housing 401 may be provided with a protruding structure 4019 at a position corresponding to the emergency interface 32. The protruding structure 4019 may be integrally formed with the first housing 401, for example by compression molding. The protruding structure 4019 is not limited to any specific shape, as long as it can limit the movement of the emergency interface 32 in the thickness direction (e.g., the Z direction). For example, after the assembly of the first housing, the protruding structure 4019 at least partially abuts against the surface of the emergency interface 32, thereby securing the emergency interface 32 in position. Since the thickness (the smallest dimension) of the emergency interface 32 is often smaller than the thickness (the smallest dimension) of the energy storage unit 300, and the overall thickness (dimension in the Z-direction) of the accommodating cavity 10a (grip section 120) is designed to be at least according to the thickness of the energy storage unit 300, and is thus greater than the thickness of the emergency interface 32. By providing the protruding structure 4019 in the first housing 401, it can compensate for this thickness difference and facilitate positioning installation of the emergency interface 32.

In some embodiments, anti-slip stripes for the grip section 120 may be provided on outer sides of both the first housing 401 and the third housing 403, for example be integrally formed, such as by compression molding.

This solution using at least three housings provides the following benefits: (1) button(s) can be conveniently installed on a side surface of the housing (a surface parallel to the airflow direction, i.e., the first direction), since button(s) can be installed between the second housing 401 and the third housing 403; (2) the third housing 403 provides an extra protective shell layer, improving overall durability and safety; and (3) it is more convenient to form fine texture structures, such as anti-slip stripes, on the outer sides of the first housing 401 and the third housing 403.

### Blowing Unit

As shown in FIG. 4, in some embodiments, the blowing unit 200 comprises an air-blowing motor 21.

The air-blowing motor 21 may be a brushless motor whose maximum rotational speed can reach at least ten thousand revolutions per minute. The air-blowing motor 21 may also be a brushed motor.

The air-blowing motor 21 may comprise a motor body and an impeller. The motor body drives the impeller to rotate, and the impeller induces airflow.

By providing the air-blowing motor 21, the device has a function of air blowing, snow/dust removal, air blasting, etc.

In some embodiments, the blowing unit 200 further comprises a motor sleeve 23. The motor sleeve is connected (e.g., sleeved) to the air-blowing motor 21. For example, the motor sleeve 23 may be sleeved at a peripheral side of the air-blowing motor 21. The motor sleeve 23 may be sleeved/fitted over an outer periphery of the air-blowing motor 21, or sleeved/fitted into an inner periphery of the air-blowing motor 21.

The motor sleeve 23 and the air-blowing motor 21 may be connected by insertion/bayonet connection. For example, a locking block may be provided on the air-blowing motor 21 (for example on a peripheral side surface), and a slot may be provided on the motor sleeve 23. When the motor sleeve 23 is sleeved at the peripheral side of the air-blowing motor 21, the locking block and the slot are positionally aligned to form insertion/bayonet connection.

The motor sleeve 23 and the housing 40 may also be connected by insertion/bayonet connection. For example, the housing 40 (e.g., in the first accommodating cavity 1001) may be provided with one selected from a bayonet catch 11a and a bayonet slot 11c, while the other may be correspondingly provided on a peripheral side of the motor sleeve 23; the bayonet slot 11c can cooperate with the bayonet catch 11a, so that the motor sleeve 23 is connected to the housing 40. The motor sleeve 23 is used to form an air outlet channel of the air-blowing motor.

The motor sleeve 23 has an air flow channel, and the air flow channel has an air outlet 20a; the air outlet 20a may be arranged corresponding to the second air port 10c, so that the air flow channel can guide the drawn-in air to the second air port 10c.

By the air-blowing motor 21 and the motor sleeve 23, the handheld air-blowing device can realize a function of air-blasting or air-blowing. This allows users to use the handheld air-blowing device to perform tasks such as removing dust/snow from vehicles, inflating tents/sleeping bags, air blasting, etc. in outdoor or transportation scenarios, thereby improving the performance of use.

The design of the motor sleeve 23 not only facilitates installation and fixation of the air-blowing motor 21, but also serves to constrain the airflow channel and separate the airflow channel from the accommodating cavity 10a. This not only improves airflow output efficiency, but also prevents impurities in air from being brought into the accommodating cavity 10a during operation of the air-blowing motor 21. Because the accommodating cavity 10a communicates with electronic components such as the circuit board and battery, the separation function of the motor sleeve 23 can prevent impurities in air from contaminating or damaging these electronic components. Accordingly, the service life of the device can be improved.

By the design of the bayonet slot and the bayonet catch, procedures such as disassembly, assembly, maintenance, and cleaning can be facilitated and simplified. This reduces costs and improves user convenience.

Further, a filter mesh (grille component) 22 may also be provided on/in/at the housing 40 and/or the blowing unit 200.

In some embodiments, the filter mesh (grille component) 22 may be provided on/in/at the housing 40, for example at the first air port 10b and/or the second air port 10c.

In some embodiments, the filter mesh (grille component) 22 may be provided on/in/at the blowing unit 200, for example on/at a side of the air-blowing motor 21 away from the motor sleeve 23 (i.e. air-inlet side), and/or on/at a side of the motor sleeve 23 away from the air-blowing motor 21 (i.e. air-outlet side).

The filter mesh (grille component) 22 functions to block debris from entering the air-blowing motor 21. The mesh structure of the filter mesh (grille component) 22 may be adjusted according to actual conditions and is not limited herein.

The airflow section 11 of the housing 40 may be provided, along the first direction, with a second air port 10c and a first air port 10b opposite to each other, and the first accommodating cavity 1001 may communicate with the second air port 10c and the first air port 10b. The air-blowing motor 21 may be disposed between the second air port 10c and the first air port 10b. Therein, an inlet of the airflow channel of the blowing unit may be located corresponding to the first air port 10b, and an outlet of the airflow channel of the blowing unit may be located corresponding to the second air port 10c.

In some embodiments, the housing 40 and the filter mesh (grille component) 22 may be connected by insertion connection, such as rotary insertion connection (bayonet connection). For example, one selected from a second bayonet catch 11b and a second bayonet slot 11d is provided in the first accommodating cavity 1001 of the housing 40, and the other is correspondingly provided on the filter mesh (grille component) 22; the second bayonet slot 11d cooperates with the second bayonet catch 11b so that the filter mesh (grille component) 22 is connected to the housing 40.

The design of the filter mesh (grille component) 22 can prevent a user from accidentally inserting fingers into, or bringing impurities into, the airflow channel, thereby avoiding injury to the device and the user. This improves stability and safety of the air-blowing device.

In some embodiments, the housing 40 and the blowing unit 200 are connected by insertion/bayonet/snap-fit connection and/or adhesive bonding, so as to install/fix the blowing unit 200.

In some embodiments, the air-blowing motor 21, motor sleeve 23, and filter mesh (grille component) 22 of the blowing unit 200 are each installed (by insertion/bayonet/snap-fit connection) between the first housing 101 and the second housing 102, so that the blowing unit 200 is stably connected to the housing 40 as a whole.

As shown in FIG. 4, in some embodiments, a first protruding portion 1011 is provided on/at a side, close to the accommodating cavity 10a, of the first housing 101 and/or the second housing 102; the first protruding portion 1011 is located between the blowing unit 200 and the first housing 101 and/or the second housing 102, so that the blowing unit 200 is at least partially spaced from the first housing 101 and/or the second housing 102. This improves heat dissipation of the blowing unit 200.

For example, there may be a plurality of first protruding portions 1011, and the plurality of first protruding portions 1011 are arranged at intervals.

For example, as shown in FIG. 4, the shape of a part of the first protruding portion(s) 1011 may match an outer contour of the air-blowing motor 21, so that the air-blowing motor 21 can stably abut against the first protruding portions 1011, thereby achieving a stable connection between the air-blowing motor 21 and the housing 40. For example, when the outer contour of the air-blowing motor 21 is arc-shaped, the first protruding portion 1011 may be an arc-shaped protrusion. The shape of a part of the first protruding portion(s) 1011 may match an outer contour of the motor sleeve 23, so that the motor sleeve 23 can stably abut against the first protruding portions 1011, thereby achieving a stable connection between the motor sleeve 23 and the housing 40. For example, when the outer contour of the motor sleeve 23 is arc-shaped, the first protruding portion 1011 may be an arc-shaped protrusion.

In some embodiments, the blowing unit 200 may comprise an air pump. For example, an air-pump assembly may be provided and connected in an axial direction of the air-blowing motor 21 (for example inside the motor sleeve 23); preferably, the air pump and the air-blowing motor 21 may share the same motor (the one motor). The handheld air-blowing device may further comprise a tire-pressure sensor and an inflation connector. The tire-pressure sensor is arranged on/in/at the inflation connector, and the inflation connector communicates with the air pump. The tire-pressure sensor may be used to detect the tire pressure.

By monitoring the tire pressure through the tire-pressure sensor, a relevant signal can be obtained by the user in time or be automatically obtained by the device, so as to stop inflating when the tire pressure reaches a target range. This not only improves practicability of the air-blowing device but also ensures safety, stability, and accuracy of the inflation process. In addition, the user can use the tire-pressure sensor to check whether tire leakage occurs.

### Energy Storage Unit

The energy storage unit 300 comprises a battery (battery cell) 31, for example a rechargeable battery, optionally may comprise a rechargeable battery and a supercapacitor.

In some embodiments, the device of the present disclosure may have an emergency-start function (jump start function), and in this case the rechargeable battery should comprise the emergency battery cell 31.

The term “emergency battery cell” herein refers to a battery cell capable of performing vehicle emergency starting. In other words, it is a battery capable of instantaneously providing a high current (for example above 100 A, or even higher) to start a vehicle. The “emergency battery cell” may be a ternary lithium battery, a lithium iron phosphate battery, or a sodium battery, etc.

In this embodiment, it is preferable to dispose the energy storage unit 300 in the grip section 120 (in other words, the emergency battery cell 31 is disposed in the second accommodating cavity 1002). This improves space utilization of the housing 40, facilitates gravity balance of the air-blowing device, and enables stable holding for users.

In order to make the shape of the battery cell 31 better match the gripping/holding function of the grip section 120, the battery cell 31 is preferably cylindrical or rectangular. For example, when the emergency battery cell 31 is cylindrical, the ratio of cylinder length to diameter is preferably not less than 2, and more preferably not less than 3. For example, when the battery cell 31 is rectangular, the ratio of rectangular length to width is preferably not less than 2, and more preferably not less than 3. This better matches a grip section 120 of an elongated handle shape.

In some embodiments, the energy storage unit 300 may comprise the emergency battery cell 31 and a power connecting wire 33. The emergency battery cell 31 is disposed in the housing 40 and is electrically connected to the control assembly 10. The power connecting wire 33 is electrically connected to the emergency battery cell 31 or the control assembly 10, and the power connecting wire 33 is connected to the emergency interface 32. The control assembly 10 is used to control connecting or disconnecting the power supply from the emergency battery cell 31 to the power connecting wire 33. It can be understood that using a power connecting wire 33 to connect the emergency interface 32 can provide higher flexibility of the emergency interface 32, so that the position of the emergency interface 32 inside the air-blowing device can be adjusted conveniently according to actual application scenarios.

For example, there may be one or more power connecting wires 33.

For example, as shown in FIGS. 3 and 4, one end of the power connecting wire 33 is electrically connected to the emergency battery cell 31, and the other end thereof is connected to the emergency interface 32. It can be understood that when the energy storage unit 300 is used to perform a vehicle emergency starting, the current that the energy storage unit 300 needs to output is relatively large. The power connecting wire 33 can be directly electrically connected to the emergency battery cell 31, so that the current output from the emergency battery cell 31 to the connecting wire 33 does not have to pass through the circuit board 41. This can protect the circuit board 41 while ensuring stable current output.

Of course, in alternative embodiments, the emergency interface 32 may be directly provided on/at the emergency battery cell 31.

In some embodiments, the emergency interface 32 is connected to the housing 40.

For example, the emergency battery cell 31 may be installed (by insertion connection) between the first housing 101 and the second housing 102.

As shown in FIG. 4, in some embodiments, a second protruding portion 1014 is provided on a side, close to the accommodating cavity 10a, of the first housing 101 and/or the second housing 102; the second protruding portion 1014 is located between the energy storage unit 300 and the first housing 101 and/or the second housing 102, so that the energy storage unit 300 is at least partially spaced from the first housing 101 and/or the second housing 102. This improves heat dissipation of the energy storage unit 300.

In some embodiments, the circuit board 41 is spaced apart from the emergency battery cell 31, so as to prevent the circuit board 41 from scratching the emergency battery cell 31 and affecting normal use of the emergency battery cell 31.

In some embodiments, a placement slot 133 may be provided in the housing 40 for placing the battery cell 31. As shown in FIG. 13, for example, in the second accommodating cavity 1002 of the housing 40, at least one fixing plate 131 and a plurality of fixing members 132 may be provided; the fixing plate 131 and the plurality of fixing members 132 enclose the placement slot 133, and the emergency battery cell 31 is mounted in the placement slot 133.

Therein, one side of the fixing plate 131 may be used for arranging the circuit board 41, and the other side of the fixing plate 131 may be connected to the emergency battery cell 31.

It can be understood that, by using the surfaces of the fixing plate 131 and the fixing members 132 to fix the electrical components, internal electrical components in the handheld air-blowing device can be arranged more compactly and orderly, which not only facilitates installation and disassembly, but also enhances the overall structural compactness of the handheld air-blowing device.

It can be further understood that, by using the fixing plate 131 and fixing members 132 to enclose a placement slot 133 and mounting the emergency battery cell 31 in the placement slot 133, it can reduce damage to the emergency battery cell 31 caused by accidental vibration or collision, and further improve the safety and stability of the handheld air-blowing device.

### Emergency Interface

Via the emergency interface 32, the emergency battery cell 31 provides electrical energy (current) for emergency starting to an external load (device).

The emergency interface 32 is electrically connected to the emergency battery cell 31, and the emergency interface 32 may be used for emergency starting.

The emergency interface 32 is normally arranged on/in/at the housing 40 (positioned on/in/at the housing 40).

For example, the emergency interface 32 may be connected to the housing 40 by adhesive bonding and/or by insertion connection, so that the emergency interface 32 can be stably disposed on the housing 40. This facilitates electrical connection between the emergency interface 32 and a vehicle. For example, as shown in FIGS. 3 and 4, a second insertion member 1013 is provided on a side, close to the accommodating cavity 10a, of the first housing 101; the second insertion member 1013 forms a second slot, and the emergency interface 32 can be inserted in the second slot. For example, the emergency interface 32 may be provided with a flange, and the flange can be inserted in the second slot. Accordingly, connection stability between the emergency interface 32 and the housing 40 is improved.

In some embodiments, the emergency battery cell 31 is connected to the housing 40 by insertion connection and/or by adhesive bonding, so as to position/install the emergency battery cell 31.

Specifically, the emergency interface 32 may be arranged on/in/at the grip section 120 of the housing 40.

Further, the emergency interface 32 may be disposed at an end of the grip section 120 close to the airflow section 110 and/or at an end of the grip section 120 away from the airflow section 110. In this way, accidental touching of the emergency interface 32 when a user holds the grip portion 120 and operates the air-blowing device can be avoided. Besides, it is convenient for a user to electrically connect the emergency interface 32 to a vehicle, while he holds the grip portion 120 to maintain the stability of the air air-blowing device.

In some embodiments shown in FIGS. 3 and 4, the emergency interface 32 is disposed at an end of the grip section 120 away from the airflow section 110.

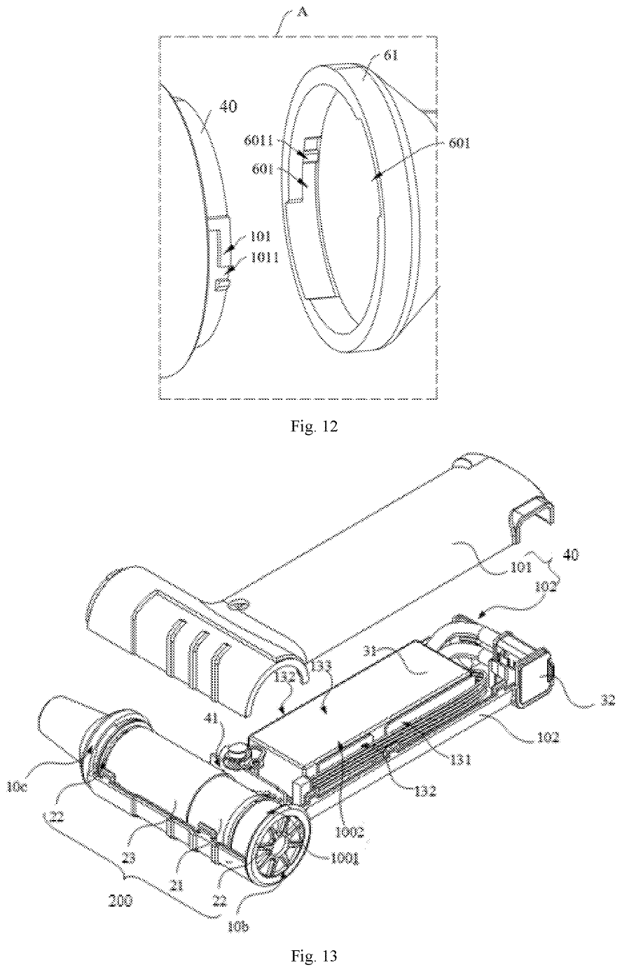

In some embodiments shown in FIGS. 12 and 22, the emergency interface 32 is disposed at an end of the grip section 120 close to the airflow section 110. In this way, all electric components (such as the air-blowing motor 21, emergency interface 32, circuit board 41, etc.) can be arranged on the same side of the emergency battery cell (i.e., the upper side of the emergency battery cell 32), which facilitates circuit routing.

In some embodiments shown in FIGS. 18 and 22, the emergency interface 32 is disposed at an end of the grip section 120 close to the airflow section 110, and located on a side toward the first air port (air inlet) 10b. This is because a switch 43 for controlling the air-blowing device is often arranged on a side toward the second air port (air outlet) 10c. Arranging the emergency interface 32 and switch 43 on two opposite sides can make full use of space, so that the overall structure becomes more compact.

In some embodiments shown in FIGS. 3, 4, 13, 14, 18, and 24, the emergency interface 32 and the emergency battery cell 31 are arranged along an extension direction (the second direction) of the grip section 120. Such an arrangement makes the grip section be a longer handle. This facilitates gripping and also facilitates force application.

In some embodiments shown in FIGS. 3, 4, 13, and 14, the emergency interface 32 and the emergency battery cell 31 are arranged along the extension direction (the second direction) of the grip section 120, and the emergency interface 32 is located below the emergency battery cell 31 (herein “below” means a direction away from the airflow section).

In some embodiments shown in FIGS. 18 and 24, the emergency interface 32 and the emergency battery cell 31 are arranged along the extension direction (the second direction) of the grip section 120, and the emergency interface 32 is located above the emergency battery cell 31 (herein “above” means a direction close to the airflow section).

In some embodiments, a user may use two electrical connecting wires (clamping wires), connect one end of the electrical connecting wire to a cathode or an anode of a to-be-emergency-started device (e.g., of a vehicle battery), and connect the other end thereof to the emergency interface 32, so as to use the emergency battery cell 31 to start the to-be-emergency-started device.

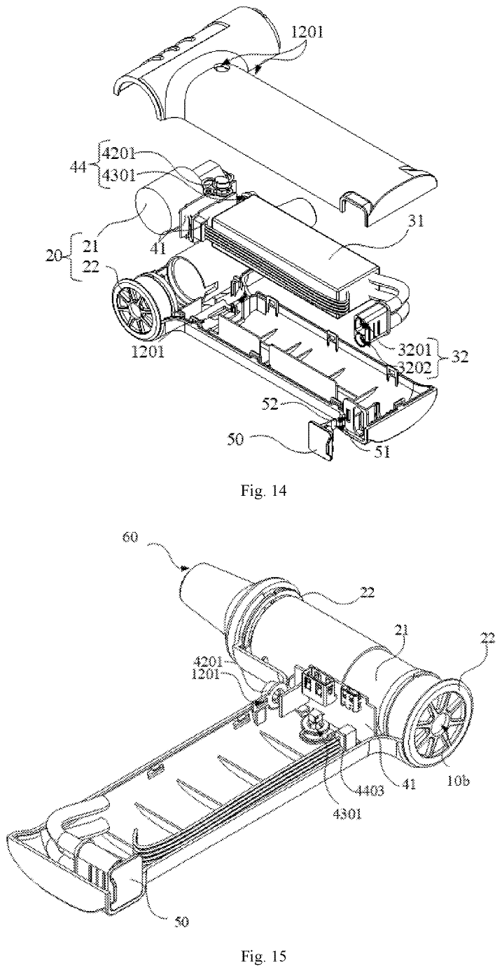

As shown in FIG. 14, in some embodiments, the emergency interface 32 is provided with a first electrical connecting socket 3201 and a second electrical connecting socket 3202. The first electrical connecting socket 3201 and the second electrical connecting socket 3202 are respectively connected to the cathode and anode of the to-be-emergency-started device through their respective corresponding electrical connecting wires, so as to enable the function of emergency starting.

Specifically, the first electrical connecting socket 3201 and the second electrical connecting socket 3202 may have different shapes, so that the first electrical connecting socket 3201 is not able to be connected to the electrical connecting wire corresponding to the second electrical connecting socket 3202, and the second electrical connecting socket 3202 is not able to be connected to the electrical connecting wire corresponding to the first electrical connecting socket 3201.

It can be understood that the foolproof design prevents the first electrical connecting socket 3201 from being connected to the second corresponding wire, and prevents the second electrical connecting socket 3202 from being connected to the first corresponding wire. This effectively prevents users from incorrectly reversing the polarity of the electrical connecting wires, improves the safety of the device when being used as an emergency-starting power supply device, and ensures the safe, normal and stable operation of the emergency starting function.

It can be understood that, in vehicle-use scenarios, especially the scenarios of long-distance freight or passenger transport, when a user uses a corded air-blowing device for dust removal, snow blowing, air blasting, or inflation, there are many restrictions on wiring, wire management, and operating posture, and risks such as wire twisting/tangling may occur, resulting in potential electrical safety hazards.

In some embodiments, as shown in FIG. 14, the first electrical connecting socket 3201 and the second electrical connecting socket 3202 of the emergency interface 32 are arranged along a direction perpendicular to the second direction. In this case, the thickness direction (the direction having the smallest size) of the emergency interface is normally parallel to the second direction.

In some embodiments, as shown in FIGS. 24 and 30, the first electrical connecting socket 3201 and the second electrical connecting socket 3202 of the emergency interface 32 are arranged along the second direction. In this case, the thickness direction (the direction having the smallest size) of the emergency interface is normally perpendicular to the second direction. Such an arrangement reduces the thickness of the grip section and makes the grip section be a longer handle. This facilitates gripping and also facilitates force application.

It can be further understood that, an emergency power device is a commonly available, simple, and accessible power source in vehicle-use scenarios. The handheld air-blowing device uses the emergency battery cell 31 as a power source and ingeniously combines an air-blowing device with an emergency power device. The present disclosure realizes the function of air blowing, and facilitates the use operation through the design of the grip section 120, and achieves a more compact structure through the design of the accommodating cavity 10a. Thereby, the whole product has advantages of practical functions, compact structure, and convenient use.

### Insulating Protector

In some embodiments, the energy storage unit 300 is disposed in the accommodating cavity 10a, and the housing 40 has a power port 10d communicating with the accommodating cavity 10a; the energy storage unit 300 is connected to the power port 10d through the emergency interface 32, so that the emergency interface 32 of the energy storage unit 300 can be electrically connected to a vehicle through the power port 10d.

As shown in FIG. 4, in some embodiments, the air-blowing device further comprises an insulating protector 50, which is movably connected to the housing 40 and is used to cover the power port 10d. When the emergency interface 32 is used for vehicle emergency starting, the insulating protector 50 may be moved relative to the housing 40 to expose the power port 10d, thereby facilitating electrical connection between the vehicle and the emergency interface 32; when emergency starting is not used, the insulating protector 50 may be moved relative to the housing 40 to cover the power port 10d. By using the insulating protector 50 to cover the power port 10d, it can protect the emergency interface 32 and meanwhile prevent accidental contact.

For example, the insulating protector 50 may be made of insulating materials such as rubber or silicone.

It can be understood that the movable connection of the insulating protector 50 to the housing 40 may be slidable connection, rotatable connection, or detachable connection.

For example, as shown in FIG. 4, the housing 40 is provided with a mounting slot 10e, a bottom surface of the mounting slot 10e communicates with the power port 10d, and the insulating protector 50 may be inserted in the mounting slot 10e, so that the insulating protector 50 can cover the power port 10d and can also be removed from the mounting slot 10e to expose the power port 10d.

For example, an operating portion is provided on the insulating protector 50, and the operating portion is at least partially located outside the mounting slot 10e. Thereby, a user can hold the operating portion, so as to remove the insulating protector 50 from the mounting slot 10e to expose the power port 10d.

As shown in FIGS. 3 and 4, in some embodiments, a connecting section 51 is provided on the insulating protector 50, and the bottom surface of the mounting slot 10e further has a connecting opening communicating with the accommodating cavity 10a; one end of the connecting section 51 is connected to the insulating protector 50, and the other end passes through the connecting opening and is located in the accommodating cavity 10a; an outer diameter of the other end of the connecting section 51 is larger than the connecting opening; the connecting section 51 is used for insertion connection with the housing 40, so as to prevent the insulating protector 50 from being lost after having been removed from the mounting slot 10e.

In some embodiments, a protector seat 52 may be provided on/in/at the grip section 120, and a connecting section 51 may be provided on one side of the insulating protector 50.

Specifically, the connecting section 51 may be connected with the protector seat 52 by snap-fit connection/insertion connection, and the insulating protector 50 can cover the emergency interface 32.

It can be understood that providing the insulating protector 50 can prevent external impurities, liquids, etc. from entering the emergency interface 32, thereby avoiding corrosion, short-circuit, or malfunction of the circuit board 41 and emergency battery cell 31 caused by the influence of liquids or impurities. This improves safety and stability of the air-blowing device, and prevents problems such as electric shock caused by accidental touching of the emergency interface 32.

### Control Assembly

In some embodiments, the air-blowing device further comprises a control assembly 10 (control circuit 10), and the control assembly 10 is electrically connected to the blowing unit 200 and the energy storage unit 300. The control assembly 10 can control start/stop of the blowing unit 200, so that the state of the blowing unit 200 is controllable. In some embodiments, the control assembly 10 may also be used to control connecting or disconnecting the power supply from the energy storage unit 300 to an external load (device).

For example, the control assembly 10 may be disposed in the accommodating cavity 10a, so that the housing 40 can protect the control assembly 10.

In some embodiments, the control assembly 10 comprises a circuit board 41, a first switch 42, and/or a second switch 43. The circuit board 41 is disposed in the housing 40, and the circuit board 41 is electrically connected to the blowing unit 200 and the energy storage unit 300.

In some embodiments, the first switch 42 is electrically connected to the circuit board 41 and is used to control connecting or disconnecting the power supply from the energy storage unit 300 (functions similarly to a main power switch). The second switch 43 is electrically connected to the circuit board 41, and is used to control the blowing unit 200 to start/stop and/or control the rotational speed of the blowing unit 200, when the energy storage unit 300 is supplying power. In this way, the first switch 42 and the second switch 43 can be used to control the state of the energy storage unit 300 and the state of the blowing unit 200 respectively. When an air-blowing function is needed, both the first switch 42 and the second switch 43 can be controlled to be turned on; when an emergency-start function is needed, the first switch 42 can be controlled to be turned on and the second switch 43 to be turned off. Preferably, in addition to controlling start/stop of the blowing unit 200, the second switch 43 is further configured to adjust an air output level when the blowing unit 200 is started. In other words, a user can use only one switch module to control start/stop as well as to control the rotational speed (airflow speed/air output level). For example, when the second switch 43 is a push button, a first press switches the air-blowing device from no blowing to first-level blowing, a second press switches from first-level blowing to second-level blowing, and a third press switches from second-level blowing back to no blowing.

In some embodiments, the first switch 42 may be omitted (or its function may be merged with that of the second switch 43). For example, with a single push button, a long press is configured to power on/off and a short press is configured to switch between speed levels.

In some embodiments, the first switch 42 (which functions similarly to a main power switch) may be omitted. In this case, the energy storage unit 300 supplies power by default, and the blowing unit is controlled by only using the second switch 43.

In alternative embodiments, the first switch 42 is used to start/stop the blowing unit 200, and the second switch 43 is used to select an air output level. For example, switching may be performed between two levels (high/low), or among three levels (high/medium/low), or more levels.

In alternative embodiments, a combination of the first switch 42 and second switch 43 may be used to select an air output level. For example, a short press of the first switch 42 is configured to start/stop the blowing unit 200, and when the second switch 43 is set to a third-level speed (at high-speed level), a long press of the first switch 42 is configured to activate a fourth-level speed (a storm mode) which is higher than the third-level speed.

In alternative embodiments, different airflow levels are marked on/at/by the second switch 43 as different modes (different blowing scenarios). For example, high/medium/low levels may respectively correspond to a snow-blowing mode, a leaf-blowing mode, and a dust-blowing mode.

For example, the first switch 42 includes, but is not limited to, a touch switch, push switch, knob, toggle switch, etc. The second switch 43 includes, but is not limited to, a touch switch, push switch, knob, toggle switch, etc.

For example, as shown in FIG. 4, the first switch 42 comprises a switch body 421 and a button 422. The switch body 421 may be disposed in the accommodating cavity 10a. The housing 40 further has a first mounting hole communicating with the accommodating cavity 10a. The button 422 is connected to a wall surface of the accommodating cavity 10a and arranged corresponding to the switch body 421; a part of the button 422 passes through the first mounting hole and is located outside the housing 40 so that a user can press the button 422 down. When the button 422 is pressed, the button 422 can deform and move closer to the switch body 421. After being triggered, the switch body 421 sends a signal to the circuit board 41, and the circuit board 41 performs/executes a corresponding operation after receiving the signal. The arrangement of the second switch 43 may refer to that of the first switch 42, and may be the same or different, which will not be repeated here.

For example, the switch body 421 may be fastened to the circuit board 41 by a fastener, or fixed to the circuit board 41 by welding; a specific implementation may be adjusted according to actual conditions and is not limited herein.

For example, the first switch 42 and/or the second switch 43 may be arranged at an end of the grip section 120 close to the airflow section 110. This can facilitates the user to operate the first switch 42 and/or the second switch 43 while holding the grip section 120.

For example, the first switch 42 and the second switch 43 may be arranged on different sides of the grip section 120. This helps users distinguish between the first switch 42 and the second switch 43, and prevents unintended triggering.

For example, as shown in FIG. 3, the second switch 43 may be located on a side where the second air port 10c is located, and the first switch 42 is located on an adjacent side.

For example, as shown in FIG. 18, the first switch 42 is a push button located on a side of the grip section 120 close to the second air port 10c. The pressing direction may be parallel to the airflow direction (the first direction), or perpendicular to the second direction. For example, the second switch 43 is a toggle switch corresponding to two or more (airflow) levels. The toggling direction may be parallel to the airflow direction (the first direction), or perpendicular to the second direction. The first switch 42 and the second switch 43 are arranged on different side surfaces of the grip section 120, such as adjacent surfaces or opposite surfaces.

For example, there may be one or more (two or more, three or more) circuit boards 41. When there are multiple circuit boards 41, they may be electrically connected with each other, or each may be independently connected to battery cell(s).

As shown in FIGS. 3 and 4, in some embodiments, the circuit board(s) 41 may be arranged in the accommodating cavity 10a, and electrically connected to the blowing unit 200 and the battery cell 31.

In some embodiments, the circuit board 41 is installed between the blowing unit 200 and the battery cell 31. Arranged from an upper side to a lower side: the blowing unit 200, the circuit board 41, the battery cell 31.

In some embodiments, as shown in FIGS. 18 and 24, arranged from an upper side to a lower side are blowing unit 200, circuit board 41, emergency interface 32, emergency battery cell 31. In alternative embodiments, arranged from an upper side to a lower side may be (i) blowing unit 200, circuit board 41, emergency interface 32, emergency battery cell 31, circuit board 41; or (ii) blowing unit 200, circuit board 41, emergency interface 32, emergency battery cell 31 and circuit board 41 which are arranged in parallel; or (iii) blowing unit 200, circuit board 41, emergency battery cell 31, emergency interface 32.

The circuit board 41 may be located in the airflow section 110 and/or in the grip section 120. In other words, the circuit board 41 may be located in the airflow section 110 or in the grip section 120, or in a housing region at a connection between the grip section 120 and the airflow section 110, or partly in the airflow section 110 and partly in the grip section 120.

The circuit board 41 may comprise a plurality of sub-circuit boards 41. At least one sub-circuit board 41 may be located in the airflow section 110, or in the grip section 120, or in the connection region between the grip section 120 and the airflow section 110.

It can be understood that the circuit board 41 may be divided into a first circuit board and a second circuit board, according to actual functions/needs. Firstly, this reduces overall volume of the circuit board 41 and facilitates the installation of the circuit board 41 and other electrical components. Secondly, this enables a design that the grip portion 120 is foldable, avoiding damage to the circuit board 41 caused by folding, or avoiding increase of costs caused by further miniaturization of the circuit board 41.

It can be further understood that at least one of the first circuit board and the second circuit board may be located in the first accommodating cavity 1001, or the second accommodating cavity 1002, or a connection region between the first accommodating cavity 1001 and the second accommodating cavity 1002.

In some embodiments shown in FIGS. 3, 4, 13, 14, 18, and 24, the circuit board 41 is at least partially located in the grip section 120, and the circuit board 41 and the battery cell 31 are arranged along an extension direction of the grip section 120 (the second direction). For example, the circuit board 41 may be entirely above the emergency battery cell 31 (herein “above” means it is closer to the airflow section than the emergency battery cell 31). Such arrangement makes the grip section be a longer handle. This facilitates gripping and also facilitates force application.

Preferably, the circuit board 41 comprises two or more sub-circuit boards 41, and all sub-circuit boards 41 are located in the grip section 120.

Preferably, the two or more sub-circuit boards 41 are arranged in parallel (along the extension direction of the grip section) and spaced apart from each other.

Preferably, a board area of the circuit board 41 (for example, a board area of each sub-circuit board 41) is smaller than a cross-sectional area of the grip section of the housing (a cross-sectional area in a direction perpendicular to the second direction).

Preferably, a plane in which the circuit board 41 (for example each sub-circuit board 41) is located is perpendicular to the second direction (the extension direction of the grip section).

Thereby, functions of the circuit board 41 can be distributed into two or more sub-circuit boards 41. This brings at least the following advantages: (1) it avoids an excessively large area of a single board, which would otherwise increase the width of the grip section; (2) the multiple sub-circuit boards are spaced apart (arranged at intervals), which helps to form sufficient heat-dissipation space; and (3) this design can increase a length-to-diameter ratio of the grip section, so that the handle portion becomes longer, which facilitates gripping and also facilitates force application.

In some embodiments, as shown in FIG. 26, the circuit board 41 comprises a first sub-circuit board 411 and a second sub-circuit board 412. The first sub-circuit board 411 and the second sub-circuit board 412 may be connected (e.g. electrically connected) through a connecting column (connecting plate) 413, such as through pin header(s). The connecting column (connecting plate) 413 is preferably of certain supporting rigidity, thereby connecting the first sub-circuit board 411 and the second sub-circuit board 412 into a stable frame structure (for example, to maintain that the first sub-circuit board 411 and the second sub-circuit board 412 are parallel to each other and are spaced apart from each other). There may be one connecting column (connecting plate) 413 or multiple (e.g. two or more, three or more) connecting columns (connecting plates) 413. The connecting column(s) (connecting plate(s)) 413 may be arranged on one side of the circuit board 41 or on opposite two sides of the circuit board 41. In some other embodiments, the first sub-circuit board 411 and the second sub-circuit board 412 may be connected by wires.

As shown in FIG. 26, the first sub-circuit board 411 is located above the second sub-circuit board 412, and is closer to the airflow section 110 of the housing.

Various electrical-control functions and electrical connections are distributed across the plurality of sub-circuit boards 411 and 412. For example, the first sub-circuit board 411 is connected to charging/discharging port(s) 70. The charging/discharging port(s) 70 may comprise at least two sockets of different specifications, such as a USB socket 71 and a Type-C socket 72. The charging/discharging port(s) 70 enables charging of the energy storage unit 300, and/or enables the energy storage unit 300 to supply power to charge a terminal device such as a mobile phone. For example, the second sub-circuit board 412 is connected to the first switch 42 (e.g., a pushbutton switch), the second switch 43 (e.g., a toggle switch), etc. In some embodiments, a control module for the air-blowing motor 21 is provided on the second sub-circuit board 412 and is configured to send a control signal (e.g., a PWM signal) to the air-blowing motor 21, so as to control start/stop of the air-blowing motor 21 and to control the rotational speed of the air-blowing motor 21. In some embodiments, a control module is provided on the second sub-circuit board 412 and is connected to the emergency interface 32, so as to control to connect/disconnect the power supply to the emergency interface 32.

In some preferred embodiments, the circuit board 41 (two or more sub-circuit boards), the emergency interface 32, and the emergency battery cell 31 are all located in the grip section 120. Along the extension direction of the grip section (i.e., the second direction) from an upper side to the lower side (i.e. toward a direction away from the airflow section) are: circuit board 41 (two or more sub-circuit boards), emergency interface 32, emergency battery cell 31. Such arrangement facilitates wiring and also makes the grip section be a longer handle and be convenient for holding.

It can be understood that the circuit board 41 can be fixedly mounted on/in the housing 40, and the method of fixing the circuit board 41 can be relatively flexible and may be adjusted according to actual conditions. For example, the circuit board 41 may be connected to the housing 40 by insertion connection, and/or the circuit board 41 may be fastened to the housing 40 by a fastener, and/or the circuit board 41 may be connected to the housing 40 by adhesive bonding.

For example, as shown in FIGS. 3 and 4, a first insertion member 1012 is provided on a side, close to the accommodating cavity 10a, of the housing 40 (e.g., the first housing 101). The first insertion member 1012 forms a first insertion slot, and the circuit board 41 may be inserted in the first insertion slot, thereby improving the connection stability between the circuit board 41 and the housing 40. Preferably, the first insertion member 1012 is located in the grip section 120 of the housing 40, for example at an end of the grip section 120 close to the airflow section 110.

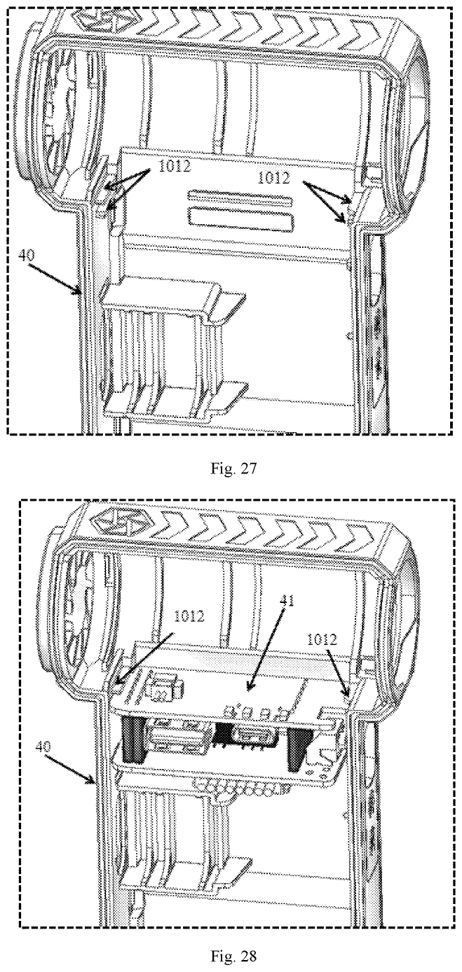

As shown in FIGS. 3, 4, 27, and 28, there may be at least two first insertion members 1012. The two first insertion members 1012 are respectively used for inserting two opposite sides of the circuit board 41, for example two opposite sides of the first sub-circuit board 411. By providing two opposite slots 1012 on an inner side of the housing, the circuit board 41 can be inserted into the slots 1012. This facilitates installation of the circuit board 41. Besides, the circuit board 41 is thereby fixed in the housing 40 and forms a rigid connection therewith. Thereby, it can avoid a displacement of circuit board that may occur during use and vehicle bumping, and thus protect the electrical components.

As shown in FIG. 28, two first insertion members 1012 located on two opposite sides of the circuit board 41 may be arranged asymmetrically, for example they are insertion members of different sizes. This is because the functional modules on (or near) the circuit board 41 are normally not symmetric. For example, when a first switch 42 is arranged on one side of the housing, the insertion member 1012 on that side may be smaller than that on the other side. Besides, asymmetric insertion members often make the alignment during the insertion of the circuit board 41 easier. At first one side of the circuit board 41 is aligned and inserted, and then the other side of the circuit board 41 is aligned and inserted.

Possible specific functions and components in the control circuit 10 are further described below.

As shown in FIG. 31, according to a first aspect of the control circuit according to the embodiments of the present disclosure, the present disclosure provides a control circuit, which is used for an air-blowing device. The control circuit comprises an emergency battery cell 11, a driving module (driving circuit) 12, and a first control module (first control circuit) 13.

On one side, one terminal of the emergency battery cell 11 may be connected to the emergency interface 20 of the air-blowing device 100, and the emergency interface 20 is used for emergency starting.

On the other side, the other terminal of the emergency battery cell 11 may be connected, through the driving module 12, to the air-blowing motor 30 of the air-blowing device 100. The first control module 13 is connected to the driving module 12, so as to control the driving module 12 to drive the air-blowing motor 30 to output airflow.

Specifically, the control circuit 10 provided by the present disclosure is intended to solve problems caused by that an emergency starting power supply device and an air-blowing device exist independently in the current market, the problems including increased economic burden on vehicle owners, inconvenience in carrying, and waste of in-vehicle space, etc. The provided control circuit 10 integrates functions of an emergency starting power supply device and an air-blowing device, so that a vehicle owner only needs to purchase one device to realize two functions.

Specifically, the provided control circuit 10 aims to combine the emergency starting power supply and the air-blowing device into one, so as to facilitate convenient use for the vehicle owner, and to reduce economic cost and to reduce occupation of in-vehicle space.

In the control circuit 10, the emergency battery cell 11 is an energy source of the device and can provide high current required during emergency starting and low current required during normal operation of the air-blowing motor 30. According to actual requirements, the control circuit 10 is configured to provide the air-blowing motor 30 with suitable/appropriate current and voltage.

The driving module 12 is configured to drive the air-blowing motor 30 as well as adjust the motor's speed and power according to an instruction from the first control module 13. By using a high-efficiency driving module 12, the control circuit 10 can reduce energy loss.

In some embodiments, the driving module 12 supports PWM (pulse-width modulation) and/or other control strategies according to actual needs, and is configured to adjust the motor speed precisely. For example, the first control module 13 sends a PWM signal, the driving module 12 receives the PWM signal, and adjusts the rotational speed of the air-blowing motor 30 under control of the PWM signal. PWM (pulse-width modulation) is a technique that simulates analog voltage values by rapidly switching digital signals. It does not change voltage magnitude itself, but controls average power by changing a time ratio between “on” and “off.” The first control module 13 may be configured to control an on/off state of a switch module (switch circuit) 14, and may be configured to adjust an operating state of the air-blowing motor 30 by controlling the driving module 12.

For example, a first switch module (first switch circuit) capable of controlling the overall circuit (overall output of the emergency battery cell) may be provided in the control circuit 10, and/or a second switch module (second switch circuit) for only controlling the output of the driving module 12 may be provided in the driving module. The first control module 13 may be configured to control the first switch module and/or the second switch module to be on or off.

The first control module 13 may comprise a microcontroller (MCU) for performing complex logic operations and signal processing. By controlling the switch module and/or the motor driving module 12, the first control module 13 can provide a protection for the emergency battery cell 11, the protection being at least one selected from overload protection, short-circuit protection, overheat protection, or undervoltage protection, so as to ensure safe use of the air-blowing device. The first control module 13 may comprise a logic circuit, or a control circuit composed of pure hardware components and capable of processing logic operations and signals.

Besides, the provided control circuit 10 may further comprise a user interface, such as an LCD display or LED indicator, to clearly provide mode selection and/or status display, so that a user can switch modes via button(s) or a touch screen. The user interface can also be used to monitor parameters such as battery voltage, current, temperature, etc. in real time, thereby ensuring safe operation of the device.

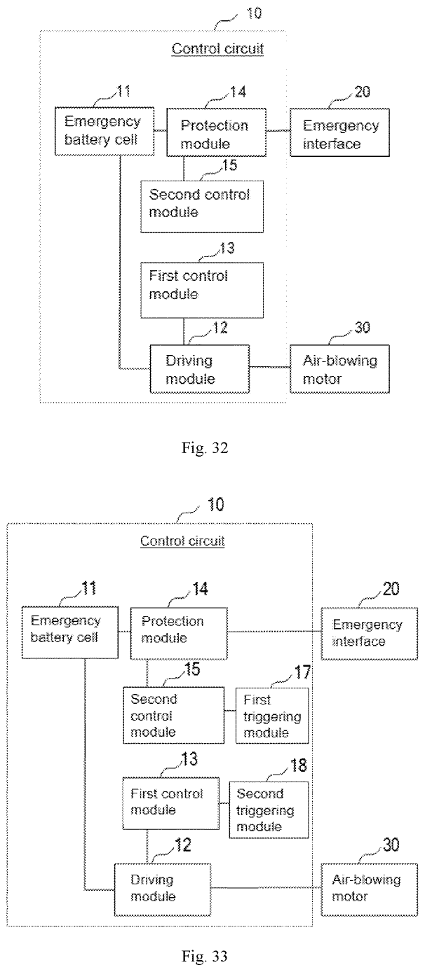

In some embodiments, as shown in FIG. 32, the control circuit 10 further comprises: a protection module 14 for connecting the emergency battery cell 11 and the emergency interface 20; and a second control module (second control circuit) 15, wherein the second control module 15 is connected to the protection module 14. The second control module 15 is used to control an on/off state of the protection module 14, thereby controlling an on/off state of power supply from the emergency battery cell 11 to external equipment through the emergency interface 20.

The protection module 14 is used to ensure that current from the emergency battery cell 11 can be input to the emergency interface 20 during emergency starting. The emergency interface 20 is used to emergency-start a vehicle, for example when vehicle battery power is insufficient. The protection module 14 may use a relay or a field-effect transistor (MOSFET) as a switching element, and its on/off state can be controlled by a signal from the second control module 15.

In some embodiments, the first control module 13 and the second control module 15 may also be merged together. Thus, an integrated control module is formed. The integrated control module can both control the on/off of the protection module 14 and control an operating state of the driving module 12 (for example, adjust an operating state of the air-blowing motor 30).

In some embodiments, as shown in FIG. 33, the control circuit 10 may further comprise a first triggering module 17, configured to receive a user trigger operation and to generate a first trigger signal; and the first triggering module 17 is connected to the second control module 15. Based on a received first trigger signal, the second control module 15 is configured to control the on/off of the protection module 14.

A user can manually control the on/off of the protection module 14 through the first triggering module 17. This increases the operability of the air-blowing device 100. In scenarios requiring immediately cutting off the connection to the emergency interface 20 or requiring emergency starting, a user can perform rapid operation through a button without going through complicated steps, thereby quickly cutting off the power supply to the emergency interface 20. The first triggering module 17 provides an intuitive physical button that users can operate easily. Using a physical button can reduce the probability of misoperation and improve the reliability of device.

Besides, a user can use the first triggering module 17 to perform cyclic operations. For example, if a trigger signal of the first triggering module 17 which is previously received by the first control module 13 is to turn on the protection module 14, a next trigger signal is to turn off the protection module 14, and so on in a cyclic manner. The introduction of the first trigger module 17 provides users with the function of manually controlling the on/off of the protection module 14, which increases device operability and safety.

In some embodiments, as shown in FIG. 33, the control circuit 10 may further comprise a second triggering module 18 connected to the first control module 13. The second triggering module 18 is configured to generate a second trigger signal when triggered. Based on a received second trigger signal, the first control module 13 starts or stops the driving module 12, so as to drive or stop the airflow output of the air-blowing motor 30.

A user can manually control start/stop of the air-blowing motor 30 through the second triggering module 18, which increases the operability of the device. When rapid start/stop of the airflow function is needed, a user can quickly operate through the second triggering module 18 without going through complicated steps. After a user presses the second triggering module 18, the first control module 13 can respond quickly and immediately, so as to drive (start) or stop the air-blowing motor 30. This improves operating efficiency. Manual start/stop control can save user time, especially when rapid stopping of the air-blowing motor 30 is required in emergency situations.

In some embodiments, the second triggering module 18 can also be used to implement some other functions, such as adjusting the level, changing the direction etc. of the air-blowing motor 30.

The introduction of the second trigger module 18 provides users with the function of manually controlling the on/off of the air-blowing motor 30, which increases device operability and safety. The two designs improve reliability and safety of the device while enabling rapid manual response to abnormal conditions. Users can quickly respond to abnormal device conditions via physical buttons, so as to ensure that the device operates in a safe state.

It should be noted that the first triggering module 17 as well as the second triggering module 18 may be button(s), toggle switch(es), knob switch(es), touch screen(s), voice receiving module(s), etc.; a user trigger operation includes pressing, touching, voice input, etc. Types of the first triggering module 17 and second triggering module 18 are not limited in embodiments of this application.

With reference to the above embodiments, detailed use methods corresponding to the control circuit 10 may be as follows:
1) Emergency starting: the vehicle owner connects positive and negative terminals of the device emergency interface 20 to positive and negative terminals of the vehicle battery, respectively. When (a user) triggering, for example, a button corresponding to the protection module 14, the control circuit 10 enters a preset emergency-start mode. The second control module 15 detects a trigger signal corresponding to emergency-start mode (e.g., by receiving a first trigger signal), sends a signal to the protection module 14, and allows high current from the emergency battery cell 11 to flow to the vehicle battery through the emergency-start interface, so as to enable a starting of vehicle. After the vehicle is successfully started, the owner may disconnect the emergency interface 20 and may optionally disconnect the connection between the emergency interface 20 and the protection module 14 (e.g., by using the first triggering module 17 to send the first trigger signal again).
2) Blowing air: the vehicle owner points a blowing nozzle of the device at a position where dust needs to be cleaned. When (a user) triggering, for example, a button corresponding to the protection module 14, the control circuit 10 enters a preset blowing mode. The first control module 13 detects a trigger signal corresponding to blowing mode (e.g., receiving a second trigger signal), sends a signal to the driving module 12, so that the emergency battery cell 11 generates low current via the driving module 12, and the low current flows from the driving module 12 to the air-blowing motor 30. The air-blowing motor 30 starts operating and blows strong airflow to clean away dust.

In some embodiments, the vehicle owner (user) can adjust airflow speed via the first control module 13. For example, different trigger signals may be generated via the second triggering module 18 (e.g., a toggle switch or a knob switch). For example, the first control module 13 can control the driving module 12 via a PWM signal, thereby adjusting motor speed, and achieving multi-level airflow control. After the dust removal is completed, the vehicle owner turns off the air-blowing motor 30, disconnects the nozzle, and may optionally use control circuit 10 to disconnect the driving module 12 from the air-blowing motor 30. For example, a shutdown signal is generated through the second triggering module 18; after receiving the shutdown signal, the first control module 13 instructs the driving module 12 to disconnect power to the air-blowing motor 30, thereby stopping the operation of the air-blowing motor 30.

Accordingly, the control circuit 10 integrates an emergency starting power supply and an air-blowing device, and provides an efficient, cost-effective, and safe solution. Its design not only satisfies the demands of vehicle owners in various scenarios, but also ensures a long-term stable operation of the applied air-blowing device 100 by virtue of multiple protection mechanisms and intelligent monitoring functions. The integrated air-blowing device 100 is practical in daily driving and can significantly improve the user experience of vehicle owners.

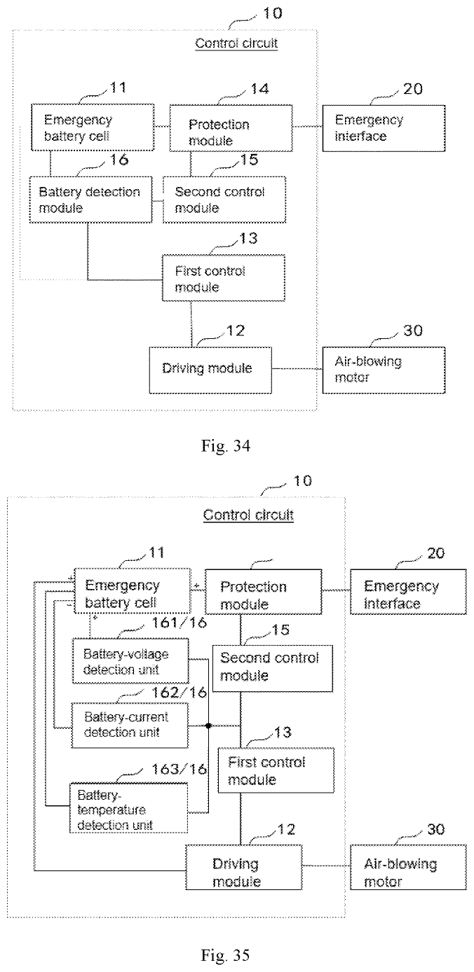

In some embodiments, as shown in FIG. 34, the control circuit 10 further comprises a battery detection module 16. The battery detection module 16 is connected to the emergency battery cell 11 and to the first control module 13.

On one side, the battery detection module 16 is electrically connected to the emergency battery cell 11, so as to be able to detect battery status of the emergency battery cell 11. On the other side, the battery detection module 16 is in electrical connection and/or in signal communication with the first control module 13, so as to be able to send a first detection signal to the first control module 13.

The battery detection module 16 generates a first detection signal regarding a state (status) of the emergency battery cell 11. If the first detection signal indicates abnormality of the emergency battery cell 11, the first control module 13 controls the driving module 12 to disconnect the circuit (to stop power supply), thereby stopping airflow output of the air-blowing motor 30.

The battery detection module 16 can monitor key parameters of the emergency battery cell 11 in real time and generate the first detection signal. Types of the monitored/detected parameters may be set according to actual requirements, such as voltage, current, temperature, etc., which are not limited in the embodiments of this application. Based on the detected battery parameter(s), a first detection signal may be generated. The first detection signal may comprise an abnormal state of the battery, such as undervoltage, overcurrent, overtemperature, etc. The battery detection module 16 is connected to the first control module 13, so as to ensure that the detection signal can be transmitted to the first control module 13 in real time.

The first control module 13 receives and processes the first detection signal generated by the battery detection module 16. If the first detection signal indicates abnormality of the emergency battery cell 11, the first control module 13 can control the driving module 12 to stop the operation of the air-blowing motor 30, which ensures that the air-blowing motor 30 does not continue running when the battery is abnormal, thereby avoids further damage.

For example, as shown in FIG. 34, the battery detection module 16 may be connected to the second control module 15.

The battery detection module 16 may send the first detection signal to the second control module 15. The second control module 15 is configured to control the on/off of the protection module 14 according to the first detection signal.

If the first detection signal indicates that the emergency battery cell 11 is abnormal, the second control module 15 controls the protection module to turn off (disconnect).

If the first detection signal indicates abnormality of the emergency battery cell 11, the second control module 15 immediately controls the protection module 14 to turn off (disconnect), so as to disconnect the emergency battery cell 11 from the emergency-start interface, so as to prevent further current flow.

Accordingly, by adding the battery detection module (battery detection circuit) 16, safety and reliability of the control circuit 10 are improved. It can monitor multiple state parameters of the emergency battery cell 11 in real time and rapidly take protective measures when abnormality is detected, thereby avoiding device damage and potential safety risks. This design not only prolongs service life of the device, but also improves operational convenience. In particular, it can better protect the safety of vehicle owners and vehicles in emergency situations.

For example, the first detection signal may comprise at least one or more selected from a battery-voltage detection signal, a battery-current detection signal, and a battery-temperature detection signal. As shown in FIG. 35, the battery detection module (battery detection circuit) 16 may comprise: a battery-voltage detection circuit 161, and/or a battery-current detection circuit 162, and/or a battery-temperature detection circuit 163.

The battery-voltage detection unit 161 is connected to the emergency battery cell 11 and to the first control module 13, and generates a battery-voltage detection signal. Based on the received battery-voltage detection signal, the first control module 13 can control the driving module 12.

For example, when the battery-voltage detection signal indicates overvoltage of the emergency battery cell 11 (voltage is too high, exceeding a first voltage threshold), the first control module 13 controls the driving module 12 to stop the air-blowing motor 30 (from blowing air).

The battery-current detection unit 162 is connected to the emergency battery cell 11 and to the first control module 13, and generates a battery-current detection signal. Based on the received battery-current detection signal, the first control module 13 can control the driving module 12.

For example, when the battery-current detection signal indicates overcurrent of the emergency battery cell 11 (current is too high, exceeding a current threshold), the first control module 13 controls the driving module 12 to stop the air-blowing motor 30 (from blowing air).

The battery-temperature detection unit 163 is connected to the emergency battery cell 11 and to the first control module 13, and generates a battery-temperature detection signal. For example, when the battery-temperature detection signal indicates overheating of the emergency battery cell 11 (temperature is too high, exceeding a temperature threshold), the first control module 13 controls the driving module 12 to stop the air-blowing motor 30 (from blowing air).

The temperature detection unit 163 may comprise a thermistor or a temperature sensor, etc.

The battery-voltage detection unit 161 is used to monitor a voltage of the emergency battery cell 11 in real time. It generates a battery-voltage detection signal that indicates whether the voltage of the emergency battery cell 11 is within a safe range. It may comprise a voltage sensor for detecting a voltage of the emergency battery cell 11.

When the battery-voltage detection unit 161 detects that voltage of the emergency battery cell 11 exceeds a preset safety upper limit (overvoltage, higher than a first voltage threshold, e.g., 14.5V), the first control module 13 receives an overvoltage signal sent by the battery-voltage detection unit 161, determines that the emergency battery cell 11 is in an overvoltage state, and immediately shuts down (turns off) the driving module 12, so as to disconnection the emergency battery cell 11 from the emergency-start interface and the air-blowing motor 30. The first control module 13 may further prompt the vehicle owner that the battery voltage is too high, so that the emergency battery cell 11 needs to be checked.

When the battery-voltage detection unit 161 detects that voltage of the emergency battery cell 11 is lower than a preset safety lower limit (undervoltage, lower than a second voltage threshold, e.g., 10.5V), the first control module 13 receives an undervoltage signal sent by the battery-voltage detection unit 161 and immediately cuts off the connection between the emergency battery cell 11 and the air-blowing motor 30. The first control module 13 may further issue a warning, to notify the vehicle owner that voltage of the emergency battery cell 11 is too low, so that charging or battery replacement is needed.

The battery-current detection unit 162 is used to monitor a current of the emergency battery cell 11 in real time. It generates a battery-current detection signal that indicates whether the current of the emergency battery cell 11 is within a safe range. It may comprise a current sensor for detecting a current of the emergency battery cell 11.

When the battery-current detection unit 162 detects that current of the emergency battery cell 11 exceeds a preset safety upper limit (overcurrent, exceeding a current threshold, e.g., 100 A), the first control module 13 receives an overcurrent signal sent by the battery-current detection unit 162 and immediately shuts down (turns off) the driving module 12, so as to disconnect the emergency battery cell 11 from the air-blowing motor 30. The first control module 13 may further prompt the vehicle owner that battery current is too high, so that it is necessary to check whether the connection of the emergency battery cell 11 or of the emergency interface 20 to air-blowing motor 30 is normal.

The battery-temperature detection unit 163 is used to monitor a temperature of the emergency battery cell 11 in real time. It generates a battery-temperature detection signal that indicates whether the temperature of the emergency battery cell 11 is within a safe range. It may comprise a temperature sensor for detecting a temperature of the emergency battery cell 11.

When the battery-temperature detection unit 163 detects that temperature of the emergency battery cell 11 exceeds a preset safety upper limit (overtemperature, exceeding a temperature threshold, e.g., 60 °C). The first control module 13 receives an overheat signal sent by the battery-temperature detection unit 163 and immediately shuts down (turns off) the driving module 12, so as to disconnect the emergency battery cell 11 from the air-blowing motor 30. The first control module 13 may further prompt the vehicle owner that battery temperature is too high, so that the device needs to be cooled down before further use.

Besides, as shown in FIG. 35, the battery-voltage detection unit 161 (and/or the battery-current detection unit 162, and/or the battery-temperature detection unit 163) may be also connected to the second control module 15. Accordingly, the battery-voltage detection signal (and/or battery-current detection signal, and/or battery-temperature detection signal) can also be sent to the second control module 15. The second control module 15 is configured to control the on/off of the protection module 14 according to the detection signal.

Analogously, when the second control module 15 receives a signal of overvoltage, undervoltage, overcurrent, or overheat, the second control module 15 controls the protection module 14 to turn off (disconnect).

Accordingly, by virtue of the functions and effects of the battery-voltage detection unit 161, battery-current detection unit 162, and battery-temperature detection unit 163, the present disclosure improves the safety and reliability of the control circuit 10 and prolongs the service life of the corresponding air-blowing device. This design not only provide more convenient use experience to vehicle owners, but also reduces the risk of device damage caused by battery abnormalities, thereby saving maintenance costs and extending the service cycle of the device.

In some embodiments, the battery-voltage detection unit 161 is connected to a positive terminal of the emergency battery cell 11; and/or the battery-current detection unit 162 is connected to a negative terminal of the emergency battery cell 11.

By connecting the battery-voltage detection unit 161 to the positive terminal of the emergency battery cell 11, battery voltage can be monitored more accurately, because the detection result will not be affected by the voltage drop caused by the line resistance. By connecting battery-current detection to the negative terminal of the emergency battery cell 11, battery discharge (output) current can be measured more accurately, because the negative terminal is usually closer to the battery interior so that the influence of line resistance is reduced.

In some embodiments, the air-blowing device may further comprise a charging circuit (not shown in figures). The emergency battery cell 11 is connected to the charging circuit, and the charging circuit is used to charge the emergency battery cell 11. The control circuit 10 is configured to control the connection or disconnection between the charging circuit and the emergency battery cell 11. For example, the first control module 13 may be used to stop the charging of the emergency battery cell 11.

The charging circuit may comprise a voltage regulation circuit, configured to regulate a voltage input from a charging/discharging port, so as to satisfy the requirements of charging the emergency battery cell. Preferably, the voltage regulation circuit comprises a boost circuit and/or a buck circuit. For example, the voltage regulation circuit may comprise a voltage-regulation chip and/or a switching transistor.

The charging circuit may comprise a protocol identification circuit, which is configured to identify a charging signal input from the charging/discharging port, and is configured to charge the emergency battery cell according to a preset charging mode in response to a successful identification.

In some embodiments, if the battery-voltage detection signal indicates battery overvoltage, the first control module 13 stops the charging of the emergency battery cell 11.

When battery voltage exceeds a preset safety upper limit (overvoltage, higher than the first voltage threshold, e.g., 14.5V), the first control module 13 immediately stops the charging. This prevents overcharge, and avoids reduction of battery life or damage to the battery. Overcharge may cause battery temperature rise and may even lead to fire or explosion. Stopping charging improves device safety. The first control module 13 can automatically determine whether the battery is fully charged and stop charging without manual intervention, thereby simplifying operation. By preventing overcharge, the service life of the battery is extended, thereby prolonging the service time of the entire device.

It should be noted that, in some embodiments, if the battery-current detection signal indicates battery overcurrent, the first control module 13 stops the charging of the emergency battery cell 11.

When battery current exceeds a preset safety upper limit (current is too high, exceeding a first current threshold, e.g., 100 A), the first control module 13 immediately stops the charging. This prevents overcurrent and avoids an internal battery-structure damage or a life reduction. Overcurrent may cause a sharp temperature rise inside the battery and may even lead to fire or explosion. Stopping charging can reduce this risk. Overcurrent may arise from a malfunction of the charging apparatus or an internal fault of the battery. Stopping charging by the first control module 13 can prompt users to check the charging device or battery, so that problems can be discovered and solved in time. Stopping charging can prevent the current from continuing to pass through a fault point, thereby avoiding damage to other parts of the device.

In these embodiments, the first control module 13 can comprehensively determine the battery state through battery-voltage detection signals and battery-current detection signals, and more intelligently control the disconnection/connection of the charging module, ensuring that the battery operates within a safe range at all times. When battery overvoltage or overcurrent is detected, the first control module 13 automatically disconnects connection between the charging module and the emergency battery cell 11. This prevents overcharge or overcurrent, and improves reliability and safety of the device.

In some embodiments, a supply voltage from the emergency battery cell 11 is input to the driving module 12, and a control unit controls the driving module 12 to convert the supply voltage into a drive voltage, which drives the air-blowing motor 30 to blow air.

Through the driving module 12, different voltage(s) from the emergency battery cell 11 can be converted into drive voltage(s) suitable for operation of the air-blowing motor 30. This ensures that the device can operate normally under different battery voltage(s). Users can therefore use emergency battery cell(s) 11 of different voltage(s) without worrying about voltage mismatch. This improves the flexibility of the device and broadens the application scope of the device. Meanwhile, the driving module 12 can ensure a stable supply voltage, so that an unstable operation of the air-blowing motor 30 caused by battery-voltage fluctuation can be avoided. By virtue of the voltage conversion of the driving module 12, excessively high battery voltage is prevented from being directly applied to the air-blowing motor 30, which would otherwise lead to motor damage. Likewise, by virtue of the voltage conversion of the driving module 12, excessively low battery voltage is prevented from making the motor unable to start or operate normally. By introducing the driving module 12, a stable conversion from supply voltage of the emergency battery cell 11 to drive voltage of the air-blowing motor 30 is realized. This improves the compatibility and the energy efficiency of the device, and meanwhile protects the motor.

In some embodiments, the air-blowing motor 30 comprises N airflow levels, where N is a positive integer greater than or equal to 2; each airflow level corresponds to a different drive voltage.

In alternative embodiments, the air-blowing motor 30 comprises N airflow levels, where N is a positive integer greater than or equal to 2; each airflow level corresponds to a different PWM duty cycle. The duty cycle of a PWM signal refers to a ratio of the high-level duration to a total period. By adjusting the duty cycle, the average output voltage can be regulated.

Users can select different airflow levels according to actual needs, so as to satisfy the requirements in different scenarios. For example, a low level (low-speed level) is suitable for light dust removal, while a high level (high-speed level) is suitable for heavy dust removal or for rapid cooling. Different airflow levels correspond to different drive voltages. Thereby, a more precise airflow control can be achieved, and the operational controllability can be improved. Based on the selected level, the driving module 12 outputs a corresponding drive voltage (average voltage). This can avoid energy waste caused by excessive power supply. By means of on-demand power supply, the discharge current and the discharge duration of the battery are effectively controlled, which reduces the operating load of battery and prolongs the service life of battery. By virtue of the design of multiple levels, a user can select different airflow levels according to actual needs, which achieves a more precise control and a more energy-efficient operation. This not only improves the performance and safety of the device, but also enhances the user's operational experience, making the device more intelligent and user-friendly.

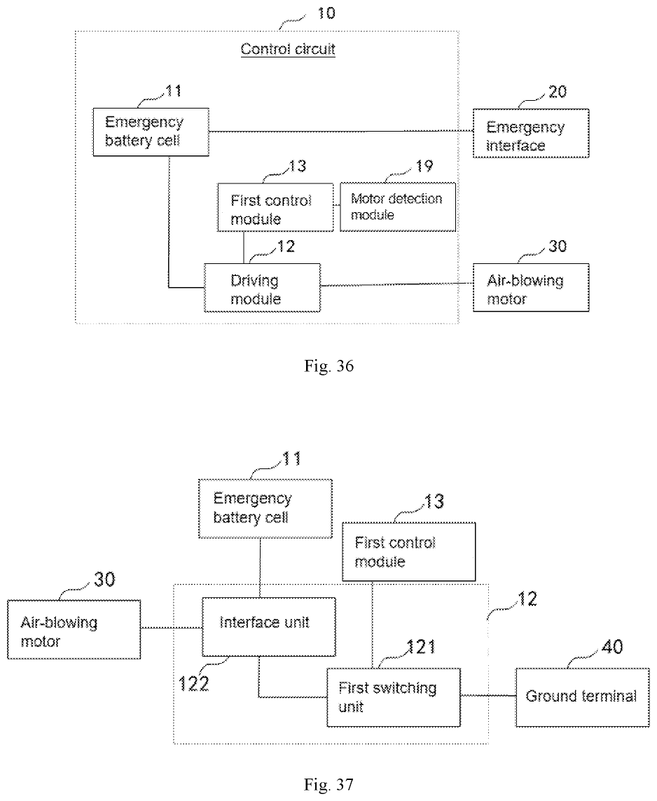

In some embodiments, as shown in FIG. 36, the control circuit 10 further comprises a motor detection module 19, which is connected to the air-blowing motor 30 and to the first control module 13.

On one side, the motor detection module 19 is electrically connected to the air-blowing motor 30, so as to be able to detect an operating state of the air-blowing motor 30. On the other side, the motor detection module 19 is in electrical connection to and/or in signal communication with the first control module 13, so as to be able to send a second detection signal to the first control module 13.

The motor detection module 19 can generate a second detection signal regarding a state/status of the air-blowing motor 30. If the second detection signal indicates abnormality of the air-blowing motor 30, the first control module 13 controls the driving module 12 to disconnect the circuit (stop the power supply), so as to stop the air-blowing motor 30 (from blowing air).

By virtue of the motor detection module 19, the operating state of the air-blowing motor 30 can be monitored in real time, and abnormal conditions can be detected in time. Real-time monitoring can ensure that the motor operates under normal conditions at all times, improving reliability and stability of the device. In the event of an abnormality occurring in the air-blowing motor 30, the first control module 13 will immediately stop the operation of the motor, so as to prevent further expansion of the fault. By timely protecting the motor, motor damage can be reduced and service life of the entire device can be extended.

For example, the second detection signal may comprise at least one or more selected from a motor-current detection signal and a motor-temperature detection signal. The motor detection module 19 may comprise a motor-current detection unit, and/or a motor-temperature detection unit.

The motor-current detection unit is connected to the air-blowing motor 30 and to the first control module 13, and is configured to generate a motor-current detection signal. Based on the received motor-current detection signal, the first control module 13 can control the driving module 12.

For example, when the motor-current detection signal indicates overcurrent of the air-blowing motor 30 (current is too high, exceeding a current threshold), the first control module 13 controls the driving module 12 to stop the air-blowing motor 30 (from blowing air).

The motor-temperature detection unit is connected to the air-blowing motor 30 and to the first control module 13, and is configured to generate a motor-temperature detection signal. Based on the received motor-temperature detection signal, the first control module 13 can control the driving module 12.

For example, when the motor-temperature detection signal indicates overheating of the air-blowing motor 30 (temperature is too high, exceeding a temperature threshold), the first control module 13 controls the driving module 12 to stop the air-blowing motor 30 (from blowing air).

Through the motor-current detection unit, the first control module 13 can monitor the current of the air-blowing motor 30 in real time. If motor overcurrent is detected (current is too high, exceeding a current threshold, e.g., exceeding a safety threshold of 100 A), the first control module 13 immediately stops the operation of motor, so as to prevent the motor from being damaged by excessive current. Overcurrent may cause rapid temperature rise inside the motor and may even lead to fire or explosion. Timely stopping motor operation can reduce these risks.

Through the motor-temperature detection unit, the first control module 13 can monitor the temperature of the air-blowing motor 30 in real time. If motor overheating is detected (temperature is too high, exceeding a temperature threshold, e.g., exceeding a safety threshold of 80 °C), the first control module 13 immediately stops the operation of motor, so as to prevent the motor from being damaged by high temperature. Overheating can degrade the material performance in motor and reduce the service life of motor. By timely stopping the motor, the motor can be protected and its service life can be prolonged.

In some embodiments, the motor detection module 19 can detect both the current and the temperature of the motor, providing multiple protections, so as to ensure motor operation within a safe range. The first control module 13 can comprehensively determine a motor state/status according to the current and the temperature of motor, thereby providing a more accurate protection.

Through the motor-current detection unit 181 and the motor-temperature detection unit 182, dual protection for the motor against overcurrent and overheating can be realized. This comprehensive protection mechanism can not only detect and handle abnormal conditions of the motor in a timely manner, but also improves users' operating experience and the service life of the device, by virtue of the functions of the user prompt and the operation guidance. These designs make the equipment more intelligent and user-friendly, and ensure safe and reliable operation under various usage conditions.

In some embodiments, as shown in FIGS. 37 to 39, the driving module 12 comprises: a first switching unit 121, wherein a control terminal of the first switching unit 121 is connected to the first control module 13; and an interface unit 122, wherein an output terminal of the interface unit 122 is connected to the air-blowing motor 30.

In some embodiments, the emergency battery cell 11 is connected first to the interface unit 122, then to the first switching unit 121, and then to the ground terminal 40. As shown in FIG. 37, an input terminal of the interface unit 122 is connected and located between the emergency battery cell 11 and a first terminal of the first switching unit 121 (as shown in FIG. 37).

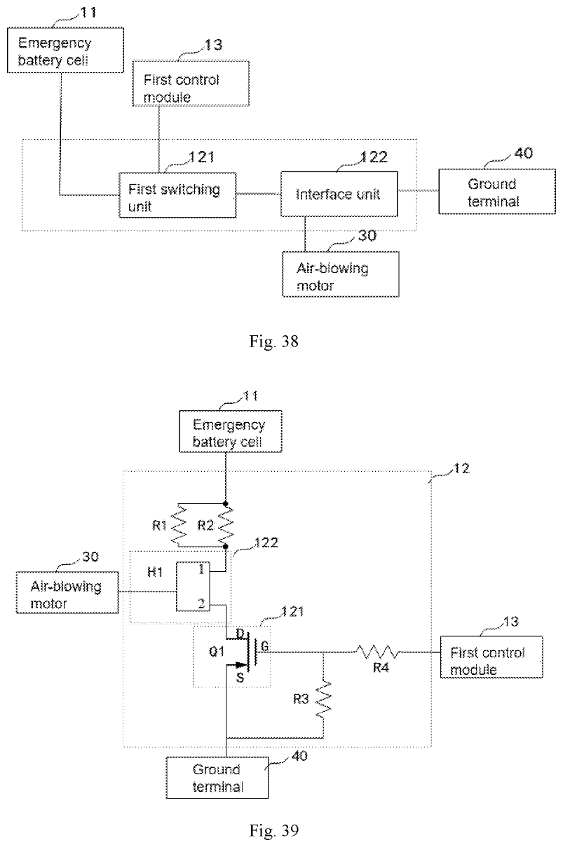

In alternative embodiments, the emergency battery cell 11 is connected first to the first switching unit 121, then to the interface unit 122, and then to the ground terminal 40. As shown in FIG. 38, the input terminal of the interface unit 122 is connected and located between a second terminal of the first switching unit 121 and the ground terminal 40 (as shown in FIG. 38).

Via the control terminal of the first switching unit 121, the first control module 13 controls the first switching unit 121 to switch on, and then the air-blowing motor 30 is driven via the interface unit 122 to blow air (output airflow).

The first control module 13 precisely controls a power-supply state of the emergency battery cell 11 via the control terminal of the first switching unit 121, so as to ensure that the air-blowing motor 30 receives the drive voltage only when needed. By precisely controlling the switching unit, motor damage or battery over-discharge caused by misoperation can be reduced. The first control module 13 can also control the first switching unit 121 to rapidly disconnect (switch off) when overload of the emergency battery cell 11 or of the air-blowing motor 30 is detected. This avoids potential safety risks caused by excessive current. If a short circuit of the emergency battery cell 11 or of the air-blowing motor 30 is detected, the first switching unit 121 can be disconnected (switched off) immediately, so as to protect the circuit from damage.

Meanwhile, the first control module 13 can control the on/off of the first switching unit 121 according to actual needs. This can avoid power consumption of the air-blowing motor 30 when it is not needed. Through precise switching control, ineffective battery discharge can be reduced, which extends the service life of the battery. Moreover, by virtue of the cooperative operation of the first switching unit 121 and the interface unit 122, the stability of drive voltage can be guaranteed, an unstable motor operation caused by battery-voltage fluctuation can be avoided. The interface unit 122 is able to control and regulate the current from the battery to a certain extent, so as to ensure that the motor operates within a safe current range.

In some embodiments (not shown in figures), the control circuit 10 may further comprise a load detection circuit, configured to detect a state/status of a load connected to the emergency interface (for example, a vehicle battery to be started, or a vehicle load without a vehicle battery).

In some embodiments, the load detection module is connected (including electrically connected) to the emergency interface, and is configured to detect an electrical signal at the emergency interface, such as voltage and/or current. The load detection module is in electrical connection to and/or in signal communication with the second control circuit 15, so as to be able to send a third detection signal to the second control module 15, which is used for controlling on/off of power supply from the emergency battery cell 31 to the emergency interface 32.

The load detection module is configured to detect/determine the occurrence of a vehicle ignition-start action. For example, only when the occurrence of the ignition-start action is detected, power supply from the emergency battery cell for vehicle starting is connected (turned on); preferably, after the connection (of power supply) has lasted for a certain time period, the power supply is automatically controlled to be disconnected (switched off).

For example, only when the load detection module detects that a voltage at the emergency interface (i.e., a positive-terminal voltage of a connected vehicle battery) drops by more than a preset amplitude threshold within a preset duration T0 (e.g., 2 ms), power supply from the emergency battery cell for vehicle starting is connected (turned on).

The load detection module may also be configured to detect a current magnitude at the emergency interface, i.e., detect a magnitude of the current supplied from the emergency battery cell to the load (vehicle battery). For example, the supply current is relatively large in the process of vehicle ignition starting, while the supply current is relatively small after ignition starting is completed.

When an “ignition start” action occurs, power supply from the emergency battery cell for vehicle starting is connected (turned on), and maintained for a certain time (a preset time, e.g., 3 seconds or 5 seconds), and then the supply current is detected and compared with a threshold. When the supply current is lower than this threshold, the power supply is controlled to be disconnected. That is, when the supply current is detected to be much lower than an operating current for vehicle ignition starting, it is determined that the ignition starting is completed, thus the energy storage module stops supplying power to the vehicle battery.

Through these controls, it can prevent the emergency battery cell from discharging (supplying power) to the vehicle battery during “non-ignition-start” periods, and saves the consumption of electric energy stored in the energy storage unit for “ignition start.” This also alleviates the problem of possible insufficient energy for other functions (e.g., an air-blowing device) when “emergency start” and other functions share the same energy storage unit (the same emergency battery cell).

The load detection module may also be configured to detect a load connection state, and the second control circuit 15 may be configured to control the on/off of power supply from the emergency battery cell 31 to the emergency interface 32 based on the detection result of the load connection state.

Optionally, detecting a load connection state includes a state that the load is correctly connected. Specifically, positive and negative terminals of the emergency interface are correspondingly connected, through a battery clamp (including cables and clamps), to positive and negative terminals of the load. Further, when it is determined that the load is correctly connected, a power supply from the emergency battery cell to the load can be triggered or allowed.

Optionally, detecting load connection state includes a state that the load is reversely connected. Specifically, positive and negative terminals of the emergency interface are respectively connected, through a battery clamp (including cables and clamps), to negative and positive terminals of the load. Further, when it is determined that the load is reversely connected, a power supply from the emergency battery cell to the load is not allowed.

Optionally, detecting load connection state includes a no-load state. Specifically, the emergency interface is not connected to a vehicle battery. Further, when it is determined to be no-load state, power supply from the emergency battery cell to the load is not actively triggered.

Optionally, detecting load connection state includes detecting a short circuit at the emergency interface; for example, the positive clamp and negative clamp of the battery clamp connected to the emergency interface are directly connected, causing a short circuit. Further, when it is determined to be short circuit, power supply from the emergency battery cell to the load is not allowed.

The load detection module may also be configured to detect whether the load is in a healthy state. The healthy state of the load may include a load voltage. For example, when the load voltage is higher than a preset voltage, such as higher than 7V, 8V, or 9V, the vehicle battery is considered to be in a healthy state, and current supply from the emergency battery cell to the load is allowed, so as to start the vehicle. In some embodiments, when the vehicle is detected to be not in a healthy state but a certain voltage requirement/threshold is met (for example higher than 2V, 3V, or 4V), power supply from the emergency battery cell to the load is still allowed.

The load detection module may also be configured to detect a load type. For example, if the detected voltage falls within a first voltage range, it indicates that the load is a 12V vehicle; if the detected voltage falls within a second voltage range, it indicates that the load is a 24V vehicle. If the load type does not match the voltage of the emergency battery cell 31, the emergency battery cell 31 is not allowed to output power via the emergency interface.

The above load detection module may be configured with various detection embodiments. The load detection module may comprise one of them, or a combination of multiple ones.

For example, as shown in FIG. 39, the interface unit 122 is interface H1, and the first switching unit 121 is MOS transistor Q1. The interface H1 comprises an input terminal 1, an input terminal 2, and an output terminal, and the output terminal is connected to the air-blowing motor 30.

In some embodiments, a voltage-dropping resistor R may be connected in series with the interface unit 122 and the first unit 121. It is preferably located at a position connected to the emergency battery cell 11.

As shown in FIG. 39, in some embodiments, the voltage-dropping resistor R may comprise a resistor R1 and a resistor R2 connected in parallel with each other. The resistor R1 and the resistor R2 are voltage-divider resistors. By connecting them in parallel, it can ensure that the input terminal 1 of interface H1 will not be damaged by excessive voltage when connected to the emergency battery cell 11. At the same time, the resistors connected in parallel can absorb a part of a transient voltage spike, which protects the interface H1 from being damaged by excessive voltage surge.

In some embodiments, the voltage-dropping resistor R is a level-adjustable resistor (with adjustable resistance value). By adjusting the level of the resistance value, the magnitude of the voltage finally allocated to the air-blowing motor 30 can be adjusted, thereby adjusting the airflow speed.

In alternative embodiments, the voltage-dropping resistor R has a fixed resistance value, and the first control module 13 adjusts a duty cycle of a PWM control signal, so as to adjusting an average output voltage, thereby adjusting the airflow speed.

When the first switching unit 121 is MOS transistor Q1, a resistor R3 may be connected in parallel between gate (G) and source (S). The resistor R3 is a pull-down resistor, used to ensure that the gate (electrode G) of the MOS transistor Q1 remains at a low level and the MOS transistor Q1 is in the off state when there is no control signal. This can prevent the MOS transistor from being switched on erroneously due to unstable signals or faults of the first control module 13. When the first control module 13 stops sending a turn-on (switch-on) signal, the resistor R3 provides a discharge path, which enables the gate (electrode G) of the MOS transistor Q1 to discharge rapidly, so as to ensure that the MOS transistor can be turned off quickly and improve the response speed of the switching circuit.

In some embodiments, a resistor R4 may be connected in series between the control terminal of the first switching unit 121 (an input terminal of control voltage, the gate in FIG. 39) and the first control module 13. The resistor R4 is a current-limiting resistor. The resistor R4 limits the current from the first control module 13 to the gate of MOS transistor Q1, which avoids that an excessive current would damage the output terminal of the first control module 13 or the gate of the MOS transistor. The resistor R4 serves as a signal matching resistor, so as to ensure that the signal output by the first control module 13 matches the impedance at the gate (electrode G) input terminal of the MOS transistor Q1, which improves the stability and reliability of signal transmission.

The resistance values of the above resistors R1, R2, R3, and R4 can be set according to actual requirements, which are not limited in the embodiments of this application.

As shown in FIG. 39, in some embodiments, when an input terminal 1 of interface H1 is connected and located between the emergency battery cell 11 and the first terminal of the first switching unit 121, a parallel combination of a resistor R1 and a resistor R2 may be arranged between the input terminal 1 of the interface unit 122 and the emergency battery cell 11. An input terminal 2 of interface H1 is connected to the drain (electrode D) of the MOS transistor Q1, and the source (electrode S) of the MOS transistor Q1 is connected to ground terminal 40. The source (electrode S) of the MOS transistor Q1 is also connected to a resistor R3 and then connected to the gate (electrode G) of the MOS transistor Q1, and the gate (electrode G) of the MOS transistor Q1 is connected to a resistor R4 and then connected to the first control module 13. The first control module 13 is configured to send a turn-on (switch-on) signal to the gate (electrode G) of the MOS transistor Q1, so as to control the MOS transistor Q1 to be turned on (switched on), and converts (regulates) the voltage from the emergency battery cell 11, for example by means of PWM modulation. When the MOS transistor Q1 is turned on, the battery voltage is converted (regulated) and is input/supplied to the air-blowing motor 30.

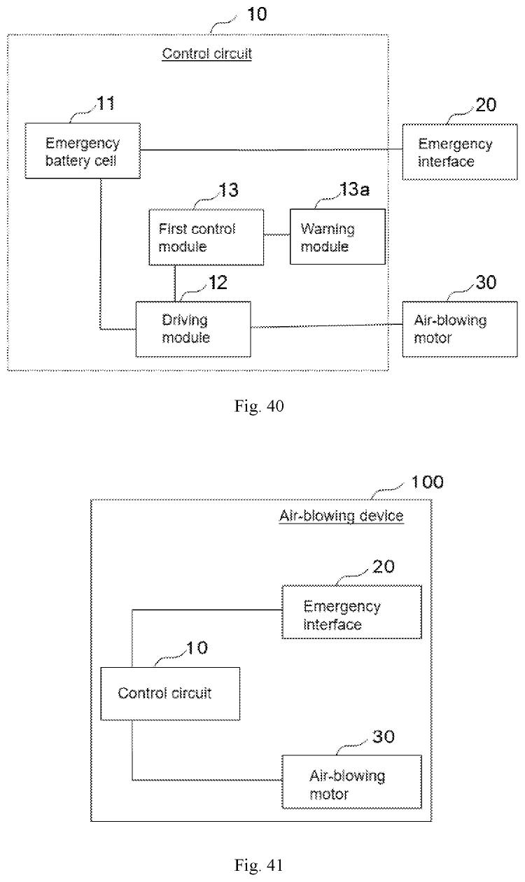

In some embodiments, as shown in FIG. 40, the control circuit 10 further comprises a warning module 13a, which is connected to the first control module 13. If the emergency battery cell 11 is abnormal and/or the air-blowing motor 30 is abnormal, the first control module 13 controls the warning module 13a to perform warning.

By virtue of the warning module 13a, alarms can be sent to users in time when abnormalities occur in the emergency battery cell 11 or air-blowing motor 30, which helps users take measures in advance, so as to prevent fault expansion. Timely warning can reduce potential safety risks caused by faults, such as battery overheating and short circuit.

The warning module 13a may include but is not limited to that the warning module 13a is configured to output an audible alarm, so as to quickly attract user attention. The warning module 13a may display abnormal information via corresponding LED indicator(s), so as to provide visual prompt(s). In some cases, the warning module 13a may also alert the user by vibration, especially in noisy environments. The warning module 13a can cooperate with the first control module 13 to provide detailed fault information, so as to assist the user in quickly locating the fault problem. Thereby, when the device abnormalities occur, the user can quickly receive prompts and take actions, which reduces the downtime caused by faults.

By introducing the warning module 13a, it achieves timely warning for abnormalities of the emergency battery cell 11 and of the air-blowing motor, which improves safety and reliability of the device. The user can quickly perceive the abnormal device status by one or more means (sound, vision, vibration, etc.) and take corresponding measures/actions, so as to reduce fault expansion and potential safety risks.

With reference to FIGS. 31 to 40, a specific embodiment is used below to explain the working principles of the control circuit:

When the first triggering module 17 is triggered (pressed down), the second control module 15 detects a low-level voltage, and sets a signal corresponding to the control terminal of the protection module 14 to a high level, thereby the emergency battery cell 11 supplies power to the vehicle via the emergency interface 20. When the user triggers (presses down) the first triggering module 17 again, the second control module 15 sets the signal corresponding to the control terminal of the protection module 14 to a low level, thereby the emergency battery cell 11 stops supplying power via the emergency interface 20 to the external (load).

When the second triggering module 18 is triggered (pressed down), the first control module 13 detects a low-level voltage, thereby the emergency battery cell 11 supplies power to the air-blowing motor 30 via the driving module 12. When the second triggering module 18 is triggered (pressed down) again, the first control module 13 sets the signal corresponding to the driving module 12 to an airflow signal of a next level (airflow signals may be all at their high levels), thereby the rotational speed of the air-blowing motor is changed. A plurality of airflow levels can be set/controlled in the similar manner. Meanwhile, in the case that airflow signals have 5 levels (N levels) in total, then upon the sixth triggering (N+1-th press) of the second triggering module 18, the first control module 13 sets the signal corresponding to the driving module 12 to a low-level signal, thereby the emergency battery cell 11 stops supplying power to the air-blowing motor 30 via the driving module 12.

The first control module 13 acquires the battery temperature information via a battery-temperature detection unit 163. When the battery temperature exceeds a set value, the first control module 13 disables (turns off) the functions of air blowing and (emergency) starting, sets signals corresponding to the protection module 14 and driving module 12 to a low level, and meanwhile instructs an LED indicator corresponding to the warning module 13a to flash for two seconds.

The first control module 13 acquires the battery-voltage information via a battery-voltage detection unit 161. When the battery voltage is higher than a (first) set value or is lower than a (second) set value, the first control module 13 performs the same operation as above, so as to set signals corresponding to the protection module 14 and driving module 12 to a low level. Moreover, when the voltage is too high, the first control module 13 sets a charging signal between the emergency battery cell 11 and an external charging device to a low level, so as to stop (turn off) the charging.

The first control module 13 acquires the battery-current information via a battery-current detection unit 162. When battery discharge current exceeds a set value, the first control module 13 performs the same operation as above, so as to set signals corresponding to the protection module 14 and driving module 12 to low level. When the battery charging current exceeds a set value, the first control module 13 sets a charging signal between the emergency battery cell 11 and an external charging device to low level, so as to stop (turn off) the charging.

The first control module 13 acquires the motor-temperature information via a motor-temperature detection unit. When motor temperature exceeds a set value, the first control module 13 stops (turns off) the function of air blowing, sets the signal corresponding to the driving module 12 to low level, and meanwhile activates the warning module 10a (e.g., a LED flashes for two seconds).

The first control module 13 acquires the motor drive-current information via a motor-current detection unit. When motor current exceeds a set value, the first control module 13 stops (turns off) the function of air blowing, sets the signal corresponding to the driving module 12 to low level, and meanwhile activates the warning module 10a (e.g., a LED flashes for two seconds).

Referring to FIG. 41, the present disclosure provides an air-blowing device 100. The air-blowing device 100 comprises an emergency interface 20, an air-blowing motor 30, and the control circuit 10 according to any embodiment of the present disclosure. The control circuit 10 is connected to the emergency interface 20, so as to control the emergency interface 20 for emergency starting; the control circuit 10 is connected to the air-blowing motor 30, so as to drive the air-blowing motor 30 to blow air (output airflow).

The control circuit 10 may comprise an emergency battery cell 11, a protection module 14, a driving module 12, and a first control module 13. A first terminal of the protection module 14 is connected to the emergency battery cell 11, and a second terminal of the protection module 14 is connected to the emergency interface 20 of the air-blowing device 100; the emergency interface 20 is used for emergency starting. The driving module 12 is connected to the emergency battery cell 11 and is connected to the air-blowing motor 30 of the air-blowing device 100. The first control module 13 is connected to a control terminal of the protection module 14 and is configured to control the on/off of the protection module 14. The first control module 13 is connected to the driving module 12, so that the air-blowing motor 30 is driven via the driving module 12 to blow air.

Meanwhile, the emergency interface 20 can be used to implement operations on an external device, such as ignition starting, power transmission, etc. The air-blowing device 100 may also be a hair dryer, a dust blower, etc., which are not limited in the embodiments of this application.

### Charging/Discharging Port

As shown in FIGS. 2 and 4, in some embodiments, the air-blowing device further comprises one or more charging/discharging ports 70 (a port used for charging and/or discharging), and the charging/discharging port(s) 70 may be electrically connected to the energy storage unit 300 or the control assembly 10. Through the charging/discharging ports 70, the charging of the energy storage unit 300 can be performed, and/or the charging of a terminal device (such as mobile phone, tablet computer, etc.) by the energy storage unit 300 can be performed. Thereby, it further realizes the multiple functions of the air-blowing device.

For example, the charging/discharging port may be soldered to the circuit board so as to be electrically connected to the circuit board.

The charging/discharging port may be a USB-A port, USB-B port, Type-C port, Lightning port, or AC port, etc. These are only examples and do not limit the invention to these interface types.

For example, the charging/discharging port may be placed at any position of the grip section 120 of the housing. Optionally, it may be close to the airflow section 110, or at a bottom of the grip section 120; it may be on a side surface of the bottom, or on an end surface of the bottom. For example, when the charging/discharging port is placed on a side surface of the bottom portion, it can facilitate the charging of the device in an upright state; when the charging/discharging port is placed on an end surface at the bottom, it can make the side appearance of the grip section more concise.

The housing 40 may be provided with a first charging/discharging port 71 and/or a second charging/discharging port 72. Optionally, the first charging/discharging port 71 may be a USB port, and the second charging/discharging port 72 may be a Type-C port. For example, the first charging port 71 may be a USB-A or USB-B port, and the second charging/discharging port 72 may be a Type-C port.

Therein, the first charging/discharging port 71 and the second charging/discharging port 72 may be electrically connected to the circuit board 41 or the emergency battery cell 31.

The first charging/discharging port 71 and/or the second charging/discharging port 72 may be located at any position of the grip section 120 of the housing 40, and are preferably located at a position close to the airflow section 110. This is because this position is relatively close to circuit board 14, which facilitates the wiring.

In some embodiments, the first charging/discharging port 71 and/or the second charging/discharging port 72 is arranged on a relatively wide side surface of the grip section (for example, a side surface parallel to airflow direction, i.e., the first direction), because a USB port occupies a relatively large area.

In some embodiments, a switch 43 of the air-blowing device is a toggle switch (or knob switch), which also occupies a relatively large area. Therefore, the first charging/discharging port 71 and/or second charging/discharging port 72 can be arranged on a side opposite to the toggle switch (or knob switch) of the air-blowing device.

It can be understood that, by providing a USB port and/or a Type-C port, the air-blowing device can serve as a power bank. This not only facilitates charging of the emergency battery cell 31, but also fully utilizes power-supply potential of the emergency battery cell 31, expands the uses and functions of the air-blowing device, further improves the use efficiency and user experience, and increases the use frequency of the device. The increased use frequency can prevent the emergency power supply equipment from being left unused or damaged, enables the user to charge the equipment in time according to the remaining power level due to frequent use, and thus improves the power supply stability of the emergency power supply equipment.

It can be further understood that the charging/discharging port may be a unidirectional charging port or a unidirectional discharging port, or may be a bidirectional port capable of both charging and discharging.

### Signal/Display

In some embodiments, the housing 40 may further be provided with a signal light and/or a display screen. The signal light and/or the display screen is electrically connected to the circuit board 41 and is configured to display operating information of the handheld air-blowing device.

The operating information may include tire-pressure information, remaining power of the device, operating level of the air-blowing motor, operating mode of the device, state/status of a load connected to the emergency interface, etc.

It can be understood that, when a user uses the handheld air-blowing device to perform an operation such as inflation (or air blasting), the user can obtain operation information (including tire pressure information, remaining power of the emergency battery cell, etc.) via the signal light or the display screen, so as to accurately determine the timing to stop the inflation (or air blowing) operation.

The device may be equipped with one or more signal light(s) and/or display screen(s), for example, a plurality of signal lights. Therein, a first signal light is used to display the remaining power of the device, and a second signal light is used to display the operating level of the air-blowing motor.

### Button Assembly

In some embodiments, the air-blowing device of the present disclosure may have a button assembly 44.

Via the button assembly 44, the user can manually operate the switches on/in the control circuit 10, such as the first switch 42 and/or the second switch 43.

The button assembly 44 preferably comprises two or more buttons.

As shown in FIG. 14, button assembly 44 may comprise a first button 4201 and a second button 4301. The first button 4201 and the second button 4301 may be arranged in/on the grip section 120 and at a position close to the airflow section 110.

As shown in FIG. 15, in some embodiments, a fixing section 4403 of the first button 4201 and/or of the second button 4301 is connected to an inner wall of the housing 40 by hot-melt bonding.

In some embodiments, the first button 4201 may be used to control, via the circuit board 41, the power-supply function of the emergency battery cell 31, and the second button 4301 may be used to control, via the circuit board 41, the operating mode or the airflow level of the air-blowing device.

It can be understood that arranging the first button 4201 and second button 4301 in the grip section 120 at a position close to the airflow section 110 not only facilitates one-hand holding and operation of the button assembly 44, but also facilitates arrangement of the circuit board 41 and internal wiring of the air-blowing device. Thereby, button signals can be received by using a single circuit board 41 and shorter electrical connecting wires, which saves material cost.

In some embodiments, the user may use the first button 4201 to start (turn on) the air-blowing device, and use the second button 4301 to control the operating mode or the airflow level of the air-blowing device, and then uses the first button 4201 to turn off the air-blowing device.

In some embodiments, the user can repeatedly use the second button 4301 to perform a switching between operating modes or airflow levels of the air-blowing device.

For example, a first using/triggering of the second button 4301 may switch the air-blowing device from no blowing to a first-level blowing, a second using/triggering of the second button 4301 may switch from the first-level blowing to a second-level blowing, and a third using/triggering of the second button 4301 may switch from the second-level blowing back to no blowing.

It can be understood that the switching of operating mode or airflow level can only use one second button 4301. This simplifies the design and operation process, and thus is convenient in use.

In some embodiments, the second button 4301 may be arranged on a first side surface of the grip section 120, wherein the first side surface faces (towards) the second air port 10c of the air-blowing device; the first button 4201 may be arranged on a second side surface of the grip section 120, wherein the second side surface is adjacent to the first side surface.

In alternative embodiments, the second button 4301 may be arranged on the first side surface of the grip section 120, wherein the first side surface faces (towards) the second air port 10c of the air-blowing device; the first button 4201 may be arranged on a second side surface of the grip section 120, wherein the second side surface is opposite to the first side surface.

In alternative embodiments, the first button 4201 may be arranged on the first side surface of the grip section 120, wherein the first side surface faces (towards) the second air port 10c of the air-blowing device; and the second button 4301 may be arranged on a second side surface, wherein the second side surface is adjacent to or opposite to the first side surface.

It can be understood that arranging the first button 4201 and second button 4301 on different surfaces can help the user to distinguish operating actions and thus prevent accidental touch.

In some embodiments, the button assembly 44 may comprise one or more selected from press button(s), push (toggle) button(s), knob button(s), touch button(s), etc.

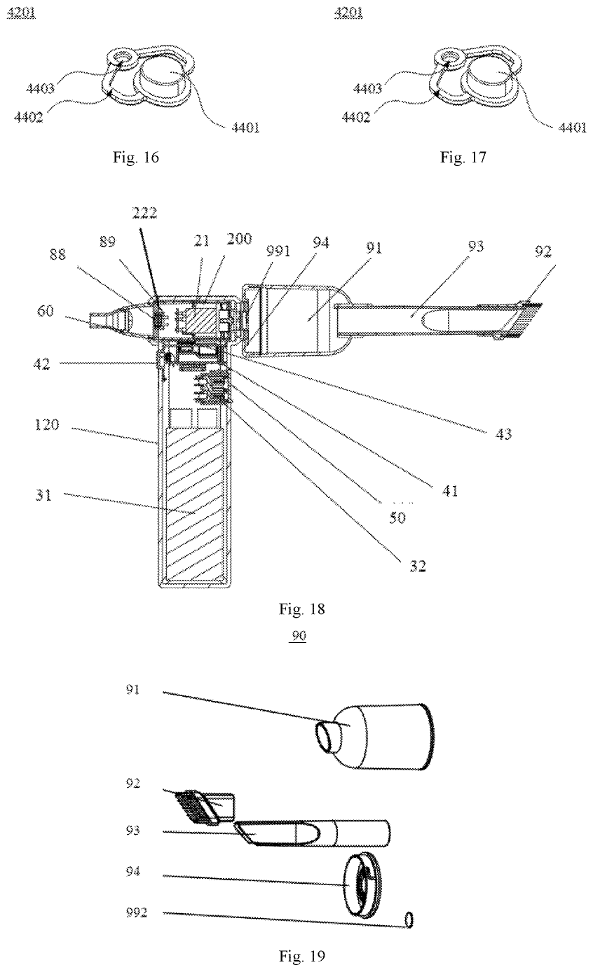

For example, as shown in FIG. 16, the first button 4201 and/or second button 4301 may comprise a pressing section 4401, an elastic arm 4402, and a fixing section 4403. The pressing section 4401 may be connected to the fixing section 4403 through the elastic arm 4402, and the fixing section 4403 may be connected to an inner wall of the housing 40. The housing 40 may be provided with a pressing opening 1201, and the pressing section 4401 of the first button 4201 and/or second button 4301 may pass through the pressing opening 1201, so as to protrude out of the housing 40.

The elastic arm 4402 may comprise a butterfly-type force arm or a strip-type force arm.

It can be understood that the pressing opening 1201 may be formed by assembling multiple parts of the housing 40, or may be directly formed on the housing 40.

In some embodiments, the elastic arm 4402 may serve both as an elastic arm and as a fixing section 4403. For example, a pressing section 4401 is provided at one end of a strip-type force arm, and the other end of the strip-type force arm serves as the fixing section 4403 connected to the inner wall of the housing 40.

It can be understood that, through the design (with the pressing section 4401, the elastic arm 4402, and the fixing section 4403 of the first button 4201 and/or second button 4301), it can convert the conventional solution in which the button is fixedly connected to the switch body of the circuit board 41 into a solution in which the button is detachably connected or abutted against the switch body of the circuit board 41, and the button is fixedly connected to the housing 40.

It can be further understood that, since the circuit board 41 is often fixed at a position inside housing 40, if the button is fixedly connected to circuit board 41, it brings the problem that the pressing section 4401 may easily become misaligned with pressing opening 1201 after molding and assembly of housing 40. On the contrary, if the button is fixedly connected to housing 40 and the pressing section 4401 abuts a switch element in the circuit, it not only ensures the normal function of the button signal transmission, but also improves the connection accuracy between the pressing opening 1201 of housing 40 and the button. This improves the waterproofness and airtightness at the connection between the pressing section 4401 and the pressing opening 1201, improves the safety and stability of the air-blowing device, increases the machining yield, and also reduces the machining accuracy requirements and related costs.

### Battery Clamp

In some embodiments, a battery clamp 900 may be used to connect the emergency interface 20 and an external battery (for example a vehicle battery to be started).

The battery clamp 900 is located outside the housing 40, and is therefore also called an external battery clamp. In some embodiments, the battery clamp may be fixedly connected to the housing; in some embodiments, the battery clamp may be detachably connected to the housing, for example in a pluggable connection between the battery clamp and emergency interface.

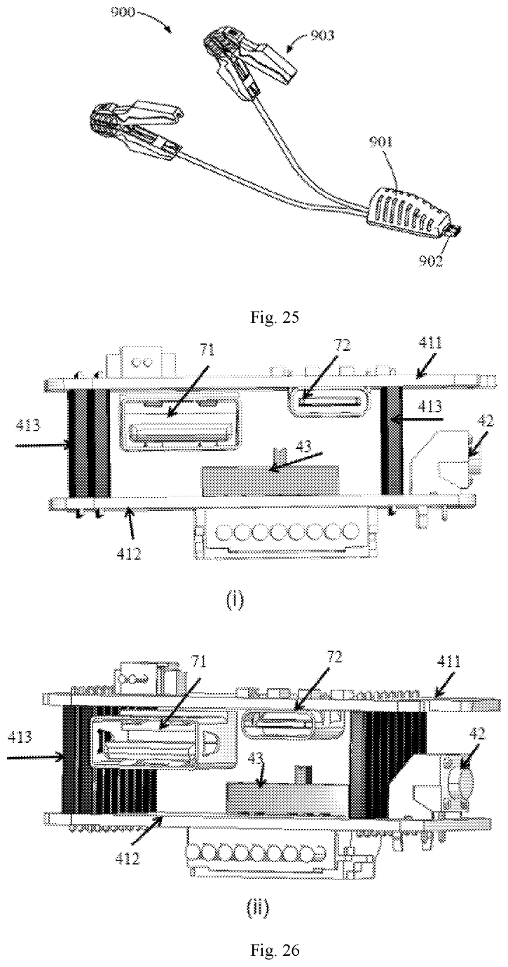

As shown in FIG. 25, the battery clamp 900 has a power input interface 902 and a power output interface 903. It may further comprise a circuit section 901.

The power input interface 902 is configured to be mated/connected with the emergency interface 20 of the emergency battery cell 11. Thereby, the electrical energy required for emergency starting (jump starting) can be obtained.

The power output interface 903 is configured to be connected to a vehicle battery.

The power output interface 903 may comprise two conductive clamps. They are respectively used for connecting positive and negative terminals of the vehicle battery. For example, a red conductive clamp is connected to the battery positive terminal, and a black conductive clamp is connected to the battery negative terminal.

In some embodiments, the circuit section 901 may comprise a switch module and/or a control module.

For example, the first triggering module 17 as mentioned in the above part <Control Assembly> may be disposed externally and be disposed in the battery clamp 900. For example, it is used for manually turning on/off the power supply for emergency starting.

For example, the second control module 15 as mentioned in the above part <Control Assembly> may be disposed externally and be disposed in the battery clamp 900. Thus, the (startup) function of the protection module 14 can be controlled via the second control module 15 in the battery clamp 900. The first triggering module 17 for controlling the second control module 15 may also be disposed externally and be disposed in the battery clamp 900.

In some embodiments, all of the protection module 14, second control module 15, and first triggering module 17 as mentioned in the above part <Control Assembly> are disposed externally and are disposed in the battery clamp 900. In some embodiments, the emergency battery cell 11 is directly connected to the emergency interface 20, and all of the control circuit(s) and/or protection circuit(s) and/or switch circuit(s) for controlling emergency-start power supply are disposed externally and are disposed in the battery clamp 900.

In some embodiments, the load detection module as mentioned in the above part <Control Assembly> is also disposed externally and is disposed in the battery clamp 900.

By placing at least part (or even all) of the control modules/detection modules/switch modules related to “emergency starting” externally and in the battery clamp 900, the volume of the grip section 120 can be reduced, the structure of the air-blowing device can be more compact, and the handheld operation can be facilitated.

### Flow Guide

In some embodiments, the air-blowing device may comprise a flow guide 60. The flow guide 60 is configured to be connected to the housing 40 or the blowing unit 200. The flow guide 60 is arranged corresponding to the second air port (air outlet) 10d. The flow guide 60 is used to adjust the airflow output effect at the air outlet 10d.

Besides, the flow guide 60 is arranged corresponding to the air outlet 10d, so that it can adjust the airflow output effect at the air outlet 10d, for example adjusting an output airflow speed, an output airflow coverage, etc. Thereby, it improves the working efficiency when the air-blowing device performs dust removal or air drying by airflow.

By using the flow guide, the airflow output effect at air outlet 10d can be adjusted. It can make the airflow of the air-blowing device more concentrated so that the output airflow can easily enter narrow gaps and blow away dust and debris. Alternatively, when there is a large amount of accumulated water or snow on vehicle body surface, the flow guide can adjust airflow output effect at air outlet 10d, so that the output airflow coverage of the air-blowing device becomes larger, so that the water or snow on the vehicle body surface can be blown away more quickly.

As shown in FIGS. 5 to 10, in some embodiments, the flow guide 60 has a flow-guiding channel 61. The flow-guiding channel 61 communicates with the air outlet 10d of the blowing unit 200, and the airflow output from air outlet 10d can be blown out through flow-guiding channel 61. By introducing the airflow output from air outlet 10d into the flow-guiding channel, the airflow speed or the airflow coverage can be adjusted in the flow-guiding channel 61. This avoids that the air output effect is impaired due to excessive dispersion of the airflow. In other words, the flow-guiding channel 61 communicates with the second air port 10c of housing 40, so that the airflow output from second air port 10c is blown out via the flow-guiding channel, and the flow-guiding channel 61 is used to adjust the airflow output effect at second air port 10c.

The flow guide 60 may have a flow converging section 611, whose radial size gradually decreases outward along the first direction.

As shown in FIGS. 6, 8, and 10, in some embodiments, the flow-guiding channel may comprise a flow converging section 611 and a guiding section 612. The flow converging section 611 communicates with the second air port 10c and the guiding section 612, and the radial size of the flow converging section 611 gradually decreases along a direction from the flow converging section 611 to the guiding section 612. It can be understood that radial size of the flow converging section 611 gradually decreases along the direction from the flow converging section 611 to the guiding section 612. Thus, after the airflow output at air outlet 10d of the blowing unit 200 (from the second air port 10c) enters the flow-guiding channel, the airflow can be concentrated in the flow converging section 611, so that the airflow speed is increased, which helps improve the efficiency of air output.

For example, the direction from the flow converging section 611 to the guiding section 612 may be the X direction as shown in FIG. 3.

It can be understood that the radial size of the guiding section 612 can be designed according to use scenarios.

For example, as shown in FIGS. 5 and 6, the radial size of the guiding section 612 may gradually decrease along the direction from the flow converging section 611 to the guiding section 612. Thereby, the airflow output from the flow converging section 611 can be further concentrated in the guiding section 612, the output airflow speed is further increased. It helps the airflow enter narrow gaps to remove dust.

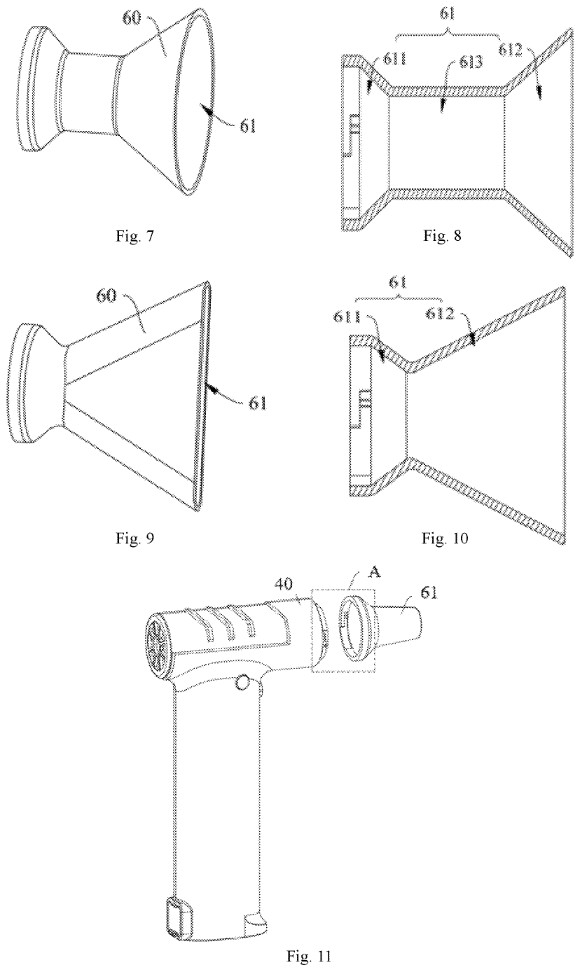

For example, as shown in FIGS. 7 to 10, the radial size of the guiding section 612 may gradually increase along the direction from the flow converging section 611 to the guiding section 612. Thereby, the airflow output from the flow converging section 611 can be stably diffused in the guiding section 612. This increases the output airflow coverage/area of the air-blowing device, and thus facilitates dust removal or air drying over a large area.

In some embodiments, as shown in FIGS. 7 and 8, an extension section 613 may further be provided between the flow converging section 611 and the guiding section 612, and the radial size of extension section 613 remains constant along the direction from the flow converging section 611 to the guiding section 612 (the diameter is unchanged). This avoids a situation where, due to excessive radial-size difference between the flow converging section 611 and the guiding section 612, the airflow output from flow converging section 611 cannot diffuse to the radial edge regions of the guiding section 612. This is to say, this avoids a situation that the guiding section 612 fails to play a role of adjusting the output coverage area of the airflow.

In some embodiments, the flow guide 60 is detachably connected to the housing 40 or blowing unit 200. By replacing the flow guides 60 with different structures, the air-blowing device can provide diversified airflow effects. This improves the applicability of the air-blowing device, so that the air-blowing device can be used in more application scenarios.

For example, as shown in FIGS. 11 and 12, the blowing unit 200 is located in the accommodating cavity 10a of the housing 40, and the flow guide 60 is detachably connected to the housing 40, so that the flow guide 60 can be assembled/disassembled while the blowing unit 200 is protected.

In some embodiments, the housing 40 and the flow guide 60 are connected by insertion/bayonet connection; and/or by magnetic connection; and/or by threaded connection; and/or by interference fit. It can be understood that connection manner between the housing 40 and the flow guide 60 can be flexible and may be adjusted according to actual conditions.

Threaded connection: two parts are respectively provided with matched external threads and internal threads, and a fastening connection therebetween can be achieved by rotating/screwing.

Magnetic connection: two parts are respectively provided with magnetic components, and a connection therebetween can be achieved by magnetic connection. Insertion/bayonet connection: two parts are respectively provided with a locking block and a slot, and an insertion/bayonet connection therebetween can be achieved by moving/rotating.

As examples of insertion/bayonet connection between the housing 40 and the flow guide 60, the following embodiments may be referred to.

For example, the flow guide 60 is sleeved over an outer periphery of the housing 40. One of the locking block(s) 6011 and the slot 1011 is provided on the outer periphery of housing 40, and the other is provided on an inner side of flow guide 60. By inserting the locking block 6011 into the slot 1011, the insertion/bayonet connection between the housing 40 and the flow guide 60 can be achieved. For example, a connection between the flow guide 60 and the housing 40 may be achieved by rotatory insertion (bayonet connection).

For example, the flow guide 60 and the housing 40 are connected (by insertion/bayonet connection) at multiple positions. This can improve the connection stability between the flow guide 60 and the housing 40.

In some embodiments, one of the housing(s) 40 and the flow guide 60 is provided with a guide groove 601, and the other is provided with a protrusion 101. The protrusion 101 is movably inserted in the guide groove 601, and can move relative to the guide groove 601 until the housing 40 and the flow guide 60 are connected by bayonet connection or snap-fit connection. Due to the movable insertion between the protrusion 101 and the guide groove 601, the flow guide 60 is guided to move relative to the housing 40 along a preset direction. This facilitates the assembly (insertion/bayonet connection) of the flow guide 60 to the housing 40. Meanwhile, such movable insertion between the protrusion 101 and the guide groove 601 can also improve the stability of the connection between the housing 40 and the flow guide 60.

For example, as shown in FIG. 12, a protrusion 101 is provided on an outer periphery of the housing 40, and a slot 1011 is formed with the protrusion 101. A guide groove 601 is provided on an inner side of the flow guide 60, and a locking block 6011 is formed on a groove wall of the guide groove 601. After the protrusion 101 is inserted from an opening of the guide groove 601 into the guide groove 601, the flow guide 60 is controlled to rotate relative to the housing 40, so that the protrusion 101 slides along the groove wall of the guide groove 601 until the locking block 6011 is inserted (or snapped) into the slot 1011. Thereby, a bayonet connection or a snap-fit connection between the flow guide 60 and the housing 40 is achieved.

### Suction Assembly

As shown in FIGS. 18 to 19, in some embodiments, the air-blowing device may have a suction assembly 90.

The suction assembly 90 is configured to be connected to the housing 40 or the blowing unit 200. In particular, it is arranged on the same side as the first air port (air inlet) 10b.

The suction assembly is used to suck in dust (debris), so as to perform vacuum cleaning inside the vehicle (for example seats).

The suction assembly 90 has a suction body 91. The suction body 91 has a suction port, a filter element, and a dust chamber. Debris (e.g., dust) in air is sucked in from the suction port, and then intercepted by the filter element so as to be left in the dust chamber. The dust chamber is detachable, which facilitates the cleaning of the dust chamber and/or the replacement of the filter element.

When the suction assembly 90 is connected to an end of the housing 40 (and/or of the blowing unit 200) which is (or is close to) the first air port (air inlet) 10b, the device can perform vacuuming under the action of the blowing unit 200 (for example, under the action of the air-blowing motor 21 therein). Under the action of the blowing unit 200 (for example that the air-blowing motor 21 drives an impeller to rotate), negative pressure is generated at the suction port, thereby drawing/sucking in debris (such as dust, paper scraps, etc.) into the suction assembly. The sucked debris is intercepted by the filter element and is collected in the dust chamber, and the cleaned air is discharged/output from the second air port (air outlet) 10c of the air-blowing device.

Thus, the suction assembly 90 and the blowing unit 200 can form a complete airflow path as a vacuum cleaner. The suction assembly 90 undertakes the function of air inlet and the function of filtering, while the blowing unit 200 undertakes the function of driving air flow and the function of air outlet.

The suction assembly 90 of the present disclosure has a suction connector 94, to achieve a connection between the suction assembly 90 and the housing 40 (and/or the blowing unit 200).

In some embodiments, the suction assembly 90 is detachably connected to the housing 40 (and/or the blowing unit 200). Because the suction assembly 90 generally occupies relatively large space, a detachable connection can facilitate storage. In some embodiments, the connection between suction assembly 90 and housing 40 (and/or blowing unit 200) may be insertion/bayonet connection; and/or magnetic connection; and/or threaded connection; and/or in interference fit. Among these, insertion/bayonet connection and/or magnetic connection is preferred.

Various connection manners between the flow guide 60 and the housing 40 as described above in the part <Flow Guide> are also applicable to the connection between the suction assembly 90 and the housing 40 (and/or the blowing unit 200). The connection between the suction assembly 90 and the housing 40 (and/or the blowing unit 200) may use the same manner as, or a different manner from, the connection between the flow guide 60 and the housing 40.

As compared with the flow guide 60, the suction assembly 90 may be connected to the housing 40 (and/or the blowing unit 200) in a different manner. This provides a mistake-proofing design that prevents incorrect assembly and helps users distinguish the air inlet from the air outlet. For example, when the connection between the flow guide 60 and the housing 40 is rotary insertion connection (bayonet connection), the connection between the suction assembly 90 and the housing 40 (and/or the blowing unit 200) is magnetic connection.

In some embodiments, the connection between suction assembly 90 and housing 40 (and/or blowing unit 200) may be rotary insertion connection (bayonet connection). One of the two is provided with a guide groove and a slot, and the other has a protrusion (locking block). After the protrusion (locking block) is aligned and enters the guide groove, the two parts rotate relative to each other, and the protrusion (locking block) moves along the guide groove and then enters the slot, so as to form a bayonet connection.

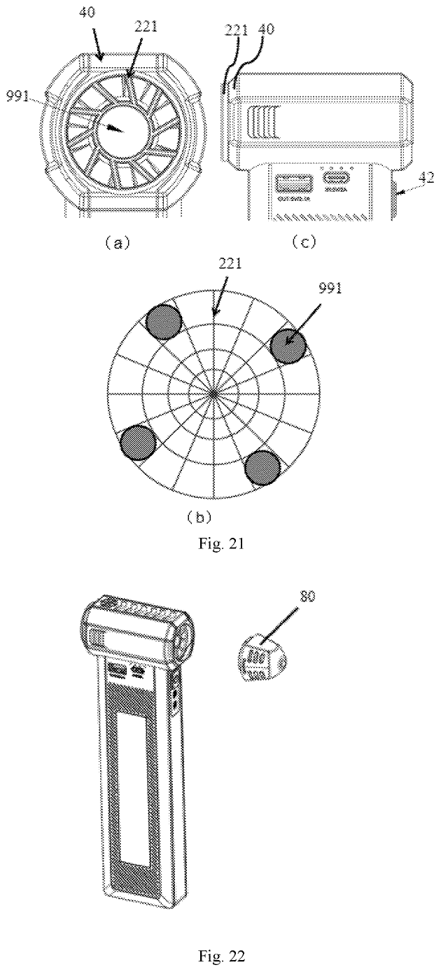

Preferably, as shown in FIG. 21, in some embodiments, the connection between the suction assembly 90 and the housing 40 (and/or the blowing unit 200) is magnetic connection.

Therein, the housing 40 (and/or the blowing unit 200) is provided with a first magnetic member 991, and the suction assembly 90 is provided with a second magnetic member 992. The first and second magnetic members are configured to attract each other when close to each other.

The first/second magnetic member usually uses magnet material, such as permanent magnet, ferromagnet, etc. At least one of the first magnetic member and the second magnetic member uses permanent-magnet material.

As described above, a filter mesh (grille component) 22 may be provided on/in/at the housing 40 and/or the blowing unit 200. For example, a grille (air-inlet grille 221) may be provided at one end (air-inlet end) of the housing 40 and/or the blowing unit 200. For example, the air-inlet grille 221 may have a frame, which is annular or circular. For example, the air-inlet grille 221 may have multiple guide plates. For example, the guide plates may be parallel or inclined relative to the first direction (longitudinal direction of the blowing unit, i.e., axial direction of the air-blowing motor).

The air-inlet grille 221 may be provided with an embedding seat for embedding the first magnetic member 991 (e.g., a magnet). Thereby, a magnetic-connection portion is formed on/at/in the housing 40 (the blowing unit 200). In some embodiments, the air-inlet grille 221 is annular, and a magnet is embedded at the circle center (see FIG. 21a). In alternative embodiments, the air-inlet grille 221 is a circle (circular), and M magnets are evenly distributed (with central symmetry) on the circle. For example, they are evenly spaced along the circumferential direction (see FIG. 21b). Here, M is an integer greater than or equal to 2, preferably M is 3 or 4.

The suction assembly 90 (for example the suction connector 94) is provided with a second magnetic member 992, which corresponds to the first magnetic member 991. Both the number and the position(s) of the second magnetic member(s) correspond to those of the first magnetic member(s). For example, the suction connector 94a is provided with an embedding seat for embedding the second magnetic member(s) corresponding to the first magnetic member(s).

In some embodiments, the first/second magnetic member(s) may be fixed in corresponding embedding seat(s) by adhesive bonding.

As shown in FIG. 19, the suction connector 94 is a sleeve ring, one side of which is sleeved (and/or connected by insertion/bayonet connection) to the suction body 91, and the other side is detachably connected to the housing 40 (and/or the blowing unit 200), for example by magnetic connection.

As shown in FIG. 18, preferably, the suction connector 94 has a larger diameter than the housing 40 (and/or air-inlet grille 221). Preferably, a side of the suction connector 94, wherein the side is connected to housing 40 (air-inlet grille 221), has an inwardly recessed surface. Thereby, when being connected, the suction connector 94 is sleeved over (fitted over) an outer diameter of the housing 40 or an outer diameter of the air-inlet grille 221. For example, as shown in FIG. 18, the air-inlet grille 221 may be designed to protrude outward from housing 40 (along the first direction), so that the suction connector 94 can be sleeved over (fitted over) the protruding portion of air-inlet grille 221.

By placing the suction connector 94 around the housing 40 (air-inlet grille 221), it can position the connection between the suction assembly 90 and the housing 40, thereby avoids that purely using magnetic attraction may cause displacement; besides, it helps to form a sealed airflow channel and prevent air leakage at the connection.

By virtue of detachable connection (especially magnetic connection) between the suction assembly and the blowing unit, the suction assembly can be easily removed and installed, thereby facilitating both use and storage/carrying.

In some embodiments, the suction assembly 90 may further comprise a suction tube 93. One end of the suction tube 93 is configured to be connected (for example detachably connected) to the suction port of suction body 91. The other end of the suction tube 93 is often designed as a converging structure. For example, as shown in FIG. 19, one end of the suction tube 93 is a round tube for sleeving onto the suction port of the suction body 91, and the other end is a converging nozzle. For example, the round tube is narrowed by two parallel surfaces into a slit nozzle (crevice nozzle). Such a converging structure helps to generate a strong negative pressure at the converged part, thereby achieving a good vacuuming effect. Besides, the suction tube 93 is normally designed to have a long tube (a long handle) with a certain length. Thus, the suction tube 93 itself also provides an effect of extending the operating arm, allowing the users to extend the suction assembly 90 into hard-to-reach areas such as under the seat.

In some embodiments, the suction assembly 90 may further comprise a suction brush head 92. The suction brush head 92 may be connected (for example detachably connected) at the suction port of the suction body 91 or at one end (the converging end) of the suction tube 93. The suction brush head 92 has bristles. The suction brush head 92 can assist the cleaning. For example, it assists in gathering dust and scraping off adhered dirt.

In the connection as shown in FIGS. 18 and 19, the suction port of the suction body 91 is connected to (sleeved/fitted onto) one end of the suction tube 93, and the other end of the suction tube 93 is connected to (sleeved/fitted onto) the suction brush head 92. For example, the suction port of suction body 91 is sleeved over one end of suction tube 93, and the suction brush head 92 is sleeved over the other end of suction tube 93. Those skilled in the art can appreciate that any other connection manners of a suction assembly as known in prior art are also applicable to the present disclosure, so that the connection is not limited to that shown in drawings of the present disclosure.

### Safety Hammer Section

In some embodiments, the air-blowing device may comprise a safety hammer section 80.

The safety hammer section 80 is detachably connected to the housing 40. For example, it is connected at the first air port (air inlet) 10b or at the second air port (air outlet) 10c. When the safety hammer section 80 is connected, the air-blowing device can serve as a safety hammer. The user can align a sharp end of the safety hammer head to a weak portion such as an edge/corner of glass, then hold the grip section 120 of the housing 40 (like the hammer handle of a safety hammer), and swing the hammer handle to apply an impact force. By the concentrated stress at the sharp end of the safety hammer, the glass can be easily broken. It functions as a window breaker, and can be used to break a vehicle window when safety incidents occur and doors cannot be opened.

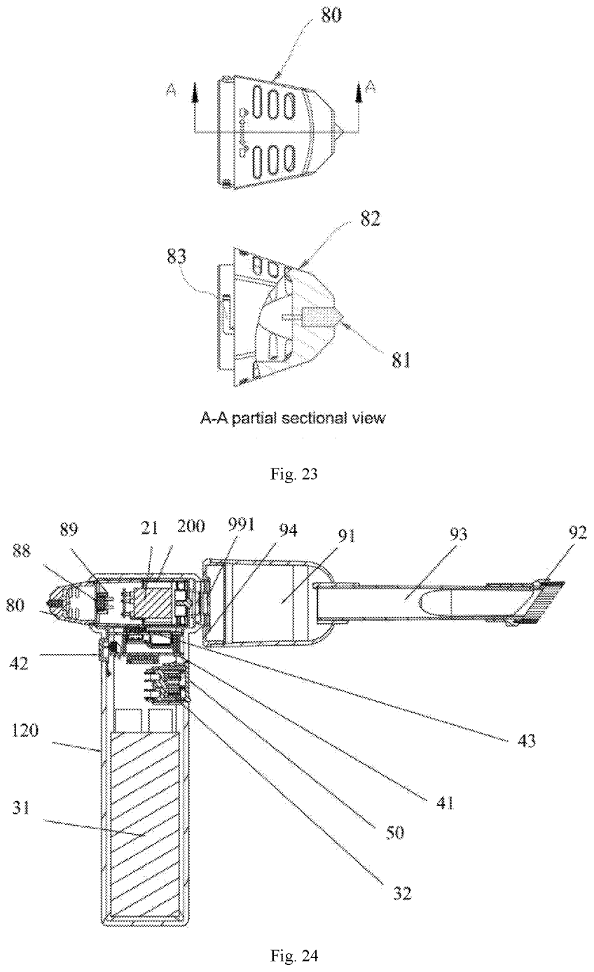

The safety hammer section 80 comprises a hammer head 81 and a safety-hammer body 82. The hammer head 81 is made of hard material. For example, hard plastic, metal, or alloy. For example, iron, steel, tungsten steel, etc. Normally, the hammer head 81 is integrally formed. One end of the hammer head 81 has a conical or pyramidal structure, which forms a force-applying sharp corner. The other end of the hammer head 81 may be provided with a fixing part (e.g., an inserting pin) to be fixed (inserted) into the safety-hammer body 82. The safety-hammer body 82 has a mounting seat for mounting the hammer head. As shown in FIG. 23, the mounting seat has a recess for accommodating a part of the hammer head 81. Preferably, the safety-hammer body 82 is a plastic part, especially a plastic part with elasticity. The plastic part with elasticity can tightly wrap around the hammer head 81 (with an applying force, with an elastic force), which prevents the hammer head 81 from falling off during swinging.

Preferably, a through hole is provided at a bottom the mounting seat of the safety-hammer body 82, and an inserting pin is provided at a bottom of the hammer head 81. The inserting pin of hammer head 81 passes through the through hole at the bottom of the mounting seat of safety-hammer body 82. This further enhances the effect that the plastic part of safety-hammer body 82 applies a force (an elastic force) to wrap and fix the hammer head 81, and improves the connection stability.

Further preferably, after the inserting pin of hammer head 81 passes through the through hole at the bottom of the mounting seat of safety-hammer body 82, a protruding portion (of the inserting pin) is fixed by adhesive bonding (adhesive dispensing). Thereby, the connection stability between the safety-hammer body 82 and the hammer head 81 is further improved.

In some embodiments, the safety-hammer body 82 is provided with a plurality of air ports (hollowed portions). These air ports communicate with an airflow channel of the blowing unit 200 (for example, communicate with an air inlet or an air outlet of the blowing unit 200). For example, a plurality of through holes (hollowed portions) are provided in the lateral direction(s) of the safety-hammer body 82 (in the direction(s) perpendicular to the first direction). The plurality of through holes form air ports. For example, 2 or more air ports, preferably 4 or more, are provided on the (annular) circumferential side of the safety-hammer body 82. As shown in FIG. 23, a plurality of air ports forms a grille-like structure. In this way, the stability of safety-hammer body 82 is not affected; meanwhile, air ports are formed, so that the air intake (air outlet) function of blowing unit 200 is not affected even when the safety hammer section 80 is connected with the housing 40 (blowing unit 200). By the virtue of air ports formed by hollowed portions, an unobstructed/continuous airflow path is achieved. Thus, frequent disassembly/assembly can be avoided, and ease of use is enhanced.

The safety-hammer body 82 is provided a safety-hammer connecting section 83, for achieving a connection between the safety hammer section 80 and the housing 40.

In some embodiments, the connection between the safety hammer section 80 and the housing 40 may be insertion/bayonet connection; and/or magnetic connection; and/or threaded connection; and/or in interference fit.

Various connection manners between the flow guide 60 and the housing 40 as described above in the part <Flow Guide>, and various connection manners between the suction assembly 90 and the housing 40 (and/or the blowing unit 200) as described in the part <Suction Assembly>, are also applicable to the connection between the safety hammer section 80 and the housing 40.

Preferably, the connection between the safety hammer section 80 and the housing 40 adopts substantially the same connection manner as that between a flow guide 60 and the housing 40, or adopts substantially the same connection manner as that between a suction assembly 90 and the housing 40. In this way, the safety hammer section 80 can be used to replace the flow guide 60 or the suction assembly 90, so as to be mounted on/to the housing 40. Thus, the device can play a role as a safety hammer when needed, while the flow guide 60 or the suction assembly 90 can be frequently used in daily life.

In some embodiments shown in FIG. 23, the connection between the safety hammer section 80 and the housing 40 may be bayonet connection. As shown in FIG. 23, the housing 40 is provided with a guide groove and a slot, and the safety hammer section 80 (e.g. the safety-hammer connecting section 83) is provided with a protrusion (a locking block). After the protrusion (locking block) is aligned and enters the guide groove, the safety hammer section 80 rotates relative to housing 40, and the protrusion (locking block) moves along the guide groove and then enters the slot, so as to form a bayonet connection. Those skilled in the art can understand that connection between the safety hammer section 80 and the housing 40 is not limited to that shown in drawings of the present disclosure.

Preferably, the safety-hammer body 82 is integrally formed. For example, it is formed by injection molding. The mounting seat, the through hole at bottom of mounting seat, the multiple air ports, as well as the protrusion (locking block) on the safety-hammer connecting section 83 can all be obtained by integral molding.

Since the safety-hammer body 82 preferably uses a plastic part with certain elasticity, the plastic part of safety-hammer body 82 is preferably designed/dimensioned to achieve an interference fit (an appropriate degree of interference fit) with the corresponding connecting parts. For example, an inner diameter of the mounting seat is slightly smaller than an outer diameter of the hammer head 81. For example, an inner diameter of the through hole of the mounting seat is slightly smaller than an outer diameter of the inserting pin of hammer head 81. For example, the protrusion (locking block) of/on the safety-hammer connecting section 83 has a slightly larger width than the slot of/on the housing. Due to an appropriate degree of interference fit (in dimensions), the plastic part of the safety-hammer body 82 is compressed and thus applies force to corresponding connecting parts, which increases the engagement force of connection.

### Illumination Unit

The air-blowing device of the present disclosure may be provided with an illumination unit 88. Thus, it can serve as a flashlight.

Preferably, the illumination unit 88 comprises an LED lamp bead. The illumination unit 88 is connected to the emergency battery cell 31. A switch corresponding to the illumination unit may be provided for turning on/off the illumination. The illumination unit 88 may be located at any position on/in/at/of the housing 40, as long as a part of the emitted light will not be completely blocked. In some embodiments, the illumination unit 88 is arranged on the same side as a suction assembly 90 (i.e., the same side as an air inlet 10b), so as to provide/supplement the illumination during the operation of the suction assembly.

In more embodiments, the illumination unit is arranged on the same side as an air outlet 10c. This is because the suction/vacuum function is mostly used in environments with relatively sufficient illumination (such as inside a vehicle cabin), while the blowing function (e.g., blowing water, leaves, or snow) may be used in environments with relatively poor illumination.

As shown in FIG. 18, in some embodiments, an air-outlet grille 222 is provided on/in/at the housing 40 or the blowing unit 200, and is located at a position close to the second air port (air outlet) 10d. The air-outlet grille 222 is provided with an illumination-unit fixing member 89, for example at the circle center, for installing/fixing the illumination unit 88. The light emitting direction of the illumination unit 88 is consistent with the direction of the airflow output.

Thus, when one of the various flow guides 60 is connected to the second air port (air outlet) 10d of the housing, the light emitted from the illumination unit 88 passes through the flow guide 60 and is emitted/projected outward. Thereby, it provides/supplements the illumination in blowing environments.

In the embodiments equipped with a safety hammer section 80, the illumination unit 88 is arranged on the same side as the safety hammer section 80. This is because the safety hammer is often used in relatively harsh environments, and needs to be aligned with the window glass repeatedly, so as to apply force at a fixed point for multiple times. By arranging the illumination unit 88 in the same direction as the safety hammer section 80, it can help the user to break the glass as soon as possible, so as to escape rapidly.

In some embodiments, air-inlet grille 221 or air-outlet grille 222 may be provided with an illumination-unit fixing member 89 (for example at the center of the grille), for installing/fixing the illumination unit 88.

When a switch of the illumination unit 88 is turned on, the illumination unit 88 provides flashlight lighting. The grip section 120 serves as a flashlight handle.

Besides, as shown in FIG. 24, when a safety hammer section 80 is connected to the housing at the same side as an illumination unit 88 (at the air-inlet side 10b or at the air-outlet side 10c), the light emitted from the illumination unit 88 can pass through the air ports (the through holes/grilles) of the safety-hammer body, so as to be emitted/projected outward. Thus, it increases ambient illumination, and facilitates the use of the safety hammer.

A switch for controlling the illumination unit 88 may be designed as a separate button, or integrated with button(s) for other function(s). For example, the first switch 42 (first button 4201) may be used to control the on/off of the power supply from energy storage unit 300 (like a main power switch). Press the first switch 42 once to power on the device; press the first switch 42 again to turn on the illumination unit 88, and so on.

Some specific embodiments of the present disclosure are provided below. Those skilled in the art can understand that the implementations of the present disclosure are not limited to these embodiments.

### Embodiment 1

As shown in FIGS. 1 to 6, an air-blowing device of the present disclosure comprises: a housing 40; an energy storage unit 300 comprising an emergency battery cell 31 and disposed in the housing 40; the emergency battery cell 31 is connected to an emergency interface 32, wherein the emergency interface 32 is suitable for being electrically connected to a vehicle, so as to enable emergency starting of the vehicle; and a blowing unit 200 disposed in the housing 40 and electrically connected to the energy storage unit 300.

The housing 40 comprises an accommodating cavity 10a, and the accommodating cavity comprises a first accommodating cavity 1001 and a second accommodating cavity 1002. The housing comprises an airflow section 110 extending along a first direction and a grip section 120 extending along a second direction. The airflow section 110 corresponds to the first accommodating cavity 1001 and the grip section 120 corresponds to the second accommodating cavity 1002. The first direction and the second direction form a preset included angle. Preferably, the preset included angle is 60°-150°.

Preferably, the blowing unit 200 is located in the first accommodating cavity 1001. Preferably, the emergency battery cell 31 is located in the second accommodating cavity 1002. Preferably, the emergency interface 32 is located in grip section 120; further preferably, the emergency interface 32 and the emergency battery cell 31 are arranged along an extension direction of the grip section 120 (i.e., the second direction); optionally, the emergency interface 32, rather than the emergency battery cell 31, is closer to the airflow section 110.

Optionally, a first protruding portion 1011 is provided on/at a side, close to the accommodating cavity 10a, of the housing 40; the first protruding portion 1011 is located between the blowing unit 200 and the housing 40, so that the blowing unit 200 is at least partially spaced from the housing 40; and/or a second protruding portion 1014 is provided on a side, close to the accommodating cavity 10a, of the housing 40; the second protruding portion 1014 is located between the energy storage unit 300 and the housing 40, so that the energy storage unit 300 is at least partially spaced from the housing 40.

The blowing unit 200 may comprise an air-blowing motor 21 and a motor sleeve 23 sleeved/fitted onto the air-blowing motor 21. The motor sleeve 23 forms an air output channel of the air-blowing motor 21, thereby separating the airflow channel from the accommodating cavity 10a of the housing 40.

The emergency battery cell 31 preferably uses a cylindrical or rectangular emergency battery cell. When the emergency battery cell 31 is cylindrical, the ratio of cylinder length to diameter is preferably not less than 2, and more preferably not less than 3. When the battery cell 31 is rectangular, the ratio of rectangular length to width is preferably not less than 2, and more preferably not less than 3.

The air-blowing device further comprises a control assembly 10, which is electrically connected to the blowing unit 200 and the energy storage unit 300, and can control start/stop of the blowing unit 200.

The control assembly 10 comprises a circuit board 41. Preferably, the circuit board 41 comprises two sub-circuit boards 41. Further preferably, two or more sub-circuit boards 41 are arranged in parallel and spaced apart (along the extension direction of the grip section).

Preferably, the circuit board 41 is at least partially located in the grip section 120. For example, both the sub-circuit boards are located in grip section 120. Further preferably, the circuit board 41 and the emergency battery cell 31 are arranged along the extension direction of the grip section 120 (i.e., the second direction). Further preferably, the circuit board 41, rather than the emergency battery cell 31, is closer to airflow section 110.

An inner side of housing 40 is provided with a slot formed by a first insertion member 1012 for inserting/fixing circuit board 41.

The air-blowing device may comprise a flow guide 60. The flow guide 60 is designed to be detachably connected with the housing 40 or the blowing unit 220, at a position close to an air outlet 10c. Optionally, the flow guide 60 has a flow converging section 611, whose radial size gradually decreases outward along the first direction.

The connection manner between the housing 40 (or the blowing unit 220) and the flow guide 60 may be insertion/bayonet connection; and/or magnetic connection; and/or threaded connection; and/or in interference fit.

In this embodiment, two push switches 42 and 43 are installed on two adjacent sides of the grip section 120, respectively. Functions of the switches are not specially limited and may be configured as needed (for example configured via software in a control module).

### Embodiment 2

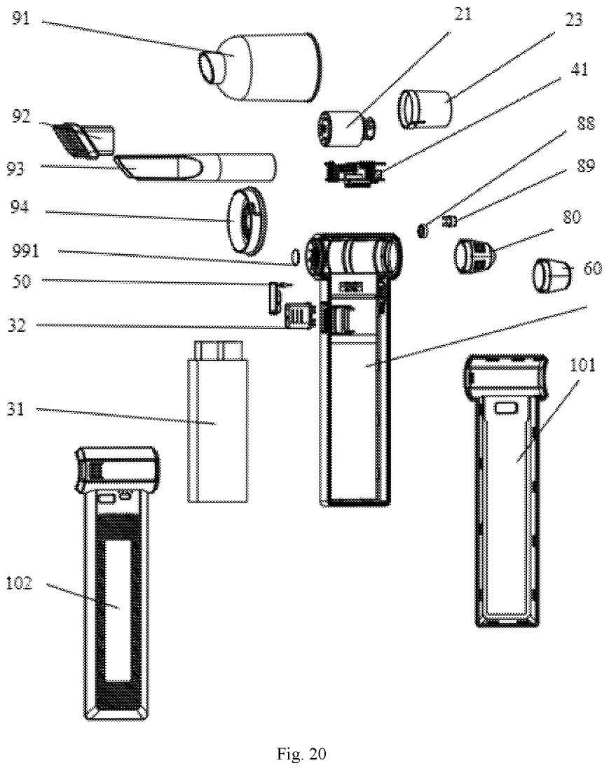

As shown in FIGS. 18, 20, and 24, the air-blowing device in this embodiment may further comprise a detachable suction assembly 90 and/or a detachable safety hammer section 80, in addition to a detachable flow guide 60.

In this embodiment, the suction assembly 90 is configured to be detachably connected to an air inlet of the blowing unit 200 (or the housing 40). In this embodiment, the safety hammer section 80 is configured to be detachably connected to an air outlet of blowing unit 200 (or the housing 40), and adopts substantially the same connection manner as the flow guide 60. In this way, the safety hammer section 80 can be used to replace the flow guide 60 and be mounted on/to the housing 40.

In this embodiment, the connection between the suction assembly 90 and the blowing unit 200 (or the housing 40) may be snap-fit connection (bayonet connection), threaded connection, and/or magnetic connection. When threaded connection is used, connecting threads may be placed on an inner wall (as internal thread) or outer wall (as external thread) of the blowing unit 200 (or of the housing 40). Magnetic connection is preferred, which enables a user to rapidly install/remove the suction assembly 90.

The housing 40 or the blowing unit 200 is provided with an air-inlet grille 221 at an end of the air inlet, and an embedding seat is provided on/in/at the air-inlet grille 221 for embedding the first magnetic member 991. The suction assembly 90 has a suction connector 94, and the suction connector 94 is provided with a second magnetic member 992 corresponding to the first magnetic member.

Preferably, when the suction assembly 90 is connected with the housing 40 (or the blowing unit 200), the suction assembly 90 (the suction connector 94) is sleeved over an outer diameter (outer circumference) of the housing 40 or over an outer diameter (outer circumference) of the air-inlet grille 221.

In this embodiment, the connection between the safety hammer section 80 (the flow guide 60) and the blowing unit 200 (or the housing 40) may be snap-fit connection (bayonet connection), threaded connection, and/or magnetic connection. When threaded connection is used, connecting threads may be placed on an inner wall (as internal thread) or outer wall (as external thread) of the blowing unit 200 (or of the housing 40).

The safety hammer section 80 comprises a hammer head 81 and a safety-hammer body 82. The safety-hammer body 82 is hollowed out. The safety-hammer body 82 is a plastic part, especially a plastic part with elasticity. The safety-hammer body 82 uses a plastic part with elasticity; the connection (joint) between the safety-hammer body 82 and the hammer head 81, and/or the connection (joint) between the safety-hammer body 82 and the housing 40, are all designed to have an appropriate degree of interference fit (in sizes/dimensions).

Because safety-hammer body 82 is hollowed out, the use of the suction assembly 90 at the air inlet (e.g. the operation as a vacuum cleaner) is not affected even when the safety hammer section 80 is installed at the air outlet. Thus, frequent disassembly/assembly can be avoided.

The air-blowing device in this embodiment further comprises an illumination unit 88, and the illumination unit 88 is arranged on the same side as the safety hammer section 80.

An air-outlet grille 222 of blowing unit 200 is provided with an illumination-unit fixing member 89 (for example at the center of the grille), for installing/fixing the illumination unit 88.

The design of placing an illumination unit 88 on/in/at air-outlet grille 222 does not only make the structure more compact, but also can project the light towards where the safety hammer is to be used, which provides more accurate illumination.

Because safety-hammer body 82 is hollowed out, it can not only allow air to pass through but also allow light to pass through.

In an environment to use the safety hammer, turning on the illumination unit 88 can provide a better illumination, so that the user can better use the safety hammer and escape quickly.

In this embodiment, a push switch 42 and a toggle switch 43 are installed on two adjacent sides of the grip section 120, respectively. Functions of the switches are not specially limited and may be set as needed (for example set via software in a control module).

A circuit board 41 (two or more sub-circuit boards), an emergency interface 32, and an emergency battery cell 31 are all located in grip section 120. Along an extension direction of the grip section 120, from an upper side to the lower side (i.e. toward a direction away from the airflow section) are: circuit board 41 (two or more sub-circuit boards), emergency interface 32, emergency battery cell 31. Such arrangement facilitates wiring and also makes the handle portion of grip section longer, facilitating holding and force application.

### Embodiment 3

The embodiment 3 differs from the embodiment 2 in that the safety hammer section 80 is configured to be detachably connected to an air inlet of the blowing unit 200 (or the housing 40), and preferably adopts substantially the same connection manner as the suction assembly 90. In this way, the safety hammer section 80 can be used to replace the suction assembly 90 and be mounted on/to the housing 40.

### Embodiment 4

The embodiment 4 differs from the embodiment 1 in that it does not have a function of emergency starting. Therefore, the embodiment 4 may use an ordinary rechargeable battery cell as the energy storage unit 300, and does not necessarily use an emergency battery cell capable of instantaneously providing a high current. In addition, there is no need to provide the emergency interface 32, nor to provide the circuit components between the energy storage unit 300 and the emergency interface 32 (e.g., related control modules, power connecting wire 33, etc.).

### Embodiment 5

The embodiment 5 differs from the embodiment 2 in that it does not have a function of emergency starting. Therefore, the embodiment 5 may use an ordinary rechargeable battery cell as the energy storage unit 300, and does not necessarily use an emergency battery cell capable of instantaneously providing a high current. In addition, there is no need to provide the emergency interface 32, nor to provide the circuit components between the energy storage unit 300 and the emergency interface 32 (e.g., related control modules, power connecting wire 33, etc.).

### Embodiment 6

The embodiment 6 differs from the embodiment 3 in that it does not have a function of emergency starting.

Therefore, the embodiment 6 may use an ordinary rechargeable battery cell as the energy storage unit 300, and does not necessarily use an emergency battery cell capable of instantaneously providing a high current. In addition, there is no need to provide the emergency interface 32, nor to provide the circuit components between the energy storage unit 300 and the emergency interface 32 (e.g., related control modules, power connecting wire 33, etc.).

It can be understood that the air-blowing device facilitates handheld operation and enables functions such as dust/snow blowing and inflation/air blasting. For example, in long-distance transport and outdoor travel scenarios, a user can hold the air-blowing device to inflate/aerate devices (such as compressed mattresses, tents), and can also blow dust/snow from a floor mat, a blanket, a windshield, etc. of the vehicle, thereby ensuring the driving safety.

It can be further understood that, by frequently using the emergency power equipment to perform high-frequency functions (such as dust removal, dust/snow blowing, inflation, air blasting), the user is forced to frequently use/check/recharge the device, thereby preventing the emergency power equipment from being forgotten and thus improving the stability of power supply.

Besides, through detachable connection, the air-blowing device may be equipped with accessories such as a flow guide, a suction assembly, a safety hammer section, etc. When the suction assembly is connected, the device can operate as a vacuum cleaner. When the safety hammer section is connected, the device can operate as a safety hammer. When an illumination unit is equipped, the device can operate as a flashlight. Thus, multiple uses are realized in one device.

The present disclosure integrates multiple functions comprising emergency starting, air blowing, vacuum cleaning, safety hammering, and flashlight lighting into one device. Thereby, the user does not need to carry several different devices, improving the practicality and convenience of the product.

The above descriptions are only specific embodiments of the present disclosure, and the protection scope of the present disclosure is not limited thereto. Any person skilled in the art may easily conceive of various equivalent modifications or substitutions within the technical scope disclosed by the present disclosure, and these modifications or substitutions shall fall within the protection scope of the present disclosure. Therefore, the protection scope of the present disclosure shall be determined by the scope of the claims.

1. An air-blowing device, wherein the air-blowing device comprises:
a housing, comprising an airflow section and a grip section;
an energy storage unit, comprising an emergency battery cell, which is provided in the housing,
wherein the emergency battery cell is connected to an emergency interface, wherein the emergency interface is suitable for being electrically connected to a vehicle, so as to enable emergency starting of the vehicle;
a blowing unit, which is provided in the housing and is electrically connected to the energy storage unit, wherein:
the blowing unit is located in the airflow section; and
the emergency interface is located in the grip section and is located at a part of the grip section close to the airflow section.

2. The air-blowing device according to claim 1, wherein the emergency battery cell is disposed in the grip section, and the emergency interface is disposed closer to the airflow section than the emergency battery cell is.

3. The air-blowing device according to claim 1, wherein the housing is provided with a mounting seat for mounting the emergency interface, wherein the mounting seat provides a receiving space that is constrained in at least two dimensions so as to position the emergency interface, wherein the at least two dimensions comprises length direction and width direction, wherein the housing is provided with a protruding structure at a position corresponding to the emergency interface and the protruding structure is able to limit movement of the emergency interface in thickness direction.

4. The air-blowing device according to claim 1, wherein a circuit board is provided in the housing, wherein the circuit board is electrically connected to the blowing unit and to the energy storage unit, wherein the circuit board, the emergency interface, and the emergency battery cell are arranged in sequence, along a direction in which the grip section extends away from the airflow section.

5. The air-blowing device according to claim 4, wherein the circuit board comprises two or more sub-circuit boards, and the two or more sub-circuit boards are located in the grip section.

6. The air-blowing device according to claim 5, wherein the two or more sub-circuit boards are disposed in parallel and spaced apart from one another; and/or
each plane in which each of the two or more sub-circuit boards is located is perpendicular to the extending direction of the grip section extends.

7. The air-blowing device according to claim 4, wherein there are at least two first insertion members, wherein the at least two first insertion members are respectively located on opposite sides of the circuit board, and are asymmetrical.

8. The air-blowing device according to claim 1, wherein the air-blowing device comprises a first control circuit, and the first control circuit is configured to provide overload protection, short-circuit protection, overheating protection, and/or undervoltage protection for the emergency battery cell.

9. The air-blowing device according to claim 8, wherein the air-blowing device further comprises a battery clamp, wherein the battery clamp is configured to connect the emergency interface to a battery of the vehicle for emergency starting, wherein all control circuits and/or protection circuits and/or switch circuits for controlling power supply for emergency starting are located in the battery clamp.

10. The air-blowing device according to claim 1, wherein an anti-slip section or an anti-slip member is provided on a surface of the grip section of the housing; the anti-slip section or the anti-slip member is provided with a plurality of uneven anti-slip stripes, which are repeatedly arranged.

11. The air-blowing device according to claim 1, wherein the air-blowing device comprises a suction assembly, and the suction assembly is detachably connected to an air inlet of the blowing unit.

12. The air-blowing device according to claim 11, wherein the suction assembly is magnetically connected to the blowing unit.

13. The air-blowing device according to claim 12, wherein an air-inlet grille is provided at the air inlet of the housing or of the blowing unit; an embedding seat is provided on the air-inlet grille, and is used for embedding a first magnetic member; the suction assembly comprises a suction connector; a second magnetic member corresponding to the first magnetic member is provided on the suction connector.

14. The air-blowing device according to claim 13, wherein the suction connector is sleeved over an outer circumference of the housing, or around an outer circumference of the air-inlet grille.

15. The air-blowing device according to claim 1, wherein the air-blowing device comprises a safety hammer section, and the safety hammer section is detachably connected to an air inlet of the housing, or to an air outlet of the housing.

16. The air-blowing device according to claim 15, wherein the safety hammer section comprises a hammer head and a safety-hammer body, and the safety-hammer body is hollowed-out.

17. The air-blowing device according to claim 15, wherein the safety hammer section comprises a hammer head and a safety-hammer body, wherein the safety-hammer body is made of a plastic member with a certain degree of elasticity; at the connection between the safety-hammer body and the hammer head, and/or at the connection between the safety-hammer body and the housing, the connection is designed to have an appropriate degree of interference fit.

18. The air-blowing device according to claim 15, wherein the air-blowing device is further provided with an illumination unit, and the illumination unit is arranged on the same side as the safety hammer section.

19. The air-blowing device according to claim 1, further comprising:
an illumination unit; and
an air-outlet grille of the blowing unit, wherein the air-outlet grille is provided with an illumination-unit fixing member, and the illumination unit is located in the illumination-unit fixing member.

20. The air-blowing device according to claim 1, wherein the blowing unit comprises an air-blowing motor, the air-blowing motor comprises a motor body and an impeller, and the motor body is configured to drive the impeller to rotate to induce airflow.
